(19) United States
(12) Patent Application Publication
(10) Pub. No.: US 2015/0170186 A1
(43) Pub. Date: Jun. 18, 2015

(54) Eco Advantage Mediation Apparatuses, Methods and Systems

(71) Applicant: Perminio Moreira Neto, San Paulo (BR)

(72) Inventor: Perminio Moreira Neto, San Paulo (BR)

(21) Appl. No.: 13/842,593

(22) PCT Filed: May 21, 2012
(86) PCT No.: PCT/BR2012/000148

§ 371 Date: Mar. 2, 2015

(51) Int. Cl. G06Q 30/02

(52) U.S. Cl. CPC G06Q 30/0229; G06Q 30/0233

(57) ABSTRACT

The ECO ADVANTAGE MEDIATION APPARATUSES, METHODS AND SYSTEMS (“ECO ADVANTAGE”) transforms transaction and user, merchant, and payment data inputs into eco, transaction, and region analytics outputs. In some implementations, ECO ADVANTAGE receive a request for a user's transaction value modifier (TVM) balance and a merchant's current TVM schedule from a merchant, receive a TVM transaction confirmation indicating a transaction has been successfully processed and TVM transaction data, debit from a user's account an amount of TVMs received from another merchant in a previous transaction for use in the transaction, credit to the user's account an amount of TVMs based on the TVM transaction data, and store TVM transaction data in a TVM transaction record.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### PRIORITY CLAIM

Applicant hereby claims priority to Patent Cooperation Treaty patent application serial no. PCT/BR2012/000148, filed May 21, 2012, entitled “SISTEMA DE INTERMEDIACAO MUTUA DE VANTAGENS,” attorney docket no. P200015.

The entire contents of the aforementioned applications are herein expressly incorporated by reference.

### FIELD

The present innovations generally address exchanging purchase benefits, and more particularly, include ECO ADVANTAGE MEDIATION APPARATUSES, METHODS AND SYSTEMS.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. §112.

### BACKGROUND

Merchants can provide coupons or discounts to products in order to sell more stock. Coupons and discounts can be of a particular merchant-specified value.

### BRIEF DESCRIPTION OF THE DRAWINGS

The accompanying appendices and/or drawings illustrate various non-limiting, example, innovative aspects in accordance with the present descriptions:

FIG. 1a shows a block diagram illustrating example embodiments of the ECO ADVANTAGE;

FIG. 1b shows a block diagram illustrating example embodiments of the ECO ADVANTAGE;

FIG. 2a shows a data flow diagram illustrating performing a transaction in example embodiments of the ECO ADVANTAGE;

FIG. 2b shows a logic flow diagram illustrating performing a transaction in example embodiments of the ECO ADVANTAGE;

FIG. 2c shows a data flow diagram illustrating performing an online transaction in example embodiments of the ECO ADVANTAGE;

FIG. 2d shows a logic flow diagram illustrating performing an online transaction in example embodiments of the ECO ADVANTAGE;

FIG. 3a shows a data flow diagram illustrating performing a transaction without an ECO ADVANTAGE account in example embodiments of the ECO ADVANTAGE;

FIG. 3b shows a logic flow diagram illustrating performing a transaction without an ECO ADVANTAGE account in example embodiments of the ECO ADVANTAGE;

FIG. 4a shows a data flow diagram illustrating enrolling a merchant in example embodiments of the ECO ADVANTAGE;

FIGS. 4b-c show logic flow diagrams illustrating enrolling a merchant in example embodiments of the ECO ADVANTAGE;

FIG. 5a shows a data flow diagram illustrating creating and updating regions and categories in example embodiments of the ECO ADVANTAGE;

FIGS. 5b-d show logic flow diagrams illustrating creating and updating regions and categories in example embodiments of the ECO ADVANTAGE;

FIGS. 6a-b show data flow diagrams illustrating friend invitations and donations in example embodiments of the ECO ADVANTAGE;

FIGS. 6c-d show logic flow diagrams illustrating friend invitations and donations in example embodiments of the ECO ADVANTAGE;

FIG. 7a shows a data flow diagram illustrating slow commit, credit-only transactions in example embodiments of the ECO ADVANTAGE;

FIG. 7b shows a logic flow diagram illustrating slow commit, credit-only transactions in example embodiments of the ECO ADVANTAGE;

FIG. 8a shows a data flow diagram illustrating fast commit, credit-only transactions in example embodiments of the ECO ADVANTAGE;

FIG. 8b shows a logic flow diagram illustrating fast commit, credit-only transactions in example embodiments of the ECO ADVANTAGE;

FIG. 9a shows a data flow diagram illustrating merchant reconciliation in example embodiments of the ECO ADVANTAGE;

FIG. 9b shows a logic flow diagram illustrating merchant reconciliation in example embodiments of the ECO ADVANTAGE;

FIG. 10a shows a data flow diagram illustrating slow commit, cash and credit transactions in example embodiments of the ECO ADVANTAGE;

FIGS. 10b-c show logic flow diagrams illustrating slow commit, cash and credit transactions in example embodiments of the ECO ADVANTAGE;

FIG. 11a shows a data flow diagram illustrating fast commit, cash and credit transaction in example embodiments of the ECO ADVANTAGE;

FIGS. 11b-c show logic flow diagrams illustrating fast commit, cash and credit transactions in example embodiments of the ECO ADVANTAGE;

FIG. 12a shows a data flow diagram illustrating fast commit, cash only transactions in example embodiments of the ECO ADVANTAGE;

FIG. 12b shows a logic flow diagram illustrating fast commit, cash only transactions in example embodiments of the ECO ADVANTAGE;

FIG. 13a shows a data flow diagram illustrating slow commit, cash only transactions in example embodiments of the ECO ADVANTAGE;

FIG. 13b shows a logic flow diagram illustrating slow commit, cash only transactions in example embodiments of the ECO ADVANTAGE;

FIG. 14a shows a data flow diagram illustrating merchant and partner transactions in example embodiments of the ECO ADVANTAGE;

FIGS. 14b-c show logic flow diagrams illustrating merchant and partner transactions in example embodiments of the ECO ADVANTAGE;

FIG. 15a show a data flow diagram illustrating refunding or cancelling transactions in example embodiments of the ECO ADVANTAGE;

FIG. 15b shows a logic flow diagram illustrating refunding or cancelling transactions in example embodiments of the ECO ADVANTAGE;

FIG. 16 shows a table diagram illustrating using ECO ADVANTAGE for health insurance in example embodiments of the ECO ADVANTAGE;

FIGS. 17a-b show screenshot diagrams illustrating enrolling a merchant in example embodiments of the ECO ADVANTAGE;

FIG. 18 shows a screenshot diagram illustrating creating a region in example embodiments of the ECO ADVANTAGE;

FIG. 19 shows a screenshot diagram illustrating creating categories in example embodiments of the ECO ADVANTAGE;

FIGS. 20a-b show screenshot diagrams illustrating donating ecos in example embodiments of the ECO ADVANTAGE;

FIGS. 21a-b show screenshot diagrams illustrating user profiles and eco balances in example embodiments of the ECO ADVANTAGE;

FIGS. 22a-b show diagrams illustrating user navigation and check-in in example embodiments of the ECO ADVANTAGE;

FIG. 23 shows a block diagram illustrating embodiments of an ECO ADVANTAGE controller.

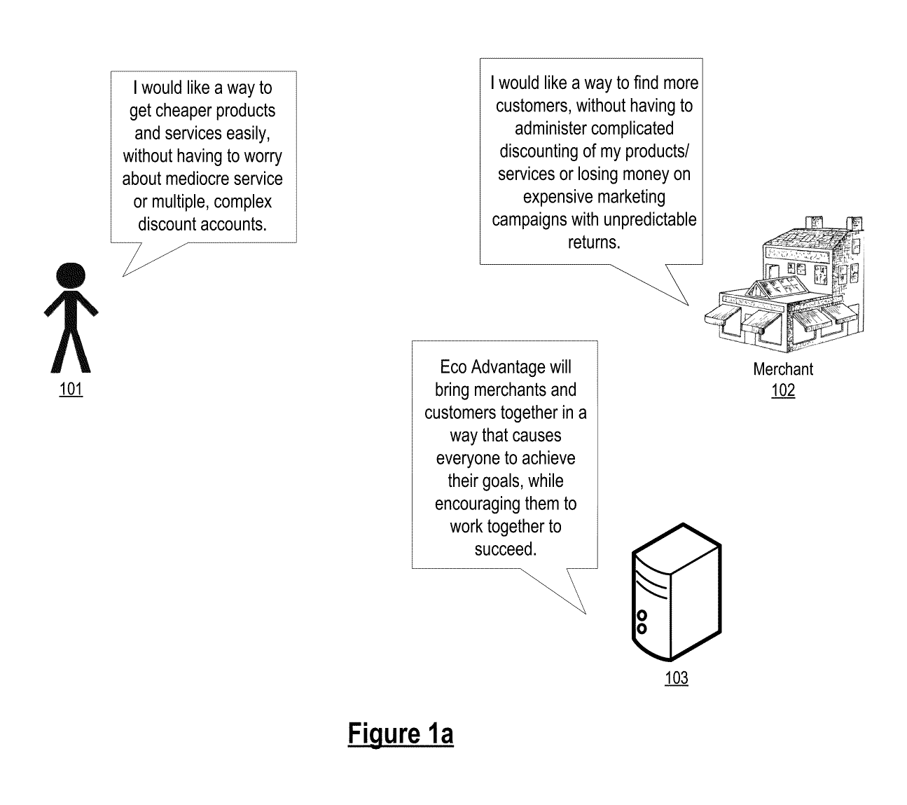

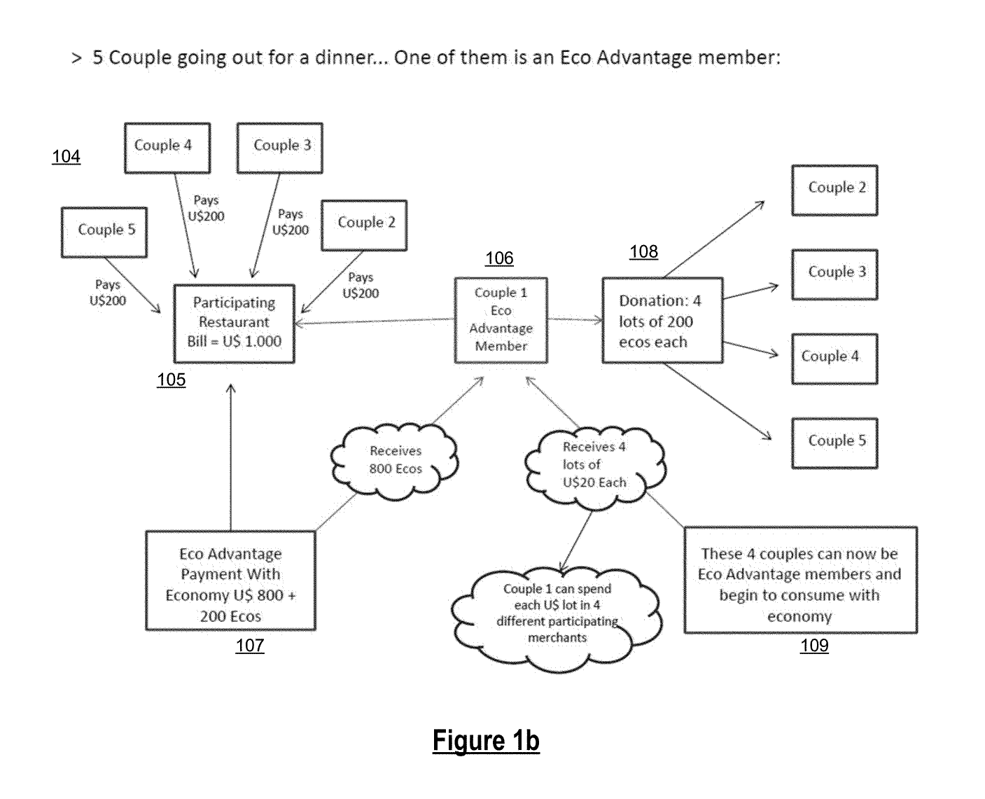

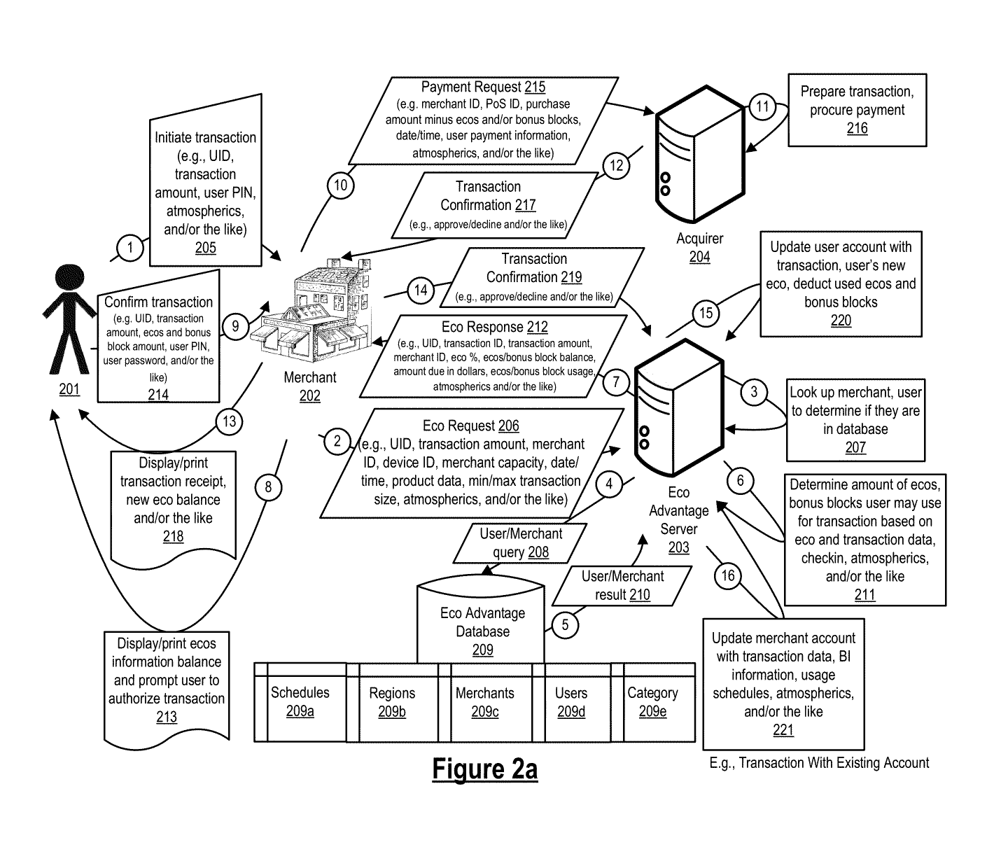

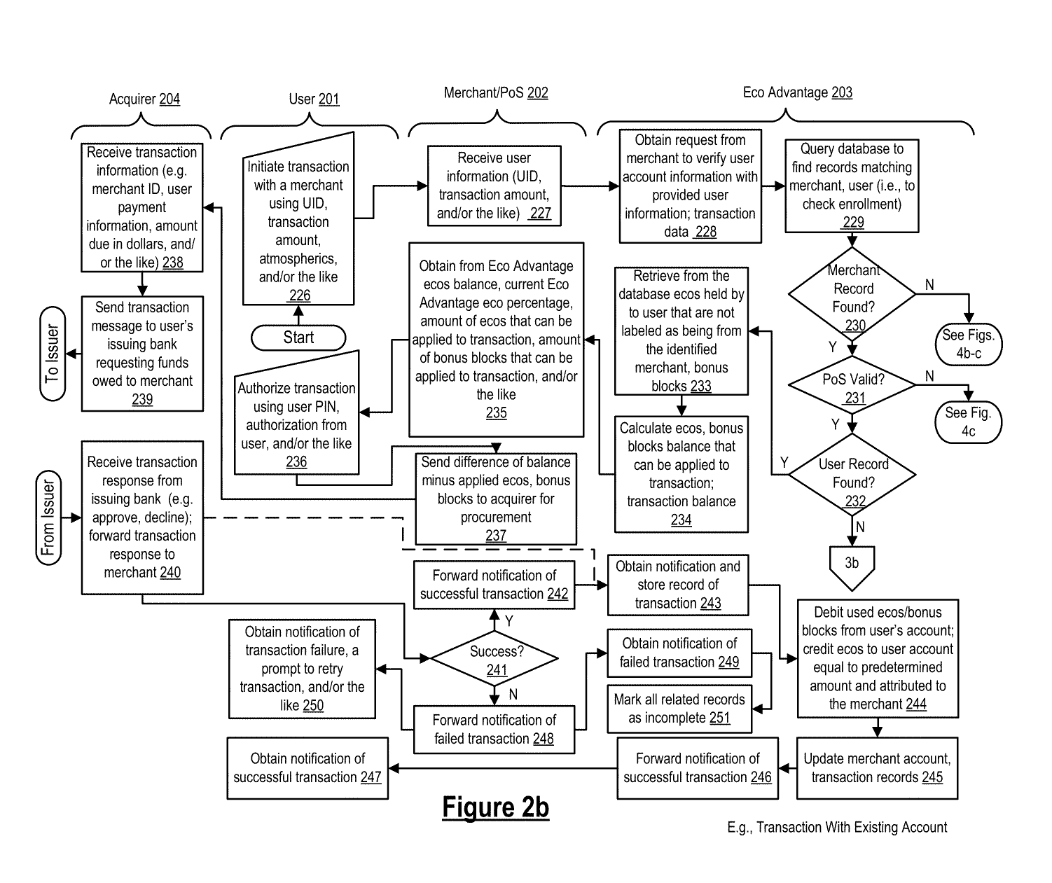

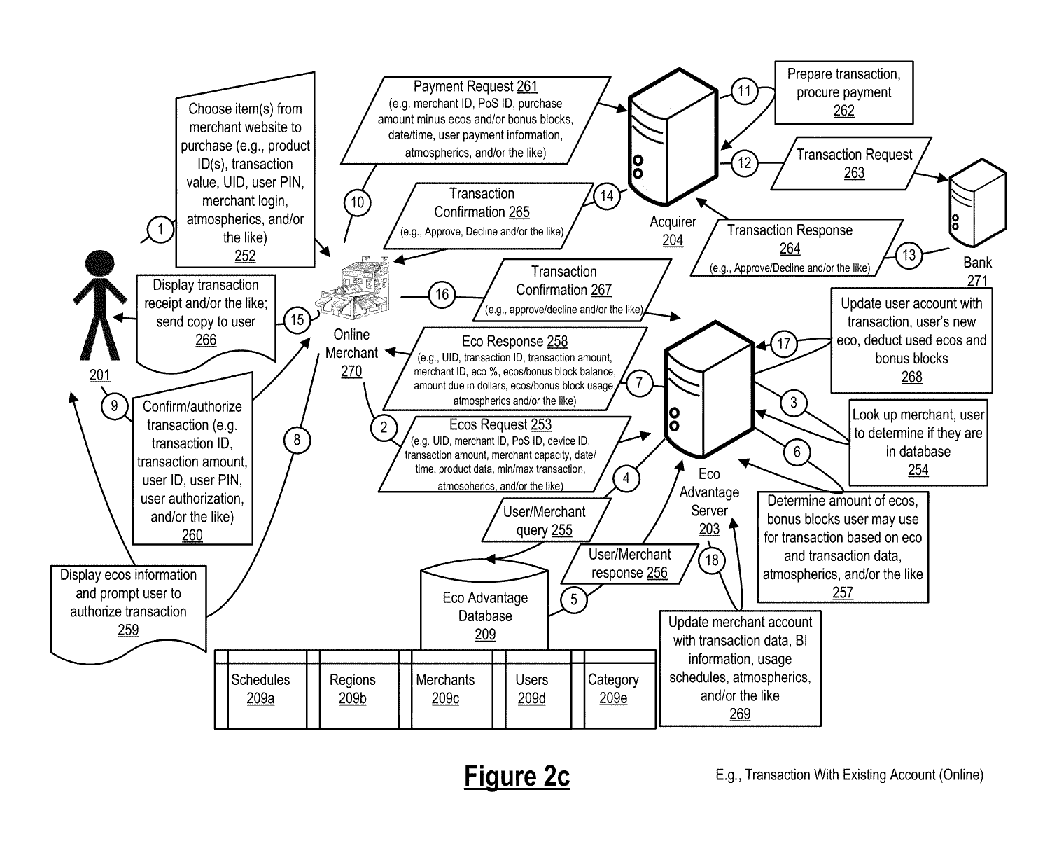

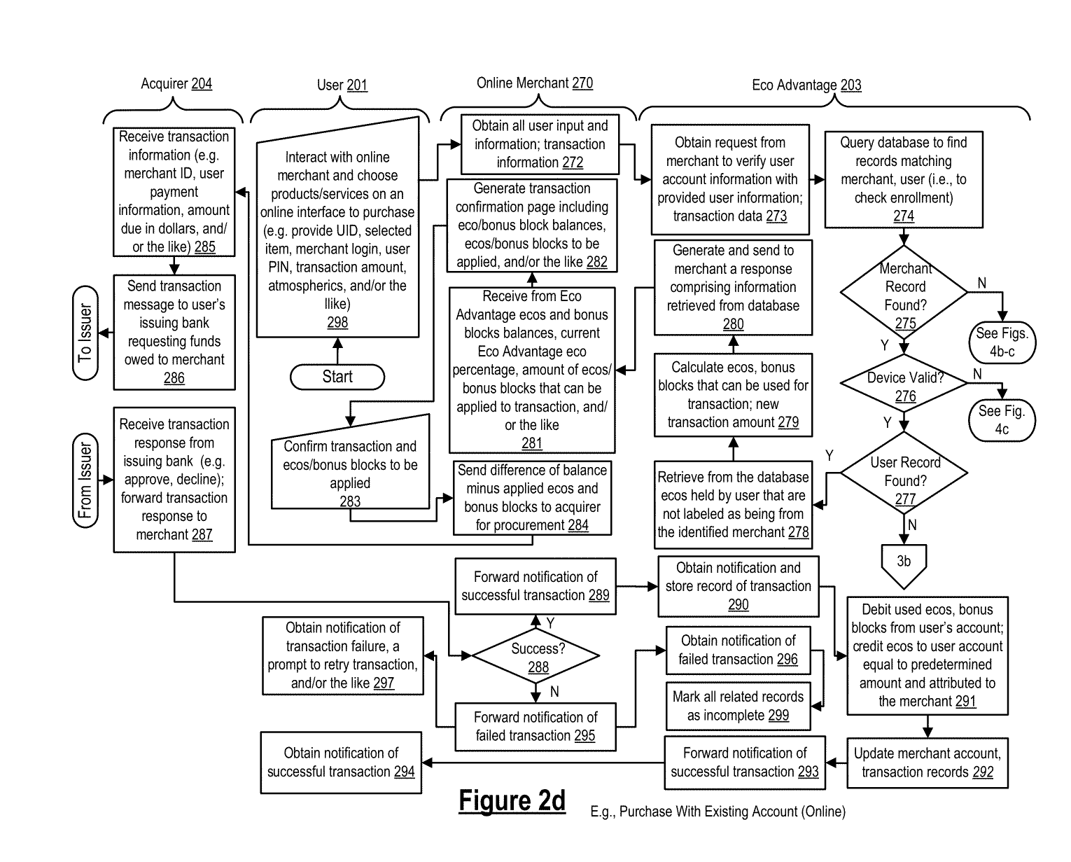

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Eco Advantage

FIG. 1a shows a block diagram illustrating example embodiments of the ECO ADVANTAGE. In some implementations, a consumer 101 may want to be able to find an easy way to purchase inexpensive products and/or services without having to handle a variety of discount program accounts, or without having to worry about a loss in service quality due to the nature of the discount. A merchant 102 may also wish to find more customers to serve, without having to create costly or complicating discounts, and without having to risk a large amount of money on expensive marketing campaigns with unpredictable returns. In some implementations, ECO ADVANTAGE 103 may bring such merchants and consumers together in order to offer inexpensive products and/or services to consumers, while increasing the number of consumers for the merchant and while not requiring the merchant to invest in expensive marketing or heavily discount their products. In some implementations ECO ADVANTAGE may bring other benefits to merchants such as using installed capacity in a more equalized manner, taking advantage of underused installed capacity, and fixed costs for growth without capital investment. In some implementations ECO ADVANTAGE may enroll merchants that provide goods, services or both.

FIG. 1b shows a block diagram illustrating example embodiments of the ECO ADVANTAGE. In some implementations, a group of people in a party 104 may wish to pay a bill 105 at a restaurant participating in ECO ADVANTAGE 107. One person and/or couple in the party 106 may also be enrolled in ECO ADVANTAGE, and may pay at least a part of the bill using a unit (e.g. transaction value modifiers, which may include “ecos,” value points, and/or the like) provided by ECO ADVANTAGE, and may receive ecos for performing the transaction. The user may also be able to donate 108 ecos to the other members of the party, so that they may also enroll 109 in ECO ADVANTAGE and use their ecos in subsequent transactions.

In some implementations, ECO ADVANTAGE may also donate predetermined blocks of ecos to early adoption users in order to encourage them to invite friends to ECO ADVANTAGE. In some implementations, the donated ecos may only be used for donations to other potential users.

In some implementations ECO ADVANTAGE may control how many ecos a user may utilize at a particular merchant based on the merchant capacity at particular times of day, particular days of the week, particular seasons and/or holidays during a year, total transaction amount, intended products and/or services, total transactions to date, total ecos to date, available capacity, growth potential and/or the like. In some implementations, for example, a user purchasing a meal during the day may be able to use a higher number of ecos (e.g. 30% of the transaction amount may be paid in ecos) at a merchant that does not have many customers during the day, and may be able to use a lower number of ecos (e.g. 15% of the transaction amount may be paid in ecos) at a merchant that has many customers during the day.

In some implementations, once a user makes a purchase at a merchant, the user may earn ecos which may be utilized in subsequent transactions. For example, if a user buys a meal for $100, the user may receive some number of ecos during the transaction. In some implementations, the amount of ecos received may be equal to the amount the user pays out-of-pocket for a transaction. For example, if a user purchases a meal for $100 but uses 20 ecos to pay for part of the meal (thereby only paying $80 out-of-pocket for the meal), the user may receive 80 ecos from the transaction. In other implementations, the amount of ecos the user receives may be a percentage of the total transaction, a percentage of the amount the user pays out-of-pocket, a percentage according to merchant, a fixed amount, and/or the like. In some implementations, such limitations may be determined by the ECO ADVANTAGE or the merchant(s) involved, and/or a like entity.

In some implementations, these ecos may not be used with the merchant from which they were issued. For example, a user may purchase a TV from Best Buy and receive 100 ecos from the transaction. In some implementations, these 100 ecos may be marked in an ECO ADVANTAGE Database as being from Best Buy, and in subsequent purchases at Best Buy, the user may not be able to use those 100 ecos for said purchases. The user, however, may be able to use the 100 ecos at other merchants for other purchases; for example, the user may be able to use the 100 ecos towards a transaction at Radio Shack, Whole Foods, and/or the like. In some implementations, the merchant(s) that the user may use the ecos with may not be in the same industry or category as the merchant from which the user received its ecos; for example, even though the user may have received its ecos from Best Buy, the user may not be restricted to using them at a similar electronics store, and/or the like. In some implementations the user may be able to spend the ecos at any other merchant other than Best Buy.

In other implementations, the user may be restricted to the types of merchants that the ecos may be spent at. For example, in other implementations, a user who receives ecos from a Best Buy in New York City may not be able to spend the ecos in an area other than New York City, may not be able to spend the ecos at merchant of a different industry and/or category (e.g. electronics) than Best Buy, and/or the like. In some implementations, such limitations may be determined by the merchant, ECO ADVANTAGE, and/or a like entity. In some implementations, example industries and/or categories supported by ECO ADVANTAGE may include: Accessories, Advertising and Marketing, Animal Clinic and Hospital, Arts and Crafts, Auto Body Shop, Auto Dealer, Auto Electric Shop, Auto Parts Store, Bakery, Beauty Clinic, Book Wholesale, Bookstore, Building Supplies, Camera and Photo, Car-Wash, Ceilings/Partition, Cell Phone Provider, Children's Store, Chocolate Shop, Clothing Repair, Coffee Shop, Computer and Accessories, Convenience Store, Cosmetics, Costume Shop, Courier Service, Dairy Products, Delicatessen, Diner, Do-It-Yourself Store, Durable Medical Equipment, DVD and Movies, Electrical Parts, Electronic and Video Game, Eletro/electronic Repair and Maintenance, Eyeglasses and Sunglasses, Fabric and Upholstery Store, Fast Graphic Service, Furniture Store, Gas Station, Gift Store, Gourmet and Specialty Food Store, Grocery Store, Gym, Hardware Store, Heating and Air Conditioning, Home and Gardening, Home and Kitchen Goods, Home Appliance, Home Improvement, Home Phone Provider, Hotels, Ice Cream Parlour, Janitorial/Cleaning Supplies, Jewelry, Kids Party Place, Kids Tutoring, Language School or Learning Center, Laundry and Dry Cleaning, Leisure and Tourism, Light Fixture, Lingerie and Intimate Apparel, Locksmith, Luggage and Suitcase Store, Men's Fashion, Motels, Motorcycle Dealer, Movie Theater, Moving Service, Musical Instrument Shop, Natural Food Store, Nautical Store, Nightclub/Disco, Office Supplies, Paint Store, Party Supply Store, Perfumery, Personal Development Course, Pet Shop, Pharmacy, Plastic Surgery, Refrigeration Shop, Restaurant (all kinds), Rotisserie, Rug and Curtain Shop, School, Shoe Repair, Shoe Store, SPA, Specialty Pharmacy, Sporting Goods, Sport Tickets, Supermarket, Surgical Equipment, Swimwear Fashion, Technical Course, Theaters, Tickets (ShowsConcerts), Toy Store, Travel Agency, Visual Communication, Winery, Women's Fashion, and/or the like.

In some implementations, ecos may also have an expiration date, in which they are deactivated once the expiration date has passed. In some implementations, donating and/or otherwise regifting ecos that are about to expire may reset the expiration date of the ecos.

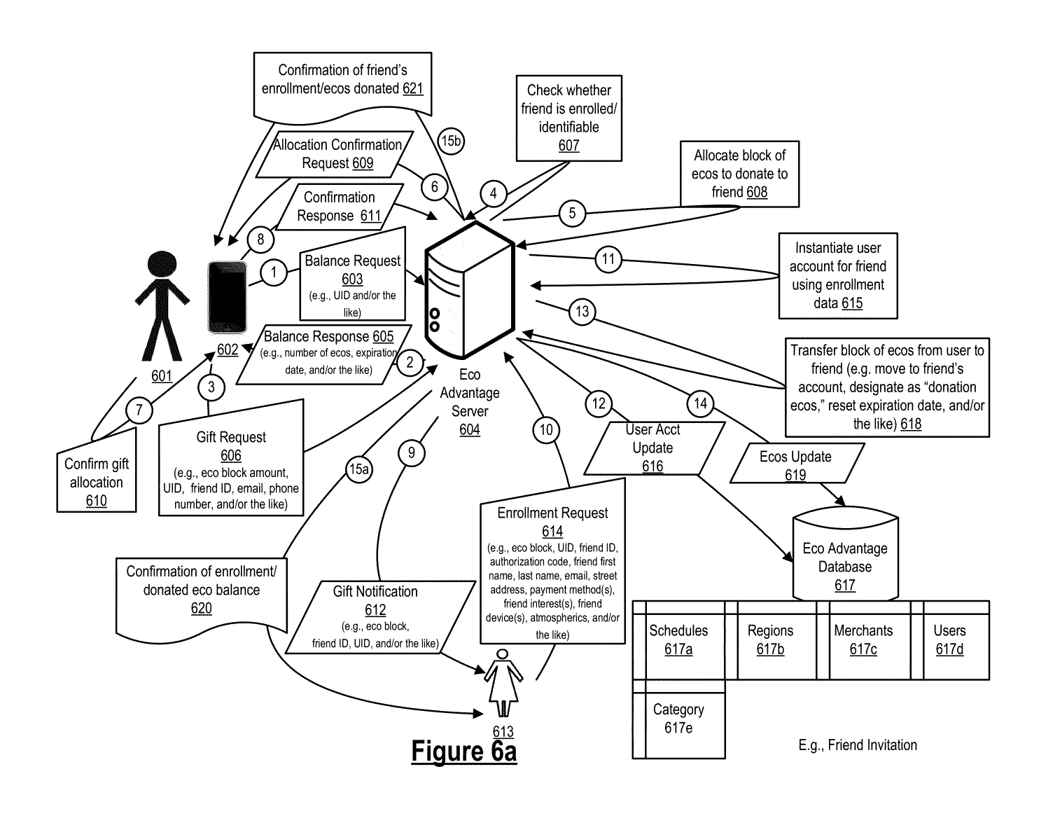

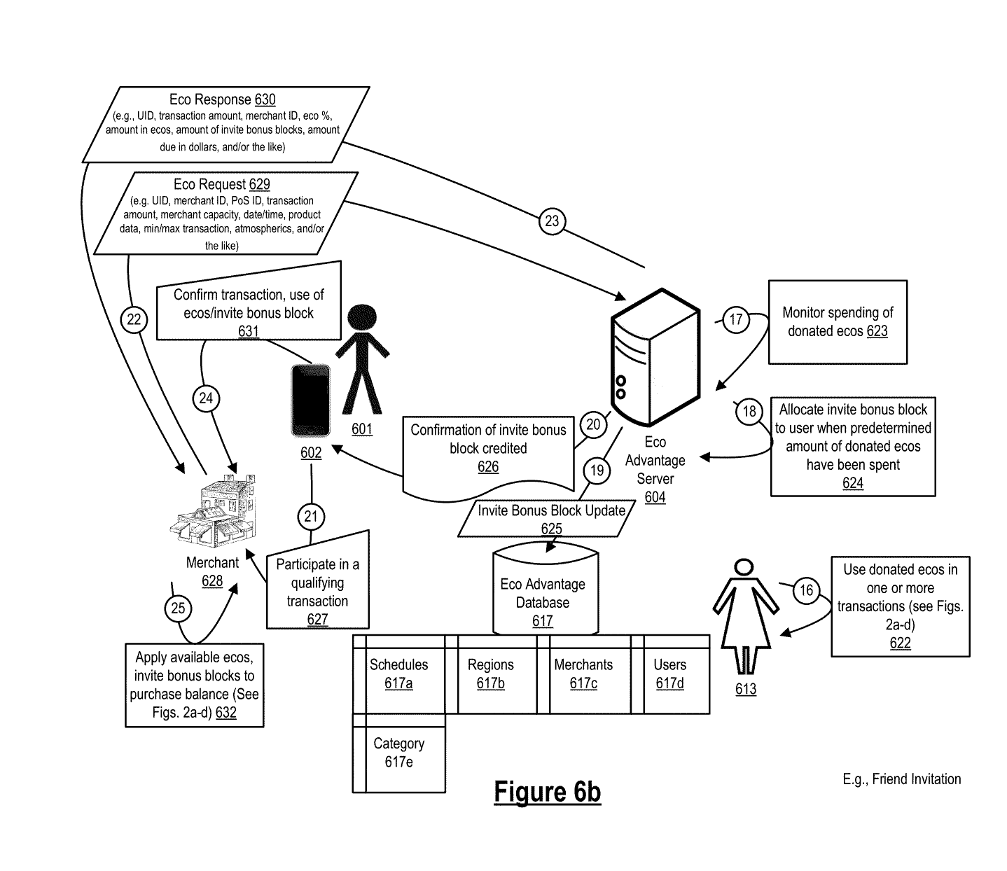

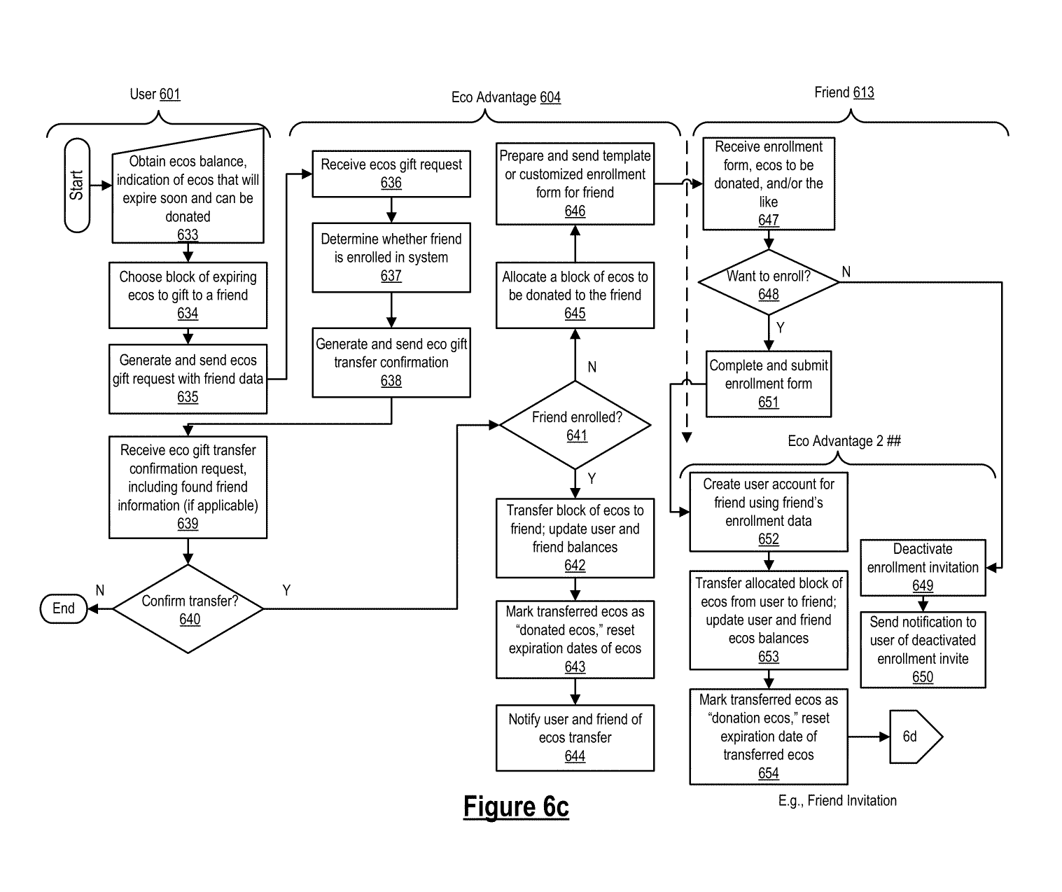

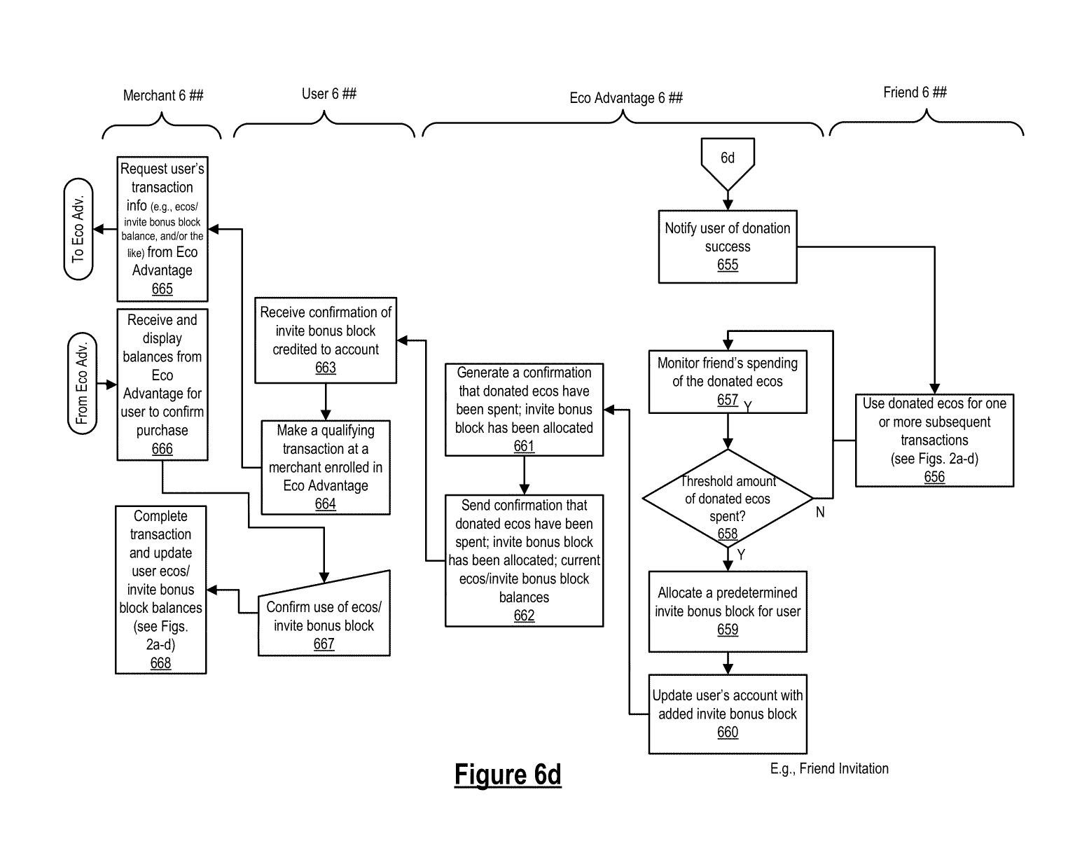

In some implementations, the user may also receive bonus blocks from referring other consumers to ECO ADVANTAGE (see FIGS. 6a-d). In some implementations bonus blocks may be blocks of money paid to the user by ECO ADVANTAGE as a result of bringing new users to ECO ADVANTAGE, and may be used in conjunction with ecos towards a purchase at any participating merchant. For example, in addition to the 20 ecos paid towards the $100 Best Buy transaction, a user may be able to use a $20 bonus block towards the purchase, lowering the out-of-pocket cost further (e.g. to $60). In some implementations there may be a variety of different types of bonus blocks, such as invite bonus blocks (e.g. bonus blocks for inviting other users), merchant bonus blocks (e.g. bonus blocks issued by merchants), and/or the like.

The term “place of business”, as herein used, means all the different geographic and non-physical locations where or through which an associated merchant conducts transactions, including shops, department stores, medical clinics, restaurants, pet shops, beauty parlors, traveling agencies, offices, hospitals, cabs, retailers, distributors, producers, manufacturers, kiosks, shopping centers, fairs, shows, cruise ships, flea markets, public markets—and also catalogs, websites, any device with private network or internet access: computer, personal computer, network device, workstation computer, handheld computer, tablet, smart phone, mobile phone, voice phone, POS electronic terminal, smart TV, set-top box, and/or the like.

FIG. 2a shows a data flow diagram illustrating performing a transaction in example embodiments of the ECO ADVANTAGE. In some implementations, a user 201 may interact with a merchant 202 via initiating a transaction for a product and/or service with the merchant 205. In some implementations, the user may initiate the transaction via the Point of Sales (PoS) device at the merchant location, via a merchant kiosk, via a personal electronic device (e.g. computer connected to a website, mobile device connected to an ECO ADVANTAGE application, and/or the like). In some implementations, the user may provide information to the merchant including the user's ID in ECO ADVANTAGE, the user's PIN (and/or a like form of authentication), and/or the like. In some implementations, the PoS device may also provide information such as the transaction amount, products and/or services being purchase, refunded, and/or the like, atmospherics at the time of the transaction, and/or like information. In some implementations, the merchant may send this information to the ECO ADVANTAGE server 203 via an eco request message 206. In some implementations, an exemplary XML-encoded eco request message 206 may take a form similar to the following:

```
POST /eco_request_message.php HTTP/1.1
Host: www.ECOADVANTAGEprocess.com
Content-Type: Application/XML
Content-Length: 788
<?XML version = ″1.0″ encoding = ″UTF-8″?>
<ecoRequest>
  <merchantId>2033</merchantId>
  <userId>102557952</userId>
  <userIdType>SSN</userIdType >
  <ecoId>3074</ecoId>
  <posId>4088</posId>
  <processingCode>683034</processingCode>
  <origDocNumber></origDocNumber>
  <nsu>572052</nsu>
  <mcc>6432</mcc>
  <merchantCapacity>27</merchantCapacity>
  <transactionAmount>100.0</transactionAmount>
  <minTransactionSize>10</minTransactionSize>
  <maxTransactionSize>500</maxTransactionSize>
  <transactionSize>1</transactionSize>
  <productData>broiled crabs</productData>
  <atmospherics>
    <dateTime>03/07/2013 03:39 PM</dateTime>
    <seating_pref>n_smoking</seating_pref>
    <party_size>2</party_size>
    <reserv_date>02/28/2013 03:39 PM</reserv_date>
    <weather>70F, sunny</weather>
    <product_pref>steak</product_pref>
  </atmospherics>
</ecoRequest>
```

In some implementations, sensitive information (e.g. the user PIN and/or the like) may be encrypted. In some implementations, the ECO ADVANTAGE server may look 207 for the merchant and the user using the information obtained in the eco request message, and may determine whether both entities are already enrolled in ECO ADVANTAGE. In some implementations, Grails code for looking up the user and merchant data mat take a form similar to the following:

```
def merchant = Merchant.get(params.merchantId);
  if (!merchant) {
    log.warn(″Merchant not found with value ′${params.merchant}′″);
    return sendError(′exception.merchant.not.found′);
  } elseif (!merchant.enabled | | !merchant.confirmed) {
    log.warn(″Merchant inactive with value ′${params.merchant}′″);
    return sendError(′exception.merchant.inactive′);
  } elseif (merchant.accountLocked) {
    log.warn(″Merchant account locked with value
′${params.merchant}′″);
    return sendError(′exception.merchant.locked′);
  }
  def schedule = merchant.getSchedules( )
  def user = User.get(params.userId);
  if (!user) {
    log.warn(″User not found with value ′${params.userId}′″);
    return sendError(′exception.user.not.found′);
  }elseif (!user.enabled | | !user.confirmed) {
    log.warn(″User inactive with value ′${params.userId}′″);
    return sendError(′exception.user.inactive′);
  } elseif (user.accountLocked) {
    log.warn(″User account locked with value ′${params.userId}′″);
    return sendError(′exception.user.locked′);
  }
```

The server may access the ECO ADVANTAGE database 209, via querying the database 208 for user and merchant records corresponding to the user and merchant specified in eco request 206.

In some implementations, ECO ADVANTAGE may query merchant 209C and user 209d tables of the ECO ADVANTAGE database in order to determine whether such records exist. In some implementations, the ECO ADVANTAGE database may return a user/merchant result 210 which may contain the found records pertaining to the user and/or merchant involved in the transaction. In some implementations, the user/merchant result 210 may take a form similar to the following:

```
merchant [
    id: 2033,
    name: ″NY some salon inc.″,
    mail: ″ny@somesalon.com″,
    document: ″32135743134″,
    dateCreated: ″05/05/2012″,
    username: ″salon″,
    password: encrypt(″salon123″),
    enabled: true,
    accountLocked: false,
    confirmed: true,
    phoneNumber: 254145451,
    contact: ″some joseph″,
    openingTimes: ″24h″,
    officialWebsite: ″www.somesalon.com″,
    region: 254,
    minConsumption: 10,
    maxConsumption: 500,
    bank: ″225″,
    bankAgency: ″2541-9″,
    bankAccount: ″123212121-3″
  ]
  user [
    id: 1025,
    name: ″John Tavares″,
    mail: ″john@somecompany.com″,
    document: ″336525544″,
    dateCreated: ″05/05/2012″,
    username: ″john″,
    password: encrypt(″john123″),
    enabled: true,
    accountLocked: false,
    confirmed: true,
    phoneNumber: ″654258225″
  ]
```

In some implementations, ECO ADVANTAGE may use these records to determine 211 a number of calculations, such as the number of ecos the user may use towards the transaction, the number and amount of bonus blocks the user may use towards the transaction, and/or the like. In some implementations, this may be determined based on the user check-in, based on the merchant's atmospherics, based on a merchant's eco schedule, based on the merchants current available capacity, projected available capacity, growth potential, and/or the like. In some implementations, Grails code for determining said calculations may resemble the following:

```
/* def merchant = Merchant.get(params.merchantId); */
/* def schedule = merchant.getSchedules( ) */
/* def user = User.get(params.userId); */
  def eco = Eco.getEcoFromCurrentSchedule(schedule)
  Checkin checkin = user.getLastCheckin
  (transaction.merchantId)
  if (checkin.isValidForTransaction (transaction.merchantId,
Now( ), transaction) {
    eco = Eco.updateEcoScheduleWithCheckin(eco, checkin)
  }
  checkin.markCheckingOut( )
  def saving = eco.saving
  def minTransactionSize = eco.minTransactionSize
  def maxTransactionSize = eco.maxTransactionSize
  def quantity = transaction.quantity
  def realValue = transaction.transactionAmount
  if ((realValue <minTransactionSize ) &&
  (realValue > maxTransactionSize
)) {
    error ″Amount must be between ${minTransactionSize}
and ${maxTransactionSize}″
  }
  def amountOfEcos = calculateValueToPayWithEco
(realValue, saving, transaction)
  def balanceForMerchant = getBalanceForMerchant
(transaction.user, transaction.merchant)
  if (amountOfEcos > balanceForMerchant) {
    error ″User insufficient balance″
    return
  }
  def amountDueInDollars =
calculateValueToPayWithRealMoney
(realValue, saving, transaction)
  BonusBlock bonusBlock = user.getValidBonusBlock( )
  if (bonusBlock) {
    if (amountDueInDollars > bonusBlock.value) {
      if (bonusBlock.isEligibleFor(transaction) {
      amountDueInDollars = amountDueInDollars -
      bonusBlock.value
    }
  }
  }
  public static BigDecimal calculateValueToPayWithEco
(BigDecimal realValue, Double saving, Integer quantity =1){
    if(!realValue | | !saving | | realValue == 0 | | saving == 0) {
        return 0;
    }
    return Math.round((realValue * quantity) -
(realValue.divide (1 + (saving / 100), 2,
RoundingMode.HALF_UP)) * quantity);
  }
  public static BigDecimal
calculateValueToPayWithRealMoney
(BigDecimal realValue, Double saving,
Transaction transaction) {
    if(!realValue | | !saving | | realValue == 0 | | saving == 0) {
        return 0;
    }
    return (realValue * quantity) -
calculateValueToPayWithEco(realValue, saving, transaction)
  }
  def getBalance( ) {
    def result = 0;
    def userBalance = Transaction.executeQuery(
        ″select sum(value * signal) as balance from
Transaction ″ +
        ″where user.id = :userId ″ +
        ″ and date <= :date ″,
        [userId: userId, date: new Date( )]);
    return result;
  }
  def getBalanceForMerchant(User user, Merchant merchant) {
    def result = 0;
    def balance = this.getBalance( );
    def merchantAdjustBalance =
    UserMerchantAdjust.executeQuery(
        ″select sum(value) from UserMerchantAdjust ″ +
        ″where user.id = :userId ″ +
        ″ and merchant.id = :merchantId ″ +
        ″ and adjustDate <= :date ″,
        [userId: user.id, merchantId: merchant.id, date: new
Date( )])?.first( );
    if (!merchantAdjustBalance) {
      merchantAdjustBalance = 0;
    }
    return balance + merchantAdjustBalance;
  }
```

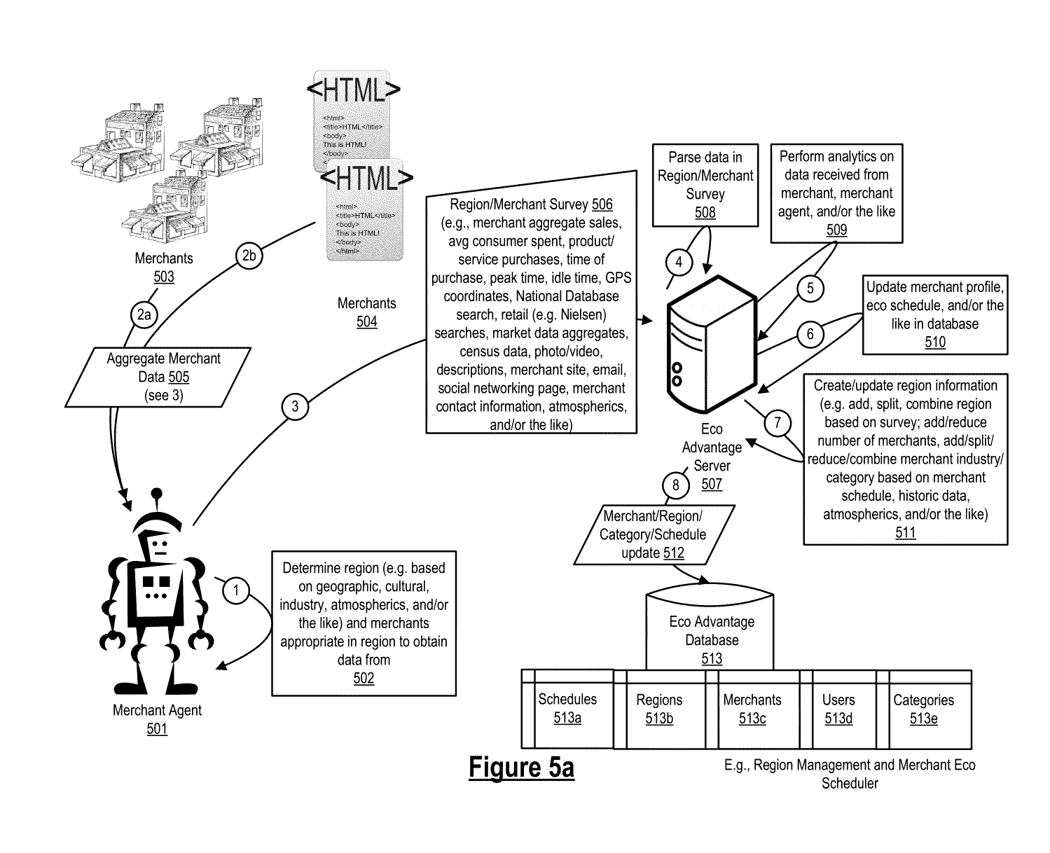

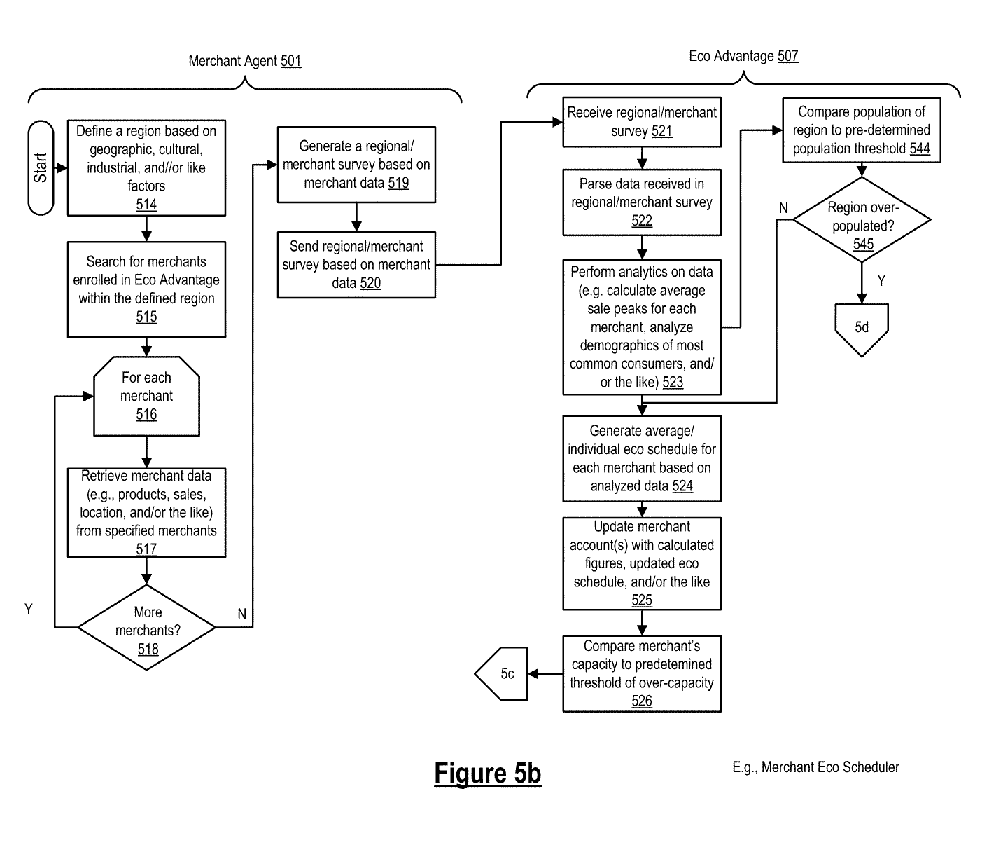

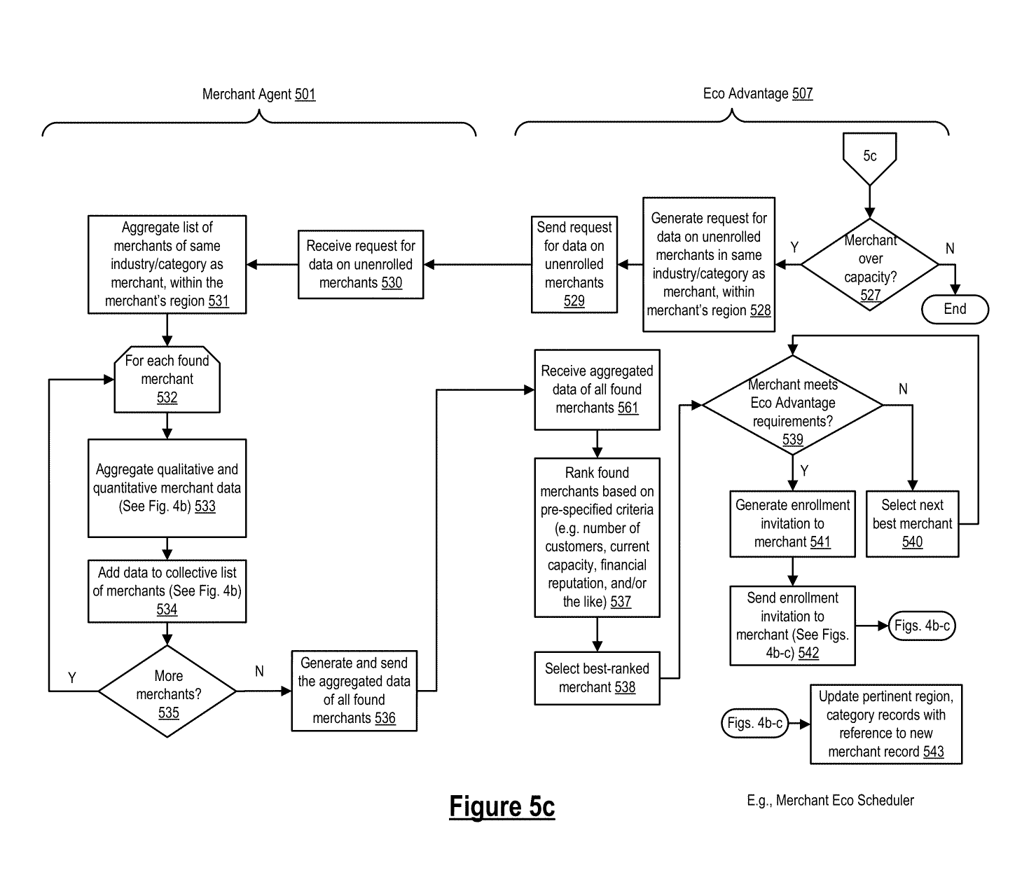

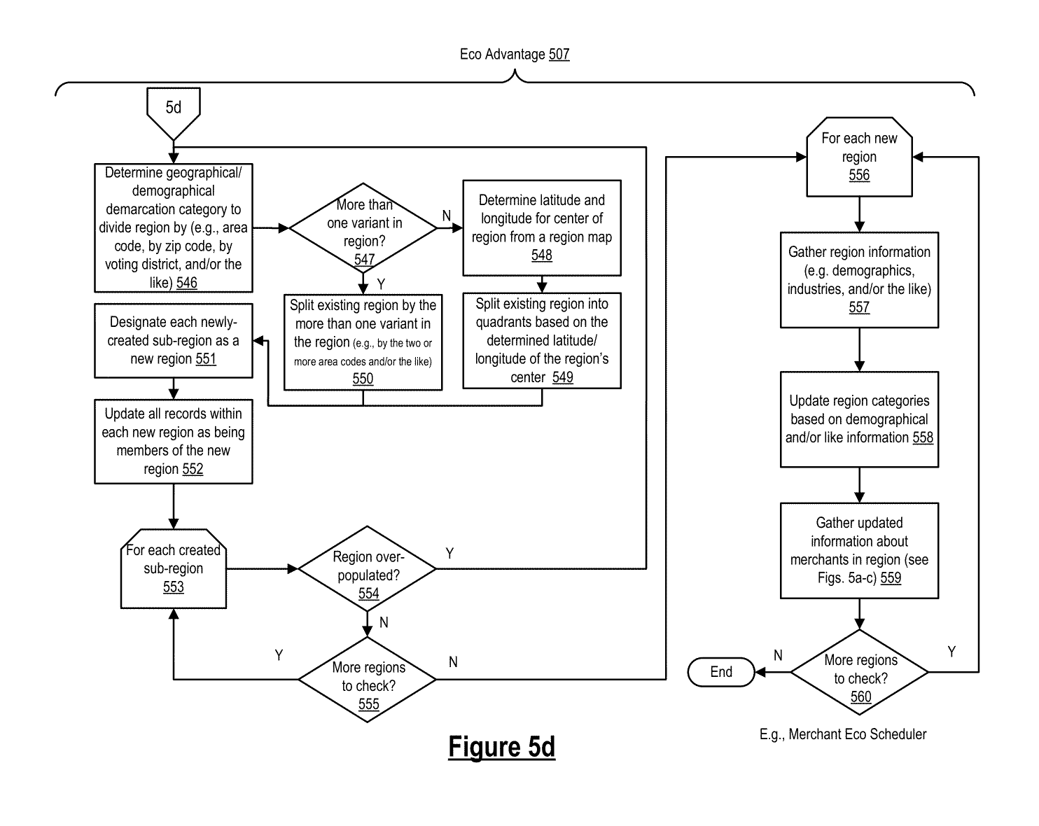

In some implementations, the merchant's eco schedule may be a schedule that outlines the percentage of a given transaction at the merchant that may be paid by the user with ecos. In some implementations this schedule may be based on information such as the merchant's atmospherics, volume of transactions, products of transaction, based on user's total transaction by period or to date, total ecos usage by period or to date, total ecos donated by period or to date, total ecos donated and used by period or to date, number of active friends by period or to date, some factor thereof, and/or the like 18 (see FIGS. 5a-d for more information).

In some implementations, the ECO ADVANTAGE server may send this information to the merchant via an eco response 212. In some implementations an XML-encoded eco response may take a form similar to the following:

```
POST /eco_request_message.php HTTP/1.1
Host: www.ECOADVANTAGEprocess.com
Content-Type: Application/XML
Content-Length: 788
<?XML version = ″1.0″ encoding = ″UTF-8″?>
<ecoResponse>
  <UID>da6c5cdf4e90b2961873f7b2e863415</UID>
  <transactionId>635467</transactionId>
  <transactionAmount>100.0</transactionAmount>
  <merchantId>2033</merchantId>
  <ecoSaving>20%</ecoSaving>
  <userEcoBalance>1091</userEcoBalance>
  <amountDueInDollars>77.0</amountDueInDollars>
  <userEcoUsage>23</userEcoUsage>
  <userBonusBlockUsage>0</userBonusBlockUsage>
  <atmospherics>
    <dateTime>03/07/2013 03:39 PM</dateTime>
    <seating_pref>n_smoking</seating_pref>
    <party_size>2</party_size>
    <reserv_date>02/28/2013 03:39 PM</reserv_date>
    <weather>70F, sunny</weather>
    <product_pref>steak</product_pref>
  </atmospherics>
<ecoResponse>
```

In some implementations, the merchant may use the information obtained to display 213 the updated transaction information to the user, which may include the user's eco balance, the number of ecos that may be used in the transaction, the new transaction balance if ecos are applied, the user's new ecos balance should the ecos be applied, and/or the like. In some implementations, the merchant may use the information may include the user's bonus block balance, the bonus blocks that may be used in the transaction, the transaction balance if bonus blocks are applied, the user's new bonus blocks balance should the bonus blocks be applied, and/or the like. The user may confirm 214 the transaction and the use of ecos. In some implementations the user may confirm the use of bonus blocks independently. In some implementations the user may confirm via pressing a button and/or the like on a PoS terminal at the merchant, or via a mobile application, SMS, a website, NFC/RFID and/or like proximity tags, UTP devices, internet-enabled electronic devices, and/or the like. In some implementations the merchant may send a payment request 215 to an acquirer 204 in order to initiate the processing of the transaction. In some implementations, the acquirer may directly procure funds for the merchant; in other implementations, the acquirer may be an intermediate between the merchant and another acquiring entity (e.g., another acquiring bank, and/or the like). In some implementations, the payment request 215 may be an XML-encoded, encrypted message and may take a form similar to the following:

```
POST /payment_request_message.php HTTP/1.1
Host: www.ECOADVANTAGEprocess.com
Content-Type: Application/XML
Content-Length: 788
<?XML version = ″1.0″ encoding = ″UTF-8″?>
<paymentRequest>
  <UID>da6c5cdf4e90b2961873f7b2e863415</UID>
  <transactionId>635467</transactionId>
    <merchantId>2033</merchantId>
    <posId>4088</posId>
    <amountDueInDollars>77.0</amountDueInDollars>
    <dateTime>03/07/2013 03:39 PM</dateTime>
    <userCard>3214 3578 3568 3542</userCard>
</paymentRequest>
```

In some implementations, the acquirer may only receive the transaction balance (e.g., the out-of-pocket cost after ecos and/or bonus blocks have been applied to the transaction total). In some implementations the acquirer may use the information in the transaction request in order to generate messages to the various payment entities who may be involved in the procurement of the user's payment 216. For example, the acquirer may interact with the user's issuing bank, the merchant's bank account, one or more other acquiring entities, and/or the like, in order to process the transaction. In some implementations those entities may be another acquirer, another financial institution, payment gateway, online payment service (e.g., PayPal), Electronic Funds Transfer Network (e.g., Swift), and/or the like. In some implementations, Grails code for processing the transaction may take a form similar to the following:

```
Card card = Card.get(userCard);
  Merchant merchant = Merchant.get(merchantId)
  Try {
    beginTransaction( )
    card.debit(amountDueInDollars)
    merchant.credit(amountDueInDollars)
    commitTransaction( );
    return true;
  }catch (Exception) {
    rollbackTransaction( );
    return false;
  }
```

Once processed, the acquirer may send a transaction confirmation 217 to the merchant, indicating whether the transaction was approved (e.g. successful) or declined (e.g. failed). In some implementations, the transaction confirmation may take a form similar to the following:

### POST/transaction_confirmation_message.php HTTP/1.1

```
Host: www.ECOADVANTAGEprocess.com
Content-Type: Application/XML
Content-Length: 788
<?XML version = ″1.0″ encoding = ″UTF-8″?>
<paymentConfirmation>
  <UID>da6c5cdf4e90b2961873f7b2e863415</UID>
  <transactionId>635467</transactionId>
  <merchantId>2033</merchantId>
  <posId>4088</posId>
  <amounDueInDollars>77.0</amountDueInDollars>
  <debitCreditAmount>77.0</debitCreditAmount>
  <cashAmount>0.0</cashAmount>
  <totalAmount>100</totalAmount>
  <dateTime>03/07/2013 03:40 PM</dateTime>
  <approved>true</approved>
</paymentConfirmation>
```

In some implementations, the merchant may provide a transaction receipt 218 to the user, indicating the user's new eco balance and/or like information. In some implementations, the receipt may be printed and/or displayed on the merchant's PoS device. In some implementations the receipt may take a form similar to the following:

DOCUMENT: NNN.NNN.NNN-NN ID EAS: IIIIII

| | |
|---|---|
| ORIGINAL VALUE: | VVV.VVV,VV |
| BONUS BLOCK VALUE: | VVV.VVV,VV |
| ECONOMY: | EEE.EEE,EE |
| VALUE PPPPPPPPPP: | TTT.TTT,TT |

NNNNNNNNNNNNNNNNNNNNNNNNNNNNNNNNNNNNNNNN

| | |
|---|---|
| ECO BALANCE: | BBB.BBB,BB |

FFFFFFFFFFFFFFFFFFFFFFFFFFFFFFFFFFFFFFFF

The merchant may also forward 219 the transaction confirmation to ECO ADVANTAGE. In some implementations transaction confirmation 219 may take a form similar to the following:

```
<transactionConfirmation>
  <UID>da6c5cdf4e90b2961873f7b2e863415</UID>
  <transactionId>635467</transactionId>
  <merchantId>2033</merchantId>
  <posId>4088</posId>
  <amounInDollars>77.0</amountDueInDollars>
  <debitCreditAmount>77.0</debitCreditAmount>
  <cashAmount>0.0</cashAmount>
  <dateTime>03/07/2013 03:40 PM</dateTime>
  <approved>true</approved>
</transactionConfirmation>
```

ECO ADVANTAGE may use the confirmation to update 220 the user's account (e.g. by deducting the ecos used in the transaction, by adding to the user account new ecos identified as being from the merchant, and/or the like). In some implementations Grails code for updating the user's account may take a form similar to the following:

```
Transaction transaction = Transaction.get(transactionId)
User user = transaction.getUser( )
Merchant merchant = transaction.getMerchant( )
long ecoUsage = transaction.getEcoUsage( )
long bonusBlockUsage = transaction.getBonusBlockUsage( )
long amountDueInDollars = transaction.getAmountDueInDollars( )
  Try {
    beginTransaction( )
    user.debitEco(ecoUsage)
    user. debitBonusBlock(bonusBlockUsage)
    user.creditEco(amountDueInDollars, merchant)
    commitTransaction( );
  } catch (Exception) {
    rollbackTransaction( );
    return false;
  }
```

ECO ADVANTAGE may also update 221 the merchant's account (e.g. linking the merchant account to a record of the transaction, updating the merchant's BI information and schedules, atmospherics, and/or the like). In some implementations Grails code for updating the merchant account may take a form similar to the following:

Transaction transaction = Transaction.get(transactionId)
Merchant merchant = transaction.getMerchant( )
User user = transaction.getUser( )
long ecoUsage = transaction.getEcoUsage( )
long bonusBlockUsage = transaction.getBonusBlockUsage( )
def historyTransaction = new HistoryTransaction
(transaction, merchant, user, ecoUsage, bonusBlockUsage)
historyTransaction.save( )

In some implementations, ECO ADVANTAGE may also monitor the status of various transactions, and may reverse, retry, and/or otherwise handle incomplete transactions if found in the ECO ADVANTAGE database's records, based on predetermined criteria.

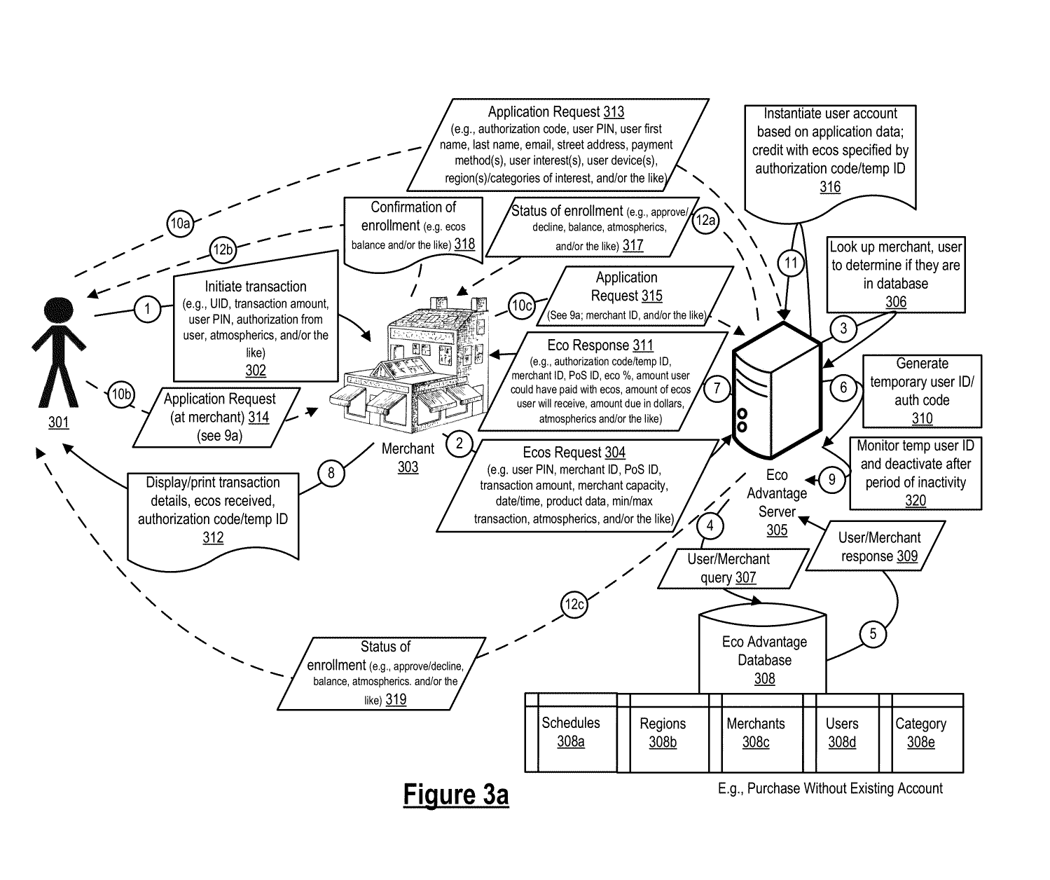

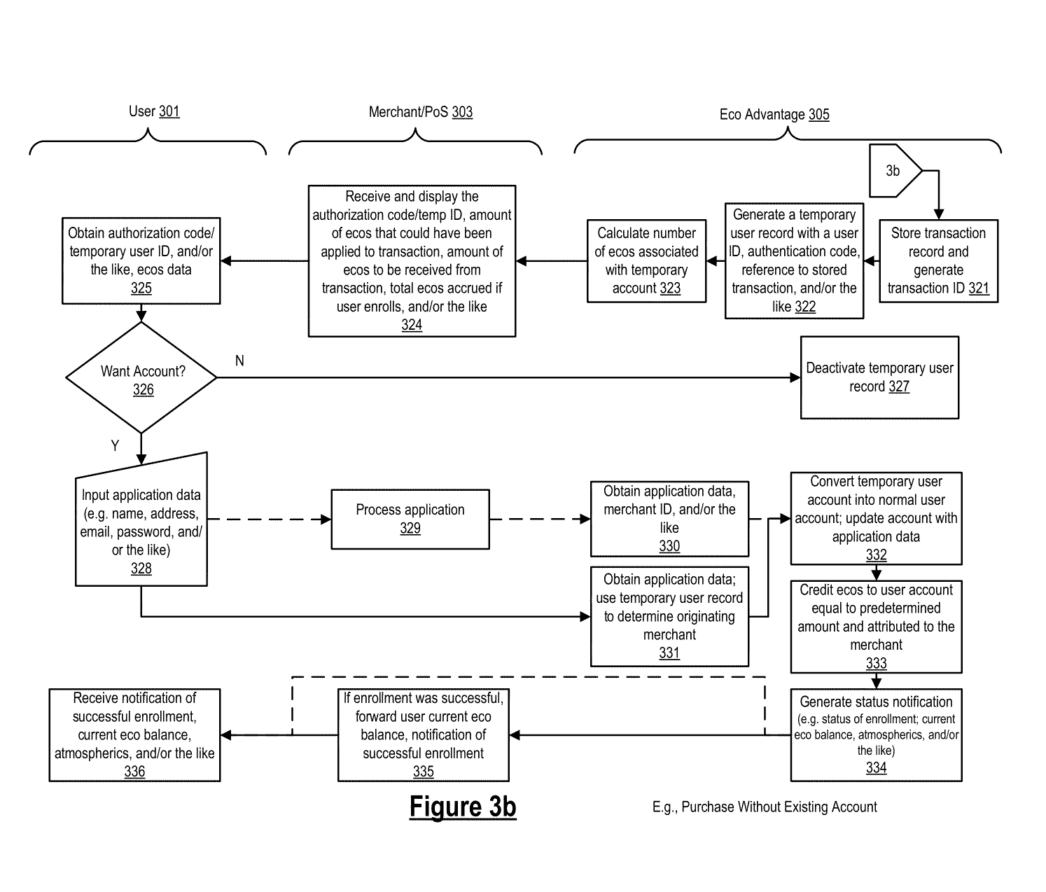

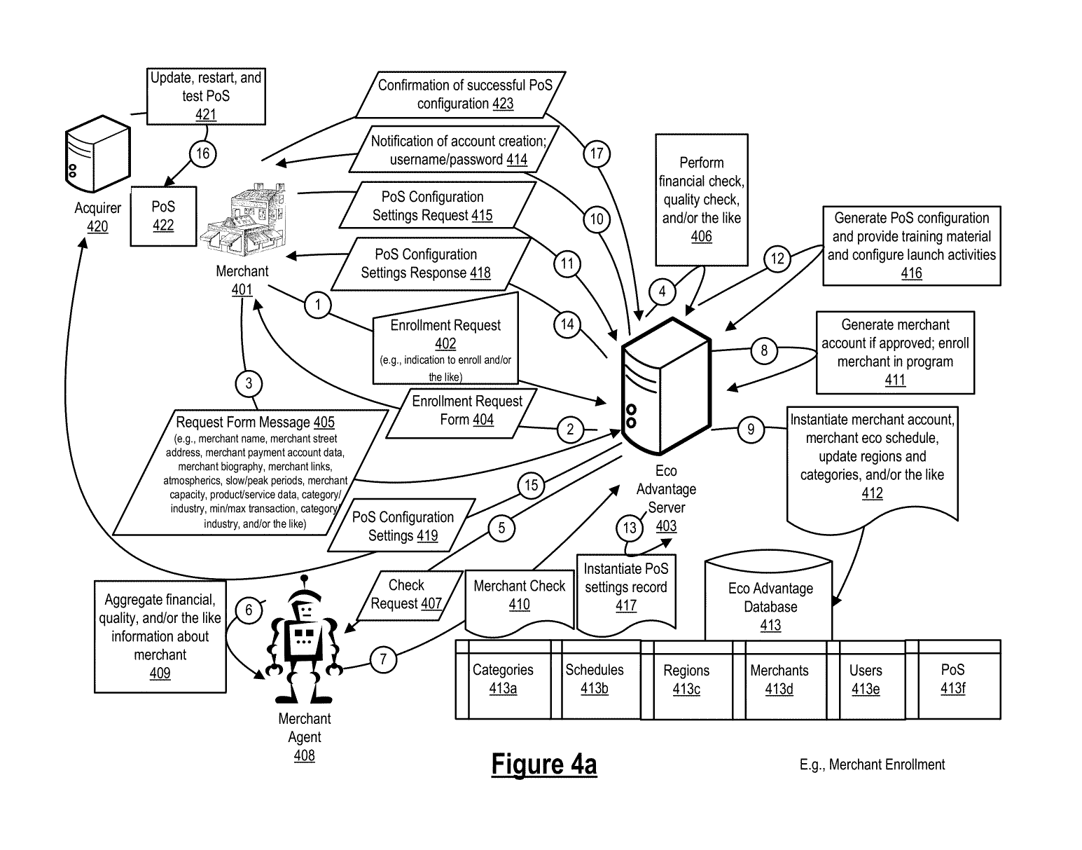

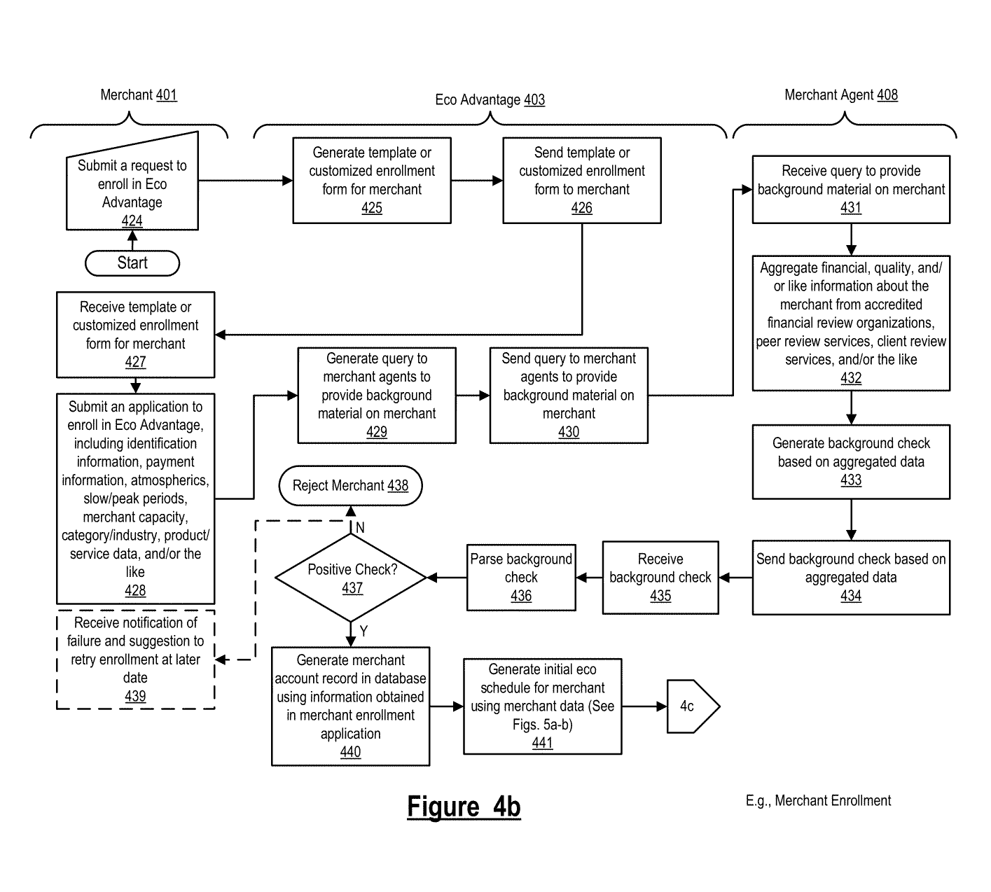

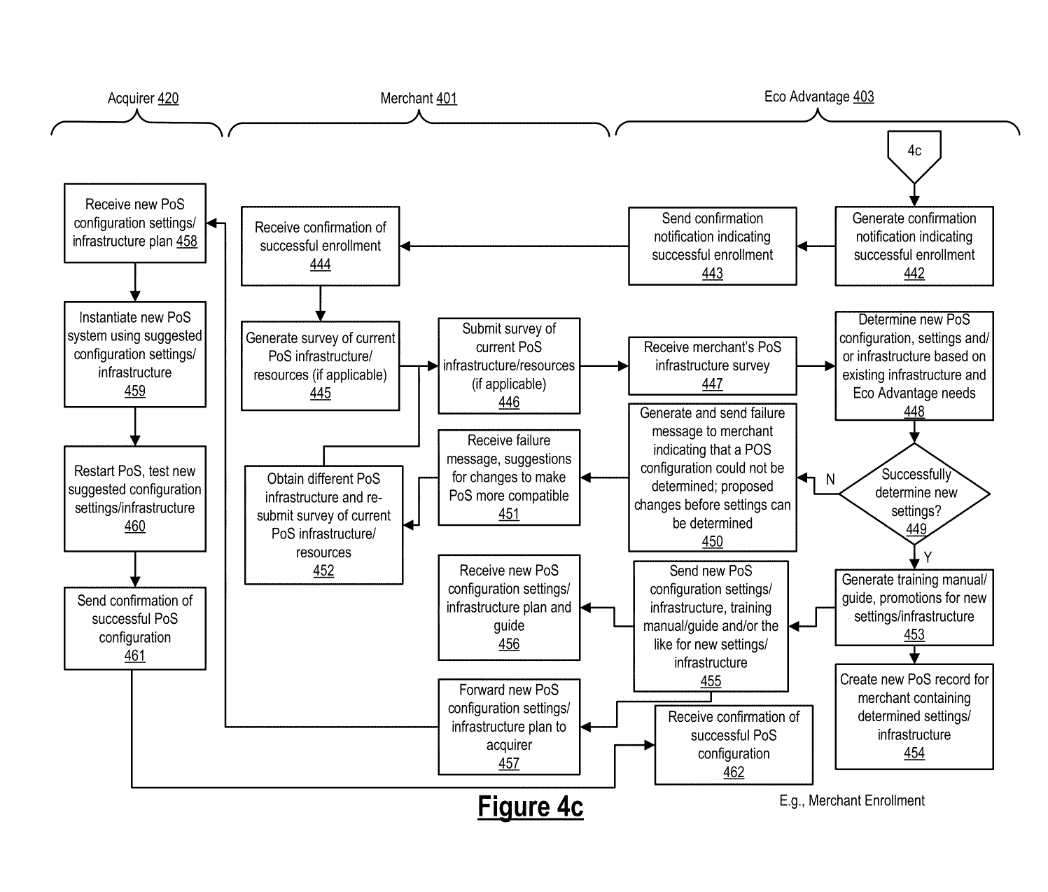

FIG. 2b shows a logic flow diagram illustrating performing a transaction in example embodiments of the ECO ADVANTAGE. In some implementations, a user may initiate a transaction with a merchant 226 by providing information such as the user's UID, the user's PIN, and/or the like. The merchant may receive 227 the user's information, and may send it to ECO ADVANTAGE, which may be prompted to use the information 228 to verify that the user is in ECO ADVANTAGE. In some implementations, ECO ADVANTAGE may query the ECO ADVANTAGE Database 229 to determine if there is a merchant and/or a user record for the entities involved. If a merchant record is not found 230, the merchant may be prompted to enroll in ECO ADVANTAGE (see FIGS. 4b-c). If a merchant record is found but there is no valid PoS record 231 for the merchant, the merchant may be prompted to submit PoS information and/or to update PoS settings and/or configurations if necessary (see FIG. 4c). If the merchant record is found and there is a valid PoS record for it, but there is no record for the user 232, ECO ADVANTAGE may prompt the merchant to allow the user to enroll in ECO ADVANTAGE (see FIG. 3b).

If a user record is found, ECO ADVANTAGE may retrieve from the user record the user's eco balance 233, and may determine which ecos are marked as being from the merchant involved in the transaction. As mentioned above, in some implementations, ecos marked as being from the merchant involved may not be usable for the transaction. In addition, ECO ADVANTAGE may retrieve from the user record any available bonus blocks, and may determine which may be used towards the purchase. ECO ADVANTAGE may calculate 234 the number of ecos that may be applied to the transaction in general, based on the merchant's eco schedule in its merchant record, and/or the like. ECO ADVANTAGE may send the user's eco balance, the merchant's eco schedule, the amount of ecos that the user may use towards the particular transaction, the remaining balance, and/or the like, to the merchant.

After obtaining 235 this information, the merchant may prompt the user to authorize the use of its ecos and/or bonus blocks, and to authorize charging the rest to a credit/debit card stored in ECO ADVANTAGE, a new credit/debit card, authorize paying the balance in cash, and/or the like. The user may authorize 236 the transaction, including authorizing the use of ecos, bonus blocks, and/or a debit/credit card, and may use the merchant's PoS device to authorize the transaction. The merchant may send 237 the amount to be charged to the user to the merchant's acquirer for procurement. In some implementations, the acquirer may receive 238 the transaction information, and may forward the pertinent information to the user's issuing bank 239 in order to procure the funds. In other implementations, the acquirer may forward the information to a different entity, such as another acquirer and/or a like entity who will directly interact with the user's issuer. In some implementations, the acquirer may receive a response 240 from the issuer and/or like entity, indicating whether the procurement of funds was successful or not. The acquirer may forward this information to the merchant, who, if the transaction was unsuccessful 241, may forward 248 the notification of the failed transaction to ECO ADVANTAGE 249 and the user 250, who may be prompted to retry the transaction. In some implementations ECO ADVANTAGE may also mark all records related to the transaction record as being incomplete and in need of further action. If the transaction was successful, the merchant may forward 242 the notification of the successful transaction to ECO ADVANTAGE, which may create 243 a transaction record for the transaction and store the record in the ECO ADVANTAGE Database. ECO ADVANTAGE may also update the merchant 245 and user 244 accounts records. In some implementations, the merchant record may be updated with a link to the transaction record, updated eco and usage schedule information, BI information, and/or the like. In some implementations updating the merchant record may also involve queuing later services, such as reconciliation, reporting, updating BI user information, and/or the like. In some implementations, updating the user record may involve updating the user record via deducting the ecos and/or bonus blocks used in the transaction, crediting new ecos to the user (said ecos being marked as coming from the merchant), and/or the like. In some implementations, the amount of new ecos received may be a predetermined amount based at least partially on the transaction amount. In some implementations ECO ADVANTAGE may forward 246 the notification of the successful transaction to the user, who may receive the notification 247 and may store the notification for future reference.

FIG. 2c shows a data flow diagram illustrating performing an online transaction in example embodiments of the ECO ADVANTAGE. In some implementations, the user may choose products and/or services on a merchant website, application, or SMS 252 to purchase via a personal computer, mobile device, merchant kiosk, and/or a like electronic device separate from a merchant PoS device. The online merchant 270 may collect from the user choices product IDs, a running total of the user's transaction balance, the user's ID and login credentials for the merchant website 22 (e.g. username and password), atmospherics for the merchant, and/or the like. The merchant may also send an eco request 253 to ECO ADVANTAGE. In some implementations the eco request may take a form similar to the following:

```
POST /eco_request_message.php HTTP/1.1
Host: www.ECOADVANTAGEprocess.com
  Content-Type: Application/XML
Content-Length: 788
<?XML version = ″1.0″ encoding = ″UTF-8″?>
<ecoRequest>
  <UID>da6c5cdf4e90b2961873f7b2e863415</UID>
  <transactionId>635467</transactionId>
  <transactionAmount>100.0</transactionAmount>
  <merchantId>2033</merchantId>
  <userId>102557952</userId>
  <userIdType>SSN</userIdType >
  <deviceId>961873f7b2e863415da6c5cdf4e90b2</deviceId>
  <processingCode>683034</processingCode>
  <origDocNumber></origDocNumber>
  <nsu>572052</nsu>
  <mcc>6432</mcc>
  <merchantCapacity>27</merchantCapacity>
  <minTransactionSize>10</minTransactionSize>
  <maxTransactionSize>500</maxTransactionSize>
  <transactionSize>1</transactionSize>
  <productData>
    <sku>6483953</sku>
    <description>television</description>
  </productData>
  <atmospherics>
    <dateTime>03/07/2013 03:39 PM</dateTime>
    <seating_pref>n_smoking</seating_pref>
    <party_size>2</party_size>
    <reserv_date>02/28/2013 03:39 PM</reserv_date>
    <weather>70F, sunny</weather>
    <product_pref>steak</product_pref>
  </atmospherics>
</ecoRequest>
```

In some implementations, sensitive information (e.g. the user PIN and/or the like) may be encrypted. Similar to FIG. 2a, ECO ADVANTAGE may send a query 255 to the ECO ADVANTAGE database 209, and may retrieve merchant and user data 254, and use the data provided in the query result 256 to determine 257 the amount of ecos the user may apply to the purchase, the number of ecos and/or bonus blocks the user has in its eco and/or bonus block balances, and/or the like. The ECO ADVANTAGE may send an eco response 258 back to the online merchant with said information. In some implementations the eco response may take a form similar to that of eco response in FIG. 2a. In some implementations, the online merchant may generate a page for the user which displays 259 the user's eco and/or bonus block balances, transaction balance remaining, and/or like information to the user, and prompts the user to confirm the transaction given said information.

The user may confirm the transaction 260, and any information the online merchant has collected from the user (e.g. user ID, user authorization, and/or the like) may be sent to the acquirer 204 via payment request 261, which may take a form similar to that of payment request 215 in FIG. 2a. In some implementations the acquirer may also be a Payment Gateway, which may be a bank, an online payment service (e.g. PayPal), electronic funds transfer, and/or the like. The acquirer may process the transaction information and procure payment 262 via sending a transaction request 263 to another payment entity 271 (e.g. the user's issuer, another acquiring entity, and/or the like) for processing. The payment entity may send back to the acquirer a transaction response 264, which may indicate whether the transaction was successfully processed or not. The acquirer may forward this notification via transaction confirmation 265, which the online merchant may use to generate a receipt page 266, and which the online merchant may use to generate an electronic receipt that it may send to the user's ECO ADVANTAGE, email address, and/or the like. The online merchant may also forward the transaction confirmation to ECO ADVANTAGE 267, and ECO ADVANTAGE may use the confirmation information to update 268 the user's eco and/or bonus block balances (e.g. deducting used ecos and/or bonus blocks, crediting new ecos, and/or the like), and to update 269 the merchant's account in a manner similar to FIG. 2a. in some implementations, ECO ADVANTAGE may receive the transaction confirmation directly from the acquirer.

FIG. 2d shows a logic flow diagram illustrating performing an online transaction in example embodiments of the ECO ADVANTAGE. In some implementations, a user may initiate a transaction with a merchant 298 by providing information such as the user's UID, the user's PIN, and/or the like. The merchant may receive 272 the user's information, and may send it to ECO ADVANTAGE, which may be prompted to use the information 273 to verify that the user is in ECO ADVANTAGE. In some implementations, ECO ADVANTAGE may query the ECO ADVANTAGE database 274 to determine if there is a merchant and/or a user record for the entities involved. If a merchant record is not found 275, the merchant may be prompted to enroll in ECO ADVANTAGE (see FIGS. 4b-c). If a merchant record is found but there is no valid PoS record 279 for the merchant, the merchant may be prompted to submit PoS information and/or to update PoS settings and/or configurations if necessary (see FIG. 4c). If the merchant record is found and there is a valid PoS record for it, but there is no record for the user 277, ECO ADVANTAGE may prompt the merchant to allow the user to enroll in ECO ADVANTAGE (see FIG. 3b).

If a user record is found, ECO ADVANTAGE may retrieve from the user record the user's eco balance 278, and may determine which ecos are marked as being from the merchant involved in the transaction. As mentioned above, in some implementations, ecos marked as being from the merchant involved may not be usable for the transaction. In addition, ECO ADVANTAGE may retrieve from the user record any available bonus blocks, and may determine which may be used towards the purchase. ECO ADVANTAGE may calculate 279 the number of ecos that may be applied to the transaction in general, based on the merchant's eco schedule in its merchant record, and/or the like. ECO ADVANTAGE may generate and send 280 the user's eco balance, the merchant's eco schedule, the amount of ecos that the user may use towards the particular transaction, the remaining balance, and/or the like, to the merchant.

After receiving 281 this information, the merchant may prompt the user to authorize the use of its ecos and/or bonus blocks, and to authorize charging the rest to a credit/debit card stored in ECO ADVANTAGE, a new credit/debit card, authorize paying the balance in cash, and/or the like, via generating a transaction confirmation page 282 which contains the user's transaction information (e.g. current eco and/or bonus block balances, balances after transaction is authorized, and/or the like). The user may authorize 283 the transaction, including authorizing the use of ecos, bonus blocks, and/or a debit/credit card via the confirmation page. The merchant may send 284 the amount to be charged to the user to the merchant's acquirer for procurement. In some implementations, the acquirer may receive 285 the transaction information, and may forward the pertinent information to the user's issuing bank 286 in order to procure the funds. In other implementations, the acquirer may forward the information to a different entity, such as another acquirer, another bank, an online payment service, an electronic funds transfer service, and/or the like, and/or a like entity who will directly interact with the user's issuer. In some implementations, the acquirer may receive a response 287 from the issuer and/or like entity, indicating whether the procurement of funds was successful or not. The acquirer may forward this information to the merchant, who, if the transaction was unsuccessful 288, may forward 295 the notification of the failed transaction to ECO ADVANTAGE 296 and the user 297, who may be prompted to retry the transaction. If the transaction was successful, the merchant may forward 289 the notification of the successful transaction to ECO ADVANTAGE, which may create a transaction record for the transaction and store the record in the ECO ADVANTAGE Database. ECO ADVANTAGE may also update the merchant 292 and user 291 accounts records. In some implementations, the merchant record may be updated with a link to the transaction record, updated eco schedule information, BI information, and/or the like. In some implementations, updating the user record may involve updating the user record via deducting the ecos and/or bonus blocks used in the transaction, crediting new ecos to the user (said ecos being marked as coming from the merchant), and/or the like. In some implementations, the amount of new ecos received may be a predetermined amount based at least partially on the transaction amount. In some implementations ECO ADVANTAGE may forward 293 the notification of the successful transaction to the user, who may receive the notification 294 and may store the notification for future reference.

FIG. 3a shows a data flow diagram illustrating performing an online transaction without an ECO ADVANTAGE account in example embodiments of the ECO ADVANTAGE. In some implementations, a user 301 may initiate 302 a transaction with a merchant 303 via providing transaction information to the merchant, and a unique user PIN and/or identifier (e.g. a social security number, phone number, and/or the like). In some implementations, the merchant may send an eco request 304 to ECO ADVANTAGE 305 (which may take a form similar to eco request 206), indicating that a person at the merchant would like to initiate a transaction. In some implementations, sensitive information (e.g. the user PIN and/or the like) may be encrypted. In some implementations eco request 304 may be similar to eco request 206. ECO ADVANTAGE may look up 306 the merchant and the user in the ECO ADVANTAGE database in order to determine whether either entity is in the database, via send a user and merchant information query 307 to the user 308d and merchant 308c tables of the ECO ADVANTAGE database 308. In some implementations a PHP-encoded user and merchant query 307 may take a form similar user/merchant query 208.

In some implementations, the ECO ADVANTAGE database may send a user and merchant response 309 to ECO ADVANTAGE indicating whether the records were successfully found, and the information requested. In some implementations, the user and merchant response 309 may take a form similar to the following:

| | |
|---|---|
| merchant [ | |
| | id: 2033, |
| | name: ″NY some salon inc.″, |
| | mail: ″ny@somesalon.com″, |
| | document: ″32135743134″, |
| | dateCreated: ″05/05/2012″, |
| | username: ″salon″, |
| | password: ″salon123″, |
| | enabled: true, |
| | accountLocked: false, |
| | confirmed: true, |
| | phoneNumber: 254145451, |
| | contact: ″some joseph″, |
| | openingTimes: ″24h″, |
| | officialWebsite: ″www.somesalon.com″, |
| | region: 254, |
| | minConsumption: 1, |
| | maxConsumption: 5, |
| | bank: ″225″, |
| | bankAgency: ″2541-9″, |
| | bankAccount: ″123212121-3″ |
| ] | |
| user | [ |
| | ] |

If a user account was not found (e.g., if the user does not yet have an account with ECO ADVANTAGE), ECO ADVANTAGE may generate 310 a temporary user ID/authorization code for the user, which may be used to keep track of the transaction details, and/or to allow the user to enroll in ECO ADVANTAGE. In some implementations Grails code for generating the temporary user ID may take a form similar to the following:

```
TemporaryUser tempUser = new TemporaryUser(
  authorizationCode: <auto-increment>,
  uniqueNumber: userPersonalUniqueNumber,
  document: userdocument,
  userDocumentType: ″SSN″,
  initialBalance: receivedEcos
  dateCreated: <today>,
  )
tempUser.save( )
```

In some implementations, ECO ADVANTAGE may send an eco response 311 to the merchant. An XML-encoded eco response 311 may take a form similar to the following:

```
POST /eco_response.php HTTP/1.1
Host: www.ECOADVANTAGEprocess.com
Content-Type: Application/XML
Content-Length: 788
<?XML version = “1.0” encoding = “UTF-8”?>
<ecoResponse>
  <authorizationCode>109654324</authorizationCode>
  <ecosCouldBeUsed>23</ecosCouldBeUsed>
  <receivedEcos>77</receivedEcos>
  <ecoSaving>20%</ecoSaving>
<ecoResponse>
```

In some implementations, the merchant may print or display 312 the information received from ECO ADVANTAGE for the user, so that the user may register for an ECO ADVANTAGE account and use the ecos he received via the transaction. In some implementations the printed and/or displayed information may take a form similar to the following:

AUTHORIZATION CODE: NNNNNNNNN
IF YOU WERE ENROLLED, YOU'D HAVE
SAVED ON THIS TRANSACTION: PP%
OR ECO AMOUNT: VVVVVVVVVV,VV
ECOS RECEIVED: VVVVVVVVVV,VV
AMOUNT PAYABLE: VVVVVVVVVV,VV

| | |
|---|---|
| CANCEL | ENTER |

In some implementations ECO ADVANTAGE may monitor 320 the temporary user ID to see if the user has created an account, and may choose to deactivate the user's account after a pre-specified period of inactivity. The user may submit an application request 313 to ECO ADVANTAGE, or may submit an application request 314 to the merchant, who may forward the application request 315 to ECO ADVANTAGE. In some implementations, an XML-encoded application request 313, 314, or 315 may take a form similar to the following:

```
POST /application_request.php HTTP/1.1
Host: www.ECOADVANTAGEprocess.com
Content-Type: Application/XML
Content-Length: 788
<?XML version = “1.0” encoding = “UTF-8”?>
<applicationRequest>
  <authorizationCode>109654324</authorizationCode>
  <userId>102557952</userId>
  <userIdType>SSN</userIdType >
  <userFirstName>Peter</userFirstName>
  <userLastName>Tavares</userLastName>
  <userLastName>Tavares</userLastName>
  <email>petertavares@somecompany.com</email>
  /*<streetAddress>Tavares Street, 44</streetAddress>
  <paymentMethod>debitcard, creditcard</paymentMethod>
  <userInterests>eletronics, restaurants</userInterests>
  <userDevices>iphone, tablet</userDevices>*/
</applicationRequest>
```

In some implementations, the user's application information in the application request may be used to instantiate 316 a user account on ECO ADVANTAGE. In some implementations Grails code for instantiating the user account may take a form similar to the following:

```
TemporaryUser tempUser = TemporaryUser.getByAuthorizationCode(authorizationCode);
  if (tempUser) {
    def user = new User( );
    user.document = tempUser.document;
    user.name = applicationRequest.userFirstName  +  “  ”  +
applicationRequest.userLastName;
    user.mail = applicationRequest.email;
    user.password = applicationRequest.password;
    user.address = applicationRequest.streetAddress;
    user.paymentMethod = applicationRequest.paymentMethod;
    user.interests = applicationRequest.userInterests;
    user.devices = applicationRequest.devices;
    user.enabled: true;
    user.accountLocked: false;
    user.confirmed: false;
    user.save( )
  user.creditEco(tempUser.receivedEcos)
} else {
    sendError(“authorizationcode.not.found”)
  }
```

ECO ADVANTAGE may also credit to the user's new account the number of ecos specified in the user's authorization code/temp ID. ECO ADVANTAGE may send a confirmation of enrollment to the user (e.g., via a message 319 directly to the user, or via a message to the merchant 317, which may be forwarded to the user 318). In some implementations, an XML-encoded status of enrollment message may take a form similar to the following:

```
POST /enrollment_message.php HTTP/1.1
Host: www.ECOADVANTAGEprocess.com
Content-Type: Application/XML
Content-Length: 788
<?XML version = “1.0” encoding = “UTF-8”?>
<userApplicationResponse>
  <authorizationCode>109654324</authorizationCode>
  <approved>true</approved>
  <ecoBalance>77</ecoBalance>
</userApplicationResponse>
```

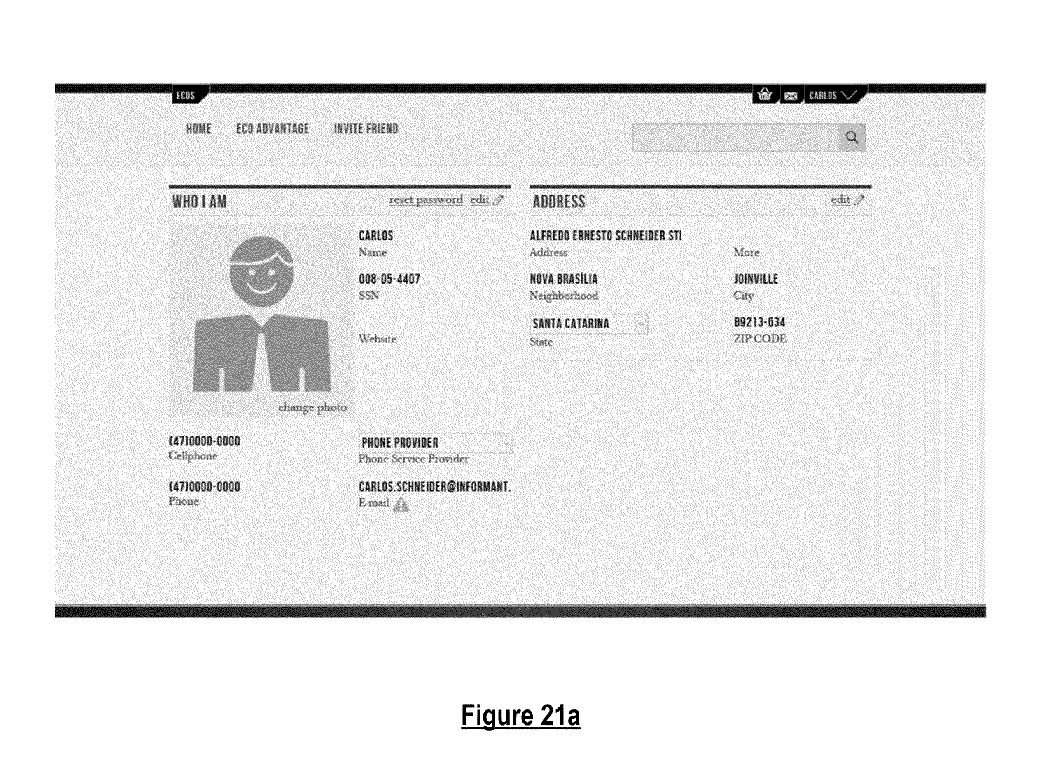

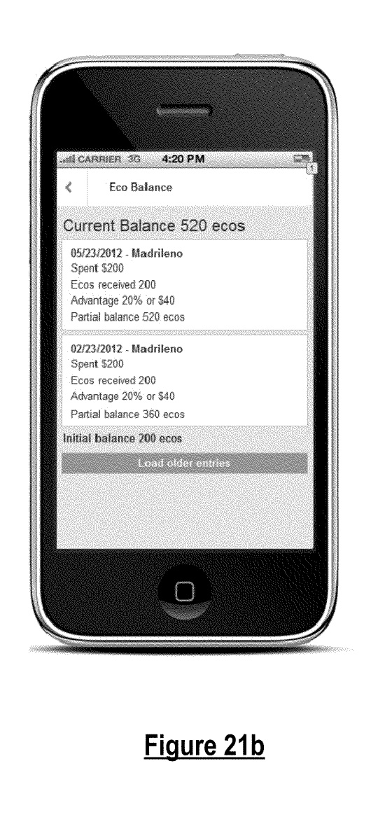

FIG. 3b shows a logic flow diagram illustrating performing an online transaction without an ECO ADVANTAGE account in example embodiments of the ECO ADVANTAGE. In some implementations, ECO ADVANTAGE may store 321 a transaction record and generate a transaction ID for the record. ECO ADVANTAGE may also generate a temporary user record 322, with a temporary user ID, authentication code, a reference to the stored transaction, and/or like information. In some implementations, ECO ADVANTAGE may calculate 323 the number of ecos associated with the temporary account, and may send the eco information to the merchant, who may receive and print and/or display 324 the user's authorization code and/or temp ID, the amount of ecos that could have been applied to the merchant's transaction, the amount of ecos to be received from the transaction, the total ecos accrued for the user should he enroll, and/or like information. The user, upon obtaining 325 the data provided by the merchant, may be given the opportunity to create an account with ECO ADVANTAGE so that he may use his ecos in the system. If the user wants the account 326, the user may provide application information 328, such as the user's name, address, email, password, and/or the like to the merchant. In some implementations, the merchant may process 329 the application via sending it in a message to ECO ADVANTAGE 330. In some implementations, the user may also send the application information directly 331 to ECO ADVANTAGE via an electronic device separate from the merchant and/or its PoS device. ECO ADVANTAGE may convert the user's temporary account 332 into a normal user account, and may update the new account with the application data and/or like information. ECO ADVANTAGE may also credit a predetermined number of ecos 333 to the user based on the transaction performed, and in some implementations these ecos may be marked as being from the merchant where the transaction originated. ECO ADVANTAGE may generate a status notification 324 in order to notify other entities in the process that the enrollment was successful, to provide the user's current eco balance, and/or the like. In some implementations ECO ADVANTAGE may send this status notification to the merchant 325, who may forward the notification to the user after logging the data. In other implementations, ECO ADVANTAGE may send the notification directly to the user, via mail, email, SMS, and/or the like. In some implementations, if the user chooses not to create an account, ECO ADVANTAGE may deactivate the temporary user record 327 in the ECO ADVANTAGE database. In some implementations, the user may be able to view his newly-created account via a profile user interface similar to that in FIG. 21a.

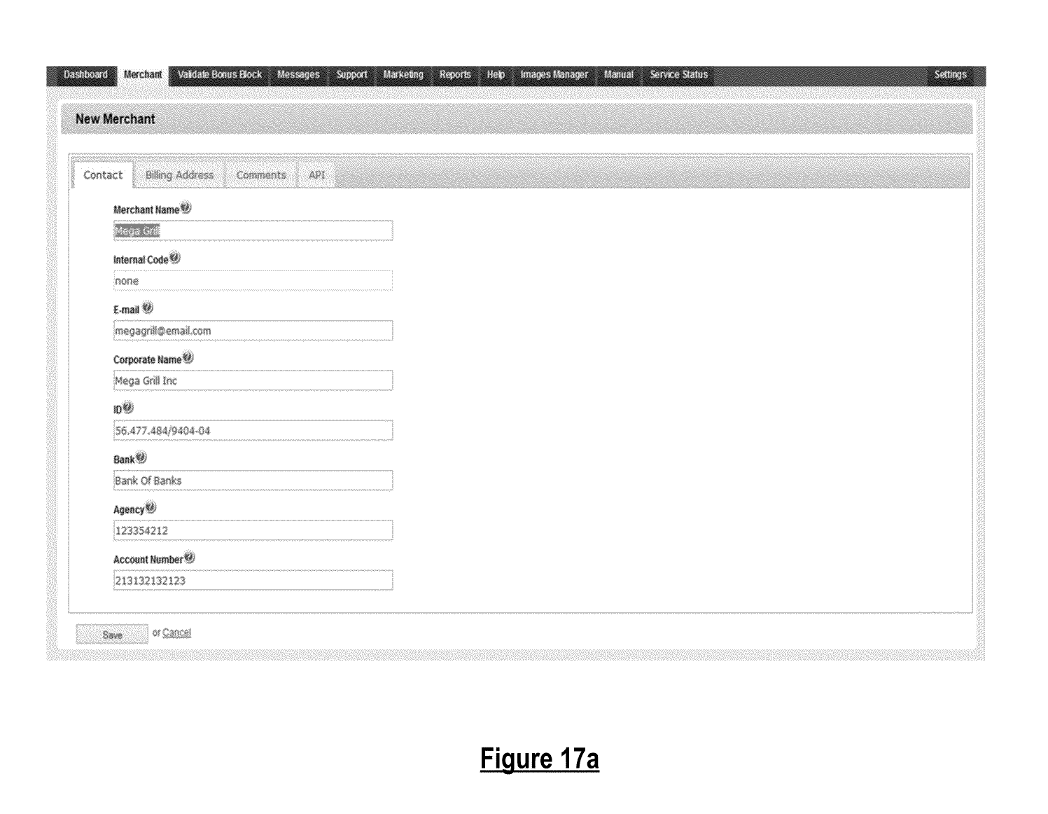

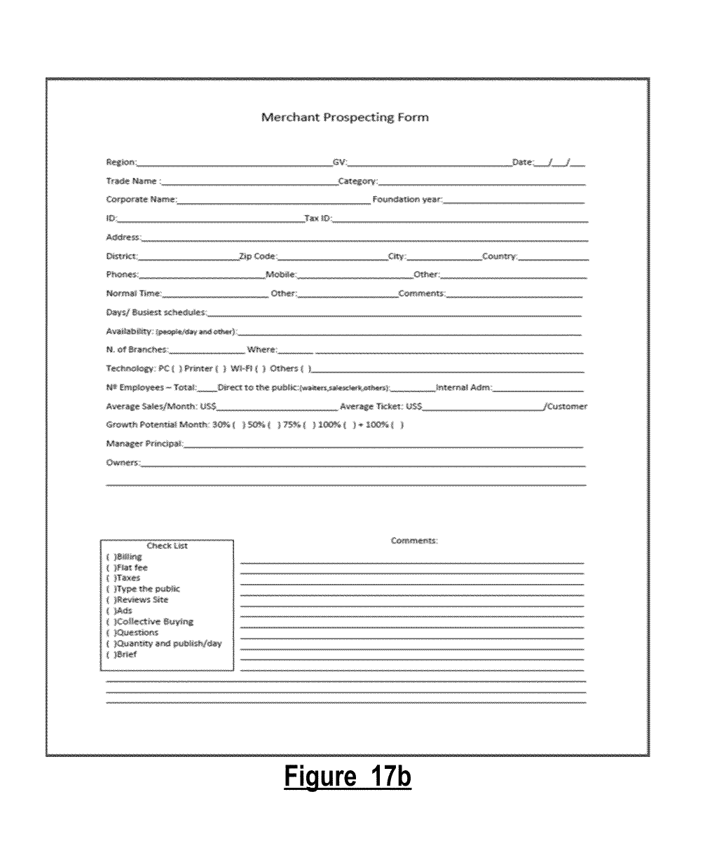

FIG. 4a shows a data flow diagram illustrating enrolling a merchant in example embodiments of the ECO ADVANTAGE. In some implementations, the merchant 401 may wish to enroll in ECO ADVANTAGE via sending an enrollment request 402 to ECO ADVANTAGE with an indication that the merchant would like to get information and/or an application for enrollment, and/or the like. ECO ADVANTAGE may send an enrollment request form 404, which may take a form similar to those in FIG. 17a or 17b, depending upon whether the enrollment form is electronic or physical. In some implementations, the merchant may fill out the enrollment request form and send it back to ECO ADVANTAGE via a request form message 405. In some implementations the request form message 405 may be an XML-encoded message similar to the following:

```
POST /request_form_message.php HTTP/1.1
Host: www.ECOADVANTAGEprocess.com
Content-Type: Application/XML
Content-Length: 788
<?XML version = “1.0” encoding = “UTF-8”?>
<merchantApplicationMessage>
  <Document>02545225441000188</Document>
  <MerchantName>Italian Restaurant</MerchantName>
  <StreetAddress>16 avenue, 20</StreetAddress>
  <BankInformation>
    <BankNumber>254</BankNumber>
    <Agency>3652-8</Agency>
    <Account>2525414-5</Account>
  </BankInformation>
  <Biography>
      The Italian restaurant opened 10 years ago
      and since then has been serving Italian food every day.
  </Biography>
  <Links>
    <Link>http://wwww.italian-restaurant.com</Link>
  </Links>
  <PosID>5467754</PosID>
  <ListOfPeriods>
    <Period type=“slow”>
      <DayRange>Mon, Tue, Wed</DayRange>
      <TimeRange>18PM-22PM</TimeRange>
    </Period>
  </ListOfPeriods>
  <Capacity>150</Capacity>
  <atmospherics>
      <dateTime>03/07/2013 03:39 PM</dateTime>
  </atmospherics>
</merchantApplicationMessage>
```

In some implementations, ECO ADVANTAGE may wish to perform a check (e.g. financial, quality, and/or the like) 406 on the merchant before enrolling the merchant in the program, and may send a check request 407 to a merchant agent 408 in order to run a check on the merchant. In some implementations, the merchant agent may be another electronic entity (e.g. web-crawler entity, robot, and/or the like) that may collect, aggregate, and analyze various types of information about various merchants both inside and outside of ECO ADVANTAGE. In some implementations, the check request message 407 may be an XML-encoded message may include check parameters for the merchant to use during aggregation (e.g. merchant to search for, sources to search, and/or the like).

In some implementations, the merchant agent may aggregate financial information, quality information, background information, and/or like information about the merchant 409, and may return this information to ECO ADVANTAGE via a merchant check response 410, which may include the merchant check data.

In some implementations, ECO ADVANTAGE, after receiving the merchant check, may generate a merchant account record 411 for the merchant if the merchant has met a pre-specified threshold of quality and is approved for ECO ADVANTAGE, and may enroll the merchant in the program. In some implementations, Grails code for creating the merchant account may take a form similar to the following:

```
MerchantRequest merchantRequest = MerchantRequest.getByDocument(XMLmerchant.document)
if (request) {
  if (request.qualityCheckPending == false
&& request.financialCheckPending == false
&& request.approved == true) {
Merchant merchant = new Merchant(merchantRequest.*)
merchant.enabled = true;
merchant.accountLocked = false;
merchant.confirmed = false;
merchant.login = XMLmerchant.email;
merchant.password = VoucherUtil.generatePassword( )
merchant.save( )
foreach(period in Merchant.ListOfPeriod) {
new MerchantPeriod(merchant, period).save( )
}
request.enrollmentPending = false;
request.save( )
}
} else {
  sendError(“merchantrequest.not.found”)
}
```

ECO ADVANTAGE may instantiate 412 the merchant account record, merchant eco schedule, and/or the like via storing the information in the schedules 413b and merchant 413d tables of the ECO ADVANTAGE database 413. In some implementations, ECO ADVANTAGE may also update the regions, categories, and/or the like in ECO ADVANTAGE via updating the categories 413a and regions 413c tables of the ECO ADVANTAGE database.

In some implementations, ECO ADVANTAGE may send a notification 414 to the merchant indicating that the merchant has successfully enrolled in the system. In some implementations, the notification of account creation 414 may be an XML-encoded message that may include the merchant's new ECO ADVANTAGE credentials and/or like enrollment information.

In some implementations, the merchant may need to update its PoS settings and/or configuration in order to properly communicate with ECO ADVANTAGE during transactions. In some implementations, the merchant may send a PoS (e.g. place of business or point-of-sales) configuration settings request 415 to ECO ADVANTAGE indicating a desire to update PoS settings, and including the merchant's current configuration, settings, and/or like information. In some implementations, the PoS configuration settings request 415 may be an XML-encoded message that may include information about the merchant's current PoS configuration, settings, infrastructure, and/or the like.

ECO ADVANTAGE may, after receiving the merchant's existing PoS information, generate a PoS configuration for the merchant 416 based on the infrastructure and/or the like that the merchant already has, and may generate training manual, tutorial, and/or like materials for the merchant so that its PoS settings may be updated accordingly. In some implementations, ECO ADVANTAGE may instantiate a PoS settings record 417 in the ECO ADVANTAGE database, and may send a PoS configuration settings response 418, detailing the new generated settings, configuration, and/or the like. In some implementations, the PoS configuration settings response 418 may include ECO ADVANTAGE's suggestions for the merchant's PoS configuration, settings, and/or the like, along with training materials and/or like resources. In some implementations PoS configuration settings response 418 may be sent to the merchant's acquirer 420; in other implementations it may be sent to the merchant directly. If it is sent to the merchant directly, the merchant may forward the PoS configurations settings via a message 419 to the merchant's acquirer. The acquirer may update, restart, and test 421 the merchant's PoS 422 based on the new configuration, settings, and/or the like. The merchant may send a confirmation 423 to ECO ADVANTAGE when the PoS has been successfully configured.

FIGS. 4b-c show logic flow diagrams illustrating enrolling a merchant in example embodiments of the ECO ADVANTAGE. In some implementations, the merchant may submit 424 a request to enroll in ECO ADVANTAGE to ECO ADVANTAGE, who may receive the request and generate 425 a template or customized enrollment form for the merchant. In some implementations, ECO ADVANTAGE may send 426 the enrollment form to the merchant, who may receive 427 the enrollment form and may submit 428 an application to enroll in ECO ADVANTAGE, which may include identification information, merchant sales information, product information, merchant payment information, atmospherics, industry information, and/or a variety of other types of merchant-related data. In some implementations, ECO ADVANTAGE may receive the application and generate a query 429 to merchant agents enrolled in ECO ADVANTAGE in order to obtain background materials on the merchant. In some implementations, once ECO ADVANTAGE has sent 430 the query to the merchant, the merchant may receive the merchant's information 431 and may begin to aggregate information 412 regarding the merchant, such as financial, quality, and/or like data. In some implementations, merchant information may be aggregated from accredited financial review organizations, peer review services, client review services, and/or the like. In some implementations, the merchant agent may generate 433 a background check based on the aggregated data, and may send 424 the background check based on the aggregated data. ECO ADVANTAGE May receive 435 the background check for the merchant, and may parse 436 the background check in order to find potentially alarming information regarding the merchant (e.g. if the merchant has a poor credit score, has a low client review score on a number of prominent social review websites, and/or the like). If the merchant meets a number of pre-specified criteria (e.g. credit thresholds, peer review thresholds, and/or the like) 437, ECO ADVANTAGE may generate a merchant account record 440 in the ECO ADVANTAGE database using the information obtained in the merchant's enrollment application, and may generate 441 an initial eco schedule for the merchant using the merchant's provided data (see FIGS. 5a-b for further details). In some implementations the eco schedule may be used to determine how many ecos a consumer may use in a transaction at the merchant at particular times of the day, particular days of the week, and/or the like.

As shown in FIG. 4c, ECO ADVANTAGE may also generate a confirmation notification 442 indicating that the merchant has been successfully enrolled, and may end 443 said confirmation to the merchant. Once the merchant received 444 the confirmation, the merchant may generate a survey 445 of the merchant's current PoS infrastructure, resources, configurations, settings, and/or the like, and may submit 445 the survey to ECO ADVANTAGE. In some implementations, ECO ADVANTAGE may receive 447 the survey and may determine new PoS (e.g. Place of Sales, place of business, or Point of Sales device) configurations, settings, infrastructure, and/or the like 448 based on the merchant's submitted infrastructure and the infrastructure and/or configuration needs of ECO ADVANTAGE. If ECO ADVANTAGE can successfully determine new settings for the merchant's PoS 449, ECO ADVANTAGE may also generate and/or retrieve 453 the proper training manuals, configuration tutorials, and/or the like, along with promotions for the new settings and/or infrastructure, and may generate a new PoS record in the ECO ADVANTAGE database containing the determined configuration, settings, and/or the like and a reference to the merchant account record. ECO ADVANTAGE may also send 455 the new configuration, settings, and/or the like, along with the training manuals, tutorials, promotions, and/or the like, to the merchant 456 for the merchant's records. The merchant may also forward 457 the settings to the merchant's acquirer, which may receive 458 the new PoS configuration and/or the like and may instantiate 459 a new PoS system using the suggested configuration, settings, infrastructure, and/or the like. The acquirer may restart the PoS, test the new suggested configuration 460, and may send a notification 461 to ECO ADVANTAGE when the PoS is successfully configured. ECO ADVANTAGE may receive 462 the notification and store it for future reference in the PoS and/or merchant record.

In some implementations, if the merchant does not meet the pre-specified enrollment criteria at 437, ECO ADVANTAGE may reject the merchant 438, and may send a notification to the merchant 429 indicating that the merchant was rejected by ECO ADVANTAGE, but is encouraged to try to enroll again at a later date. In some implementations the notification may also include reasons for rejection, including citing a poor credit score, poor peer reviews, and/or the like. If ECO ADVANTAGE cannot determine new PoS settings for the merchant, ECO ADVANTAGE may generate and send a failure message 450 to the merchant indicating that ECO ADVANTAGE could not generate a suitable configuration for the merchant given the information provided, and may also indicate what major changes the merchant could make to its existing infrastructure and/or the like before ECO ADVANTAGE can determine a suitable configuration. After the merchant receives the message 451, the merchant may obtain different PoS infrastructure and/or the like, and may re-submit a PoS survey to ECO ADVANTAGE indicating the changes in the PoS infrastructure, configuration, and/or the like.

FIG. 5a shows a data flow diagram illustrating creating and updating regions and categories in example embodiments of the ECO ADVANTAGE. In some implementations, a merchant agent 501 may determine a region 502 in ECO ADVANTAGE to analyze. In some implementations, the region may be based on geographic, cultural, industrial, and/or like constraints. The merchant may search for merchants in each region to obtain data from, and may obtain aggregate data 505 from brick and mortar merchants 503 as well as online merchants 504 already enrolled in ECO ADVANTAGE. In some implementations, the merchant agent may send the aggregate information obtained about each merchant to ECO ADVANTAGE via a region/merchant survey message 506. In some implementations, an XML-encoded region/merchant survey message 506 may be an XML-encoded message and may take a form similar to the following:

```
POST /region_merchant_survey_message.php HTTP/1.1
Host: www.ECOADVANTAGEprocess.com
Content-Type: Application/XML
Content-Length: 788
<?XML version = “1.0”encoding = “UTF-8”?>
  <regionMerchantSurvey>
    <surveyId>11254878</surveyId>
    <surveyDateTime>03/07/2013 03:39 PM</surveyDateTime>
    <merchantSurveyList>
        <merchantSurvey>
            <merchantSurveySeqNumber>1</merchantSurveySeqNumber >
            <merchantId>2033</merchantId>
            <MerchantDocument>021451125488</MerchantDocument>
            <MerchantAggregateSales></MerchantAggregateSales>
            <AverageConsumerSpent>84.5</AverageConsumerSpent>
            <ProductServicePurchase></ProductServicePurchase>
            <ListOfPeriods>
                <Period type=“idle”>
                  <DayRange>Mon, Tue, Wed, Thu, Fri</DayRange>
                  <TimeRange>03PM-06PM</TimeRange>
              </Period>
                <Period type=“slow”>
                  <DayRange>Mon, Tue, Wed</DayRange>
                  <TimeRange>06PM-10PM</TimeRange>
                </Period>
                <Period type=“peak”>
                  <DayRange>Thu, Fri</DayRange>
                  <TimeRange>11AM-03PM,06PM-10PM</TimeRange>
              </Period>
            </ListOfPeriods>
            <GPSCoordinates>1.65254125411,−5.698564545</GPSCoordinates>
            <productData>
                <sku>56673953</sku><description>hair cut</description>
            </productData>
            <RetailSearches></RetailSearches>
            <MarketDataAggregates></MarketDataAggregates>
            <CensusData></CensusData>
            <Photo></Photo>
            <Video></Video>
            <Description></Description>
            <MerchantSite>http://www.italian-restaurant.com</MerchantSite>
            <Email>admin@italian-restaurant.com</Email>
            <SocialNetworkinsPage>www.facebook.com/ItalianRestaurant</SocialN
            etworkinsPage>
            <MerchantContactInformation></MerchantContactInformation>
          </merchantSurvey>
          <merchantSurvey>
            <merchantSurveySeqNumber>2</merchantSurveySeqNumber >
            <merchantId></merchantId>
            <MerchantDocument>021451125475</MerchantDocument>
            ....
          </merchantSurvey>
          <merchantSurvey>
            <merchantSurveySeqNumber>${n}</merchantSurveySeqNumber >
            ....
          </merchantSurvey>
      </merchantSurveyList>
      <dateTime>03/07/2013 03:39 PM</dateTime>
</regionMerchantSurvey>
```

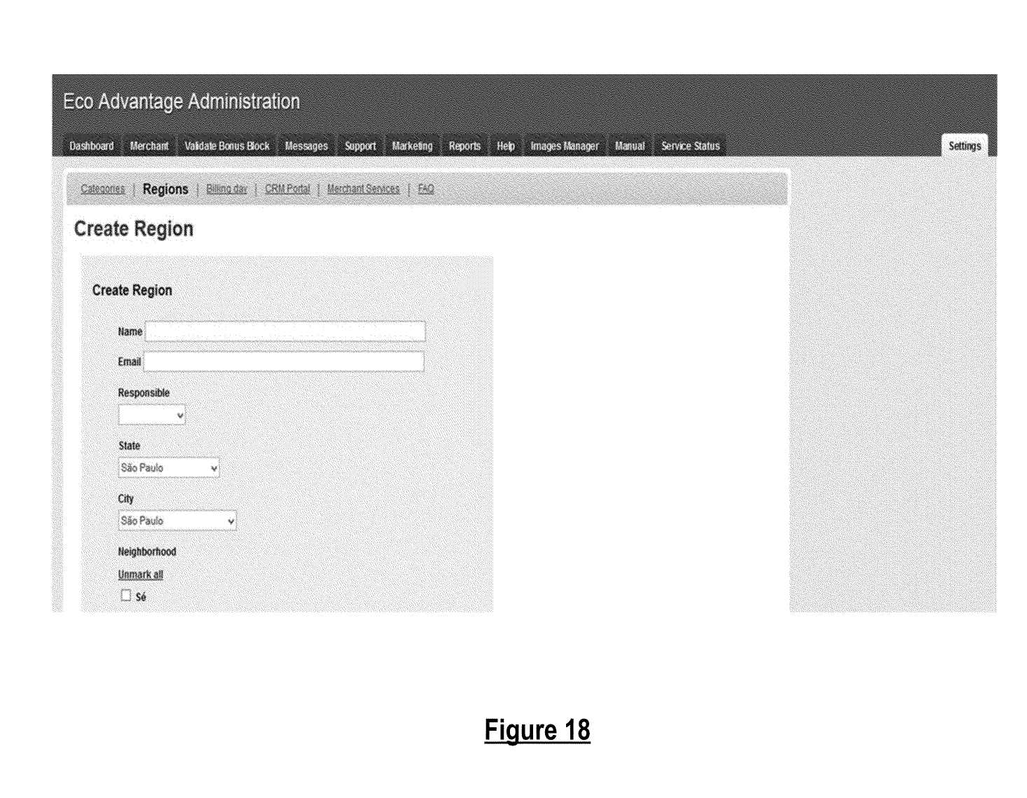

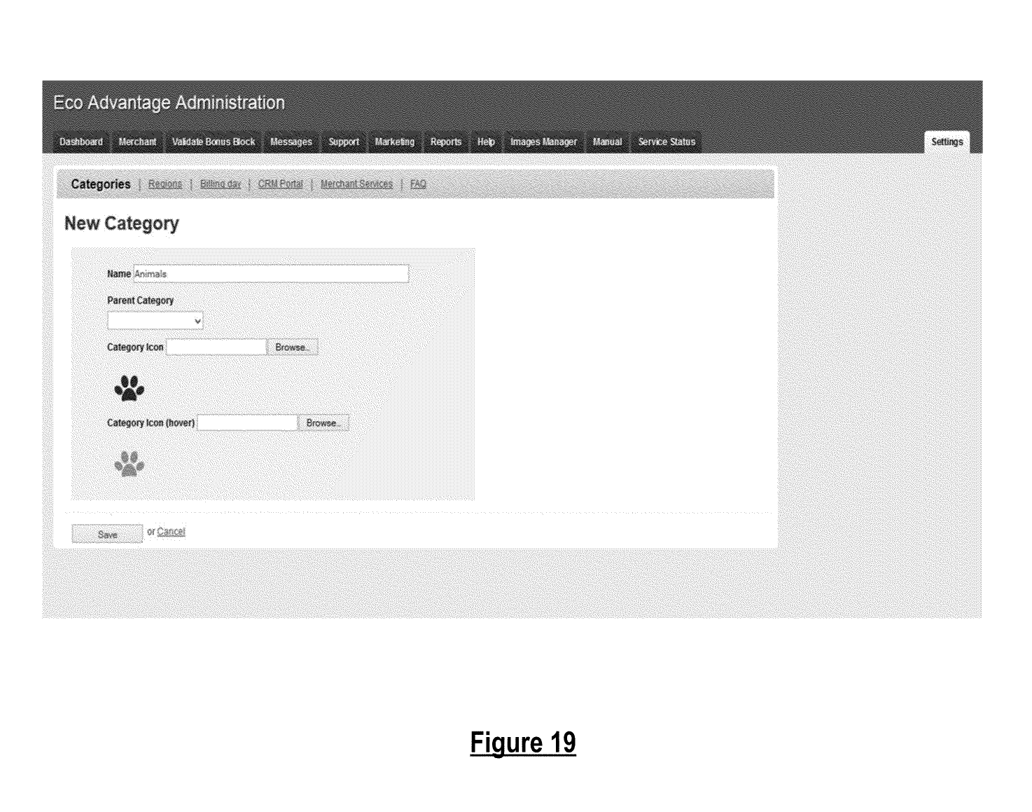

In some implementations, ECO ADVANTAGE may parse the data in the survey 508, and may perform analytics 509 on the data received (e.g. determine which merchants sell the most of a particular product at which times of the day, week, and/or the like, determine which merchants are best known by consumers, and/or the like). ECO ADVANTAGE may update the merchant profile 510, eco schedule, and/or the like for merchants being analyzed. ECO ADVANTAGE may create and/or update region and category information 511 in the ECO ADVANTAGE database based on the merchant information via sending an update query 512 to the ECO ADVANTAGE database 513. In some implementations, an ECO ADVANTAGE administrator may be able to create and/or update regions and categories via administrative user interfaces such as those in FIGS. 18 and 19.

FIGS. 5b-d show logic flow diagrams illustrating creating and updating regions and categories in example embodiments of the ECO ADVANTAGE. In some implementations, the merchant agent may define a region based on geographic, cultural, industrial, and/or like factors 514, and may search for merchants for merchants enrolled in ECO ADVANTAGE 515. For each merchant 516 being analyzed, the merchant agent may retrieve merchant data 517 such as the merchant's inventory, merchant transaction history, the merchant location, and/or like data from the merchant, and may aggregate data for another if there are more merchants 518. If all the merchants have been analyzed, the merchant agent generate a regional merchant survey based on the merchant data aggregated 519, and may send 520 the regional merchant survey to ECO ADVANTAGE. in some implementations, ECO ADVANTAGE may receive the survey, and may parse 522 the data in the survey so that ECO ADVANTAGE may perform analytics on the merchant data 523 (e.g. average sale peaks for each merchant, determine demographics of most common consumers for each merchant, and/or the like. ECO ADVANTAGE may generate individual and/or average eco schedules for each merchant 524 based on the data, wherein the individual schedules may be purely based on the merchant's sales and/or like data, and wherein the average schedules may be based on the aggregate sales and/or the like data of all merchants analyzed. After ECO ADVANTAGE has updated merchant records 525 with updated aggregated information, updated eco schedules, and/or the like, ECO ADVANTAGE may compare the merchant's capacity 526 (e.g. ability to take on new clientele, consumers, and/or the like) to a predetermined threshold of over-capacity. If the merchant is not over capacity 527, ECO ADVANTAGE may make no changes. If the merchant is over capacity, ECO ADVANTAGE may generate a request 528 for data on non-enrolled merchants in the same industry/category as the enrolled merchant, and which are within the merchant's region, and may send 529 the request to the merchant agent. In some implementations, after the merchant agent receives the request 530, the merchant agent may aggregate 531 a list of merchants meeting the specified criteria (e.g. category, region, and/or the like), and may, for each merchant 532, aggregate qualitative and quantitative merchant data 533 (see FIG. 4b for further details), and may add the data 534 to a collective list of merchant prospects for ECO ADVANTAGE. When all merchants have been processed 535, the merchant agent may generate and send the aggregated data 536 of all merchants found to ECO ADVANTAGE, which may, upon receiving 561 the aggregated data, rank 537 the merchants based on pre-specified criteria (e.g. the average and/or total number of customers for the merchant, the merchant's current capacity, the merchant's financial reputation, and/or the like). ECO ADVANTAGE may select 538 the best-ranked merchant on the list and may determine whether the merchant can meet predetermined ECO ADVANTAGE requirements 529. if the merchant would not meet the requirements, ECO ADVANTAGE may select the next best merchant on the list 540, and may perform the same check on the next best merchant. If a merchant meets ECO ADVANTAGE requirements, ECO ADVANTAGE may generate 541 and send 542 an enrollment invitation to the merchant (see FIGS. 4b-c for more detail). In some implementations, after the merchant has enrolled, ECO ADVANTAGE may update 542 the region and category that the new merchant belongs to, in order to show that a merchant has been added to both.

In some implementations, after performing analytics on enrolled merchants, ECO ADVANTAGE may also wish to compare the population 544 of a particular region to a predetermined population threshold. If the region is deemed to be overpopulated 545, ECO ADVANTAGE may with to divide the region such that each sub-region is not overpopulated. In some implementations this may be done via determining a geographical, demographic, and/or like demarcation category 546 to divide the region by. In some implementations, the demarcation category may include area codes, zip codes, voting districts, wealth pockets, and/or the like. In some implementations, if there is more than one variant of the demarcation category in the region 547 (e.g., if there is more than one area code and/or the like in the region), ECO ADVANTAGE may split the existing region 550 by the one or more variant in the region 29 (e.g. may split the region into two or more sub-regions based on the two or more area codes in the region, and/or the like). If there is only one variant of the demarcation category (e.g. only one area code in the region), ECO ADVANTAGE may determine the latitude and longitude of the center of the region 548 using a region map and/or region location data points, and may split the region 549 into quadrants centered on the determined center of the region. In some implementations, ECO ADVANTAGE may designate each new sub-region 551 and may update records related to each new region 552 (e.g. category records, merchant records, and/or the like) as being connected with the new region. For each new sub-region 553, ECO ADVANTAGE may also check to determine if the sub-region is also over-populated 554 based on ECO ADVANTAGE's predetermined threshold, and may similarly split the sub-region if it is over-populated. If not, and if there are no other sub-regions to verify 555, ECO ADVANTAGE may, for each new region 556, gather new region information 557 (.g. demographics, industries, and/or the like), may update 558 the region's categories, records, and/or the like based on the gathered information, and may gather updated information 559 of merchants currently enrolled and in the region (see FIGS. 5a-c for more details). ECO ADVANTAGE may continue to do this for each new region until it there are not any new regions left to check 560.

FIGS. 6a-b show data flow diagrams illustrating friend invitations and donations in example embodiments of the ECO ADVANTAGE. In some implementations, a user 601 may indicate at a merchant PoS device, merchant kiosk, via an electronic device 602, and/or using like technology that he would like to donate ecos. In some implementations the user may be encouraged to donate ecos that are close to expiring after a time period defined by ECO ADVANTAGE, and may be able to donate either to charities, organizations, and/or the like, or to friends in the form of a referral program. In some implementations the user may send a balance request 603 to ECO ADVANTAGE 604, which may ask for the user's current balance, including ecos that will expire soon. In some implementations the balance request 603 may be an XML-encoded message and may take a form similar to the following:

```
POST /balance_request.php HTTP/1.1
Host: www.ECOADVANTAGEprocess.com
Content-Type: Application/XML
Content-Length: 788
<?XML version = “1.0” encoding = “UTF-8”?>
<balanceRequest>
  <userId>102557952</userld>
  <userIdType>SSN</userIdType >
  <ecoId>3074</ecoId>
  <Document>06998524500</Document>
  <dateTime>03/07/2013 03:39 PM</dateTime>
</balanceRequest>
```

In some implementations, ECO ADVANTAGE may send a balance response 605 which may contain the user's eco balance, expiration date data for all of the ecos, and/or the like. In some implementations the balance response 605 may be an XML-encoded response and may take a form similar to the following:

```
POST /balance_response.php HTTP/1.1
Host: www.ECOADVANTAGEprocess.com
Content-Type: Application/XML
Content-Length: 788
<?XML version = “1.0” encoding = “UTF-8”?>
<balanceResponse>
  <userId>102557952</userId>
  <userIdType>SSN</userldType >
  <ecoId>3074</ecoId>
  <Document>06998524500</Document>
  <ListOfBalance>
    <Balance>
      <Value>77</Value>
      <ExpirationDate>05/15/2013</ExpirationDate>
    </Balance>
    <Balance>
      <Value>200</Value>
      <ExpirationDate>06/15/2013</ExpirationDate>
    </Balance>
  </ListOfBalance>
</balanceResponse>
```

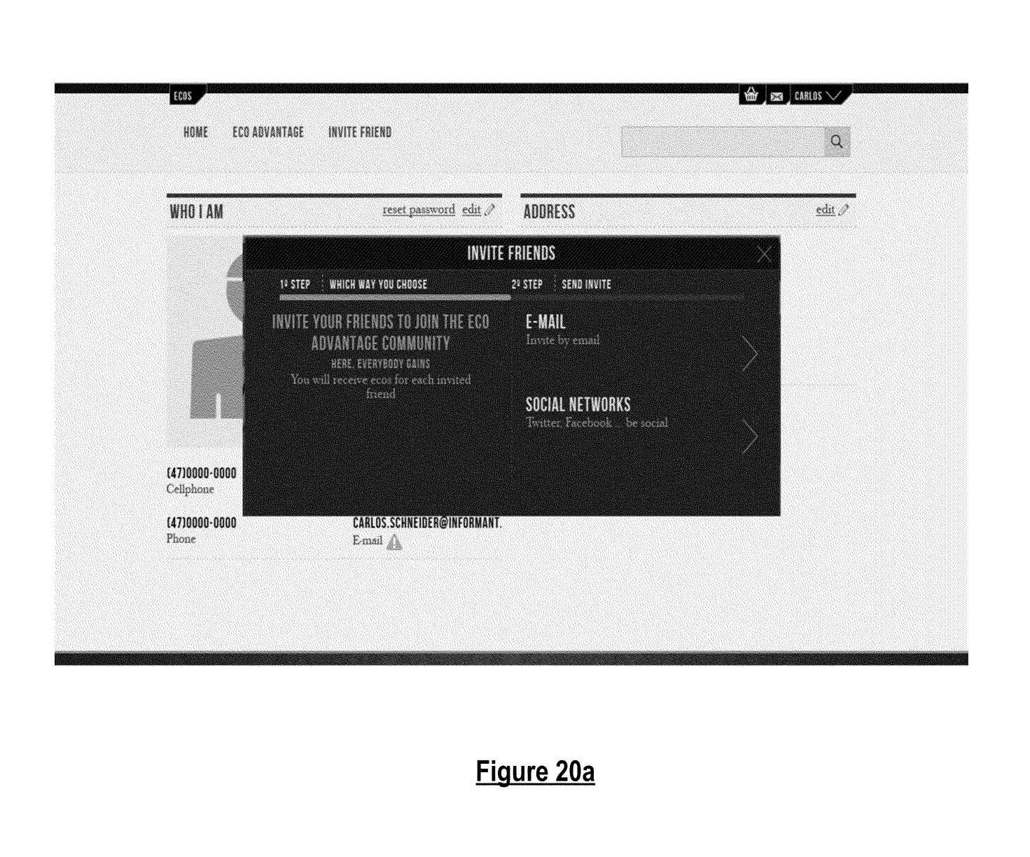

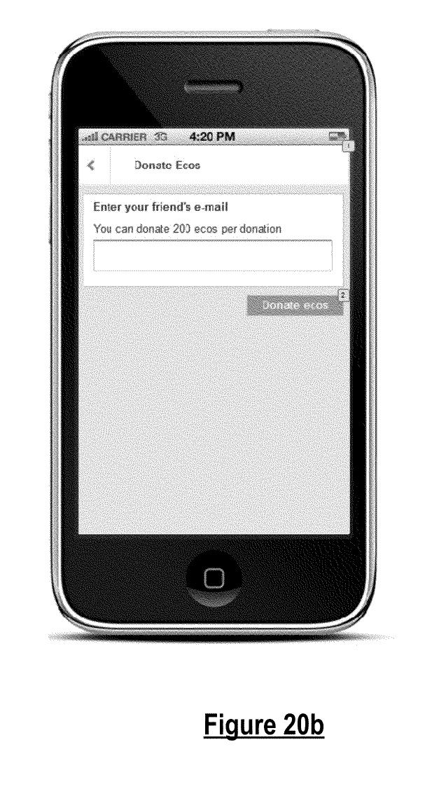

In some implementations, the user may be able to view his ecos balance via an ecos balance user interface similar to that in FIG. 21b, and may, using an interface similar to that in FIGS. 20a-b, choose a number of ecos to donate to a friend, and may send a gift request 606 to ECO ADVANTAGE. In some implementations the gift request 606 may be an XML-encoded message which may take a form similar to the following:

```
POST /gift_request.php HTTP/1.1
Host: www.ECOADVANTAGEprocess.com
Content-Type: Application/XML
Content-Length: 788
<?XML version = “1.0” encoding = “UTF-8”?>
<giftRequest>
  <UID>32134321354321345312</UID>
  <EcoBlockAmount>400</EcoBlockAmount>
  <FriendID>02541478744</FriendID>
  <Email>peter@friend.com</Email>
  <PhoneNumber>1465448874</PhoneNumber>
</giftRequest>
```

In some implementations, ECO ADVANTAGE may be able to determine whether the friend is already enrolled or not 607, and may allocate 608 the user-specified number of ecos in the user's balance as ecos to be donated to the friend. In some implementations, Grails code for checking for friend enrollment and allocating ecos may take a form similar to the following:

```
def userGift
  User user = User.getByDocument(friendID)
if (user) {
  userGift = user
} else {
  userGift = TemporaryUser.create(friendID)
}
User user = User.getByDocument(userId)
def userBalance = user.getBalance( )
if (userBalance > ecoBlockAmount) {
  sendError(“insufficient.funds.for.gifting”)
} else {
  user.blockForDonation(ecoBlockAmount,UID)
}
```

In some implementations, ECO ADVANTAGE may send an allocation confirmation request 609 to the user. In some implementations the user may confirm 610 the gift allocation, which may trigger a confirmation response 611 to be sent to ECO ADVANTAGE, indicating that the user has confirmed the gift allocation to the specified recipient. In some implementations, an XML-encoded confirmation response 611 may take a form similar to the following:

```
POST /confirmation_response.php HTTP/1.1
Host: www.ECOADVANTAGEprocess.com
Content-Type: Application/XML
Content-Length: 788
<?XML version = “1.0” encoding = “UTF-8”?>
<giftConfirmation>
  <UID>32134321354321345312</UID>
  <EcoBlockAmount>500</EcoBlockAmount>
  <FriendID>02541478744</FriendID>
  <Confirm>true</Confirm>
</giftConfirmation>
```

ECO ADVANTAGE may send a gift notification 612 to friend 613 containing information regarding the eco gift. In some implementations gift notification 612 may be sent via physical mail, email, and/or the like, and may take a form similar to the following:

From: john@friend.com
To: peter@friend.com
Subject: You won a gift from John
Are you getting 400 ecos to spend using Eco Advantage
Sign up to take advantage
GiftID: 32134321354321345312
UserID: 02541478744

The friend may send an enrollment request 614 to ECO ADVANTAGE with information necessary to create an account for the friend. In some implementations, an XML-encoded friend enrollment request may take a form similar to application request 313, 314, or 315. In some implementations, sensitive information (e.g. the user PIN and/or the like) may be encrypted.

In some implementations, ECO ADVANTAGE may instantiate 615 a user account for the friend using the enrollment data provided, via sending a user account insert query 616 to the users 617d table of the ECO ADVANTAGE database 617. In some implementations, ECO ADVANTAGE may transfer 618 the block of ecos from the user to the friend (e.g. by moving the ecos to the friend's new account, designating them as 8 “donation ecos,” resetting the expiration date for the ecos donated, and/or like record-updating). In some implementations, example Grails code for transferring the ecos may take a form similar to the following:

DonationBlock donation = DonationBlock.getbyUID(UID)
User userFrom = donation.userFrom
User userTo = donation.userTo
userFrom.donate(UID, userTo)

In some implementations, ecos designated as being donated may not be donated again by any user, and may only be able to be spent. In some implementations, ECO ADVANTAGE may update records via ecos update 619.

In some implementations, ECO ADVANTAGE may send a confirmation to the user 621 indicating that the user's ecos have successfully been transferred to the friend, along with a confirmation to friend 620 indicating that the donated ecos have been successfully transferred to the friend's new account.

Referring to FIG. 6b, in some implementations, friend 613 may use the donated ecos 622 in a plurality of transactions (see FIGS. 2a-d for more details). ECO ADVANTAGE may monitor 623 the spending of the user's donated ecos, and may, when the friend has spend some predetermined amount of the donated ecos 624, allocate an invite bonus block to the user's account, via sending an invite bonus block update 625 to the ECO ADVANTAGE database. In some implementations, Grails code for monitoring the spending of donated ecos may take a form similar to the following:

```
def listOfDonation = Donation.findbyBonusBlockId(null)
  foreach (donation in listOfDonation) {
    def userFrom = donation.userFrom
    def userTo = donation.userTo
    def amount = donaction.amount
    def date = donation.date
    def  usedAmountSinceDonation  =
transaction.getByUserAndSinceDate(userTo, date)
    call eligibleForBonusBlock(donation, usedAmountSinceDonation)
  }
```

In some implementations, Grails code for allocating invite bonus blocks may take a form similar to the following:

function eligibleForBonusBlock( donation, usedAmountSinceDonation) {

if ( usedAmountSinceDonation >= (donation.amount *

ecoAdvantageConfig.donationFactor)) {

def bonusBlockId = donation.userFrom.creditBonusBlock( )
donation.bonusBlockId = bonusBlockId;
donation.save( )

}

}

In some implementations, the bonus block update query 625 may be a PHP-encoded insert statement.

In some implementations, the user may receive confirmation 626 that the invite bonus block has been credited to the user's account, which may include the value of the invite bonus block, the date it was credited, and/or the like. The user may participate in a qualifying transaction 627, such as a purchase transaction at an enrolled merchant 628 (see FIGS. 2a-d). In some implementations, a qualifying transaction may include a transaction where the combination of using ecos and bonus blocks will result in a transaction balance (e.g. using ecos and/or bonus blocks does not result in a free purchase and/or the like), a transaction that reaches a bonus block threshold (e.g. a minimum value at which a user can use bonus blocks towards a transaction), a transaction initiated at a particular merchant, in a particular region, in a particular category, for a particular product, at a particular time of day, on a particular day of the week, after a predetermined amount of ecos have been used by the user, after the user has donated a predetermined amount of ecos, and/or the like.

In some implementations, if the friend has not spent a predetermined amount of the donated ecos after a predetermined time period, ECO ADVANTAGE may send a message to the friend and/or user indicating that the donated ecos have not been spent, and may include current eco percentages for various merchants and/or the like in order to incentivize the spending of the donated ecos. The message may be sent via physical mail, email, text, private messages through ECO ADVANTAGE, and/or the like.

In some implementations, the merchant may send an eco request 629 (which may resemble eco message 206), and receive eco response 630 (which may resemble eco message 212), and which may contain information regarding the user's newly-obtained invite bonus block. In some implementations, the merchant may allow the user to apply 632, in addition to available ecos, the newly obtained invite bonus blocks to the remaining purchase balance. In some implementations the merchant may print and/or display the ecos and/or invite bonus block balances for the user, and may prompt the user to confirm and/or authenticate the transaction. The merchant may process the transaction similarly to that in FIGS. 2a-d.

FIGS. 6c-d show logic flow diagrams illustrating friend invitations and donations in example embodiments of the ECO ADVANTAGE. In some implementations, the user may obtain 633 his ecos balance, along with an indication of which ecos will expire soon and which can be donated to other parties. The user may choose a block of expiring ecos 634 to donate, and may use his electronic device (and/or a device provided by the merchant, e.g. a merchant's PoS device) to generate and send 635 a gift request to ECO ADVANTAGE indicating the friend to donate to and the amount of ecos to donate. In some implementations ECO ADVANTAGE may receive the gift request, and may determine whether the friend is enrolled in ECO ADVANTAGE 637. ECO ADVANTAGE may generate and send a transfer confirmation 638 to the user, which may include friend identification information (and may contain friend account information, if the friend is enrolled in ECO ADVANTAGE). The user may receive 639 the gift transfer confirmation, and may decide whether to confirm the transaction or not 640. If the user would like to confirm the transfer, ECO ADVANTAGE may, if the friend is enrolled 641, transfer the specified block of ecos to the friend 642, may update the user's and friend's balances, may mark the transferred ecos as “donated ecos” 643 and reset the expiration dates of the donated ecos, and/or take care of other transfer details. ECO ADVANTAGE may notify the user and the friend 644 that the ecos were successfully transferred from the user to the friend.

If the friend is not enrolled, ECO ADVANTAGE may instead allocate a block of the user's ecos 645 to be donated to the friend, and may prepare and send a template or customized enrollment form 646 to the friend. The friend may receive the enrollment form 647, along with the amount of ecos being donated to them, from whom, and/or the like. If the friend declines to enroll 648, ECO ADVANTAGE may deactivate the enrollment invitation 649, and may send a notification to the user that his enrollment invite has been deactivated 650 because the friend did not wish to enroll in ECO ADVANTAGE. If the friend chooses to enroll 648, the friend may do so by completing and submitting the enrollment form 651 to ECO ADVANTAGE, which may create a user account 652 for the friend based on the provided enrollment data in the friend's submitted enrollment form. ECO ADVANTAGE may transfer 653 the allocated block of ecos to be donated from the user account to the friend's new account, and may update the user's and friend's eco balances. ECO ADVANTAGE may mark the transferred ecos as “donation ecos” 654, along with resetting their expiration date and/or the like. The user may be notified of a successful eco donation 655.

In some implementations, the friend may use the donated ecos in one or more subsequent transactions 656 (see FIGS. 2a-d for more details), which may be monitored 657 by ECO ADVANTAGE. If ECO ADVANTAGE finds that the friend has spent some pre-defined number and/or percentage of the donated ecos 658, it may allocate 659 a predetermined invite bonus block value to the user, and may update the user's account 660 with the allocated invite bonus block. ECO ADVANTAGE may generate may generate 661 and send 662 a confirmation message to the user indicating that a predetermined number ecos donated by the user have been spent, that the user is consequently receiving an invite bonus block, the user's current ecos and invite bonus block balances, and/or the like. the user may receive 663 the confirmation and may subsequently make a purchase and/or initiate a transaction 664 at a merchant enrolled in ECO ADVANTAGE. The merchant may request from ECO ADVANTAGE 665 the user's transaction information, including the user's eco and invite bonus block balances, and/or the like, and may receive and print and/or display 666 said user transaction information for the user so that the user may confirm the transaction. If the user confirms the use of his ecos and the new invite bonus block 667, the merchant may complete 668 the transaction via applying the ecos and invite bonus block to the transaction balance, and may update the user's ecos and invite bonus block balances in the ECO ADVANTAGE database.

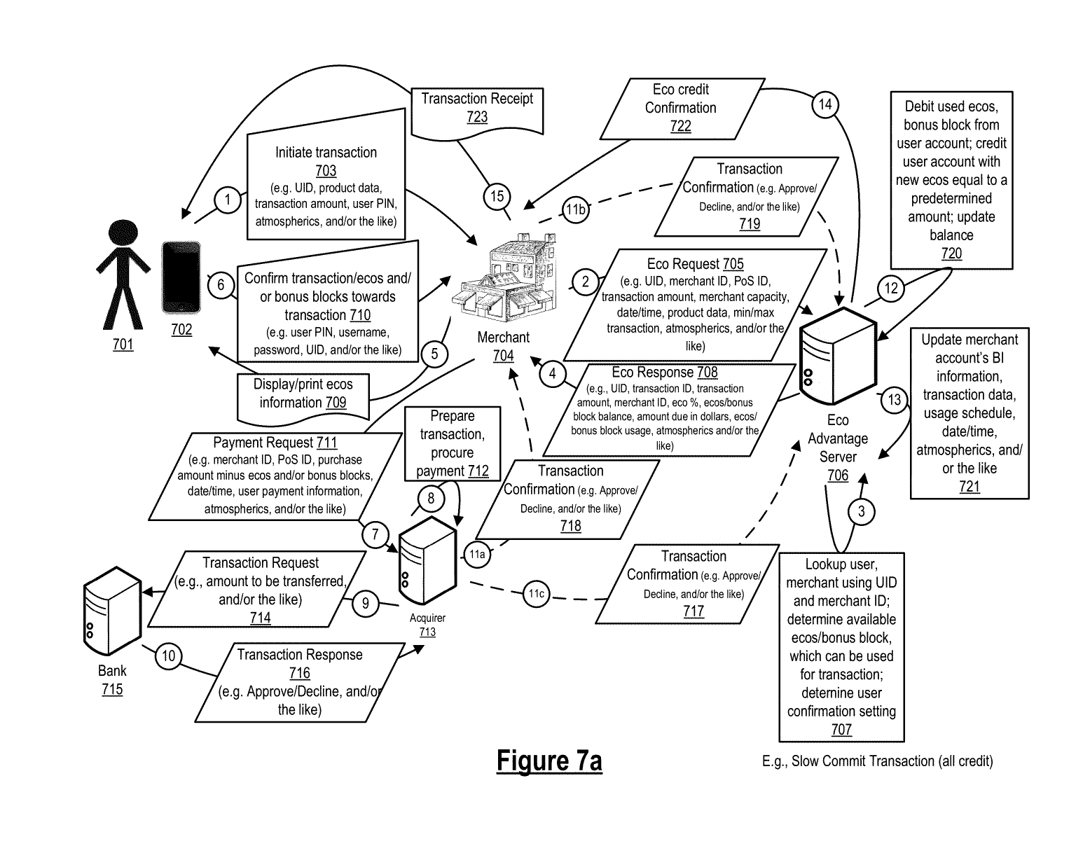

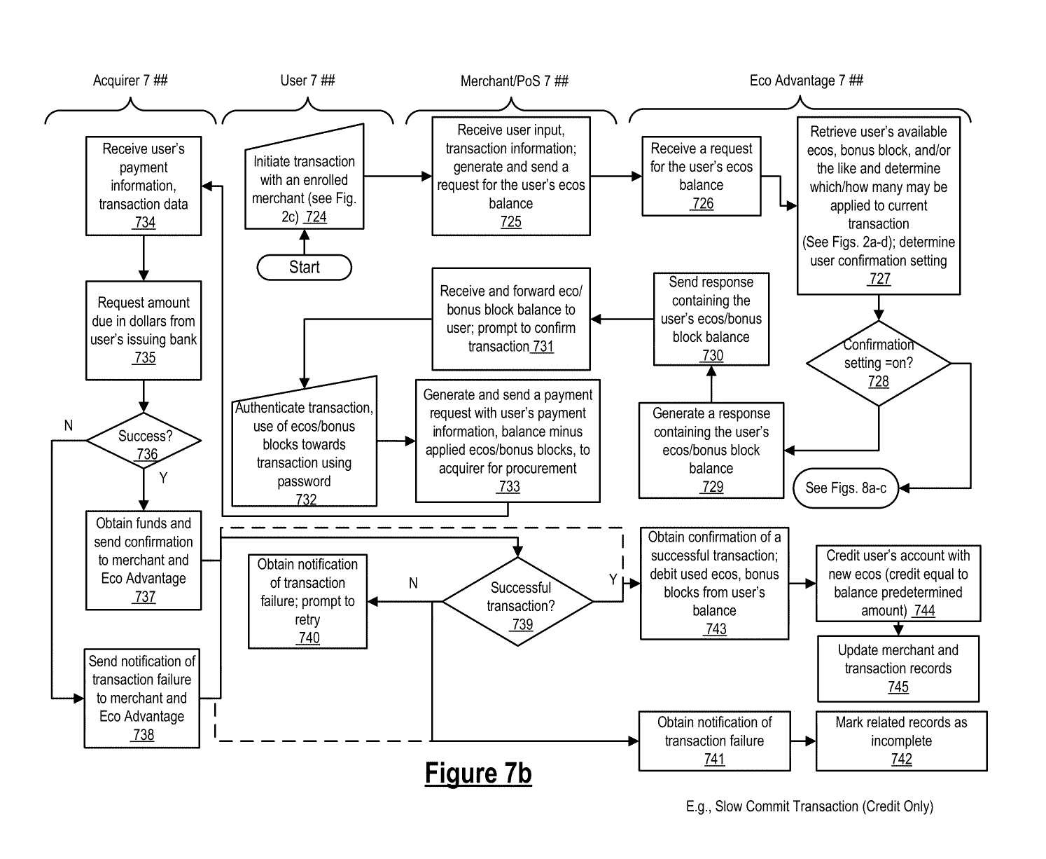

FIG. 7a shows a data flow diagram illustrating slow commit, credit-only transactions in example embodiments of the ECO ADVANTAGE. In some implementations, a user 701 may send a transaction initiation request 703 (which may take a form similar to transaction initiation 205) to the merchant 704 using the merchant's PoS device and/or a user electronic device 702. In some implementations, sensitive information (e.g. the user PIN and/or the like) may be encrypted. In some implementations, the merchant may send an eco request 705 to the ECO ADVANTAGE 706. In some implementations, eco request 705 may take a form similar to eco request 206. ECO ADVANTAGE may look up the user's and merchant's records using the user ID (UID) and the merchant ID 707, respectively, and may determine which and how many ecos and bonus blocks the user may apply to his transaction (e.g. based on the merchant's eco schedule, the user's eco and bonus block balances, and/or the like), and may determine the state of a user confirmation setting. If the confirmation setting is set to “true,” ECO ADVANTAGE may require the user to confirm his transaction before initiating any portion of it. In some implementations the confirmation setting may be set by the user, by a merchant (e.g., to require verification at the merchant), and/or the like. in some implementations, for example, some merchants may require verification before a transaction based on information contained in the ecos response (e.g. just received ecos from a distant location and/or like fraud triggers). In some implementations ECO ADVANTAGE may send an eco response 708 back to the merchant, which may take a form similar to eco response 212. In some implementations, the merchant may display and/or print 709 the ecos information for the user, who may review the information 710 and confirm the transaction, including the ecos and/or bonus blocks to be used in the transaction. In some implementations confirming the transaction may include authenticating the transaction, e.g., via providing a password, user PIN, positive identification (e.g. birthday, last four digits of cellphone number or SSN, street address, and/or the like). In some implementations the user may choose to pay for the transaction using a credit card, debit card, prepaid card, travel card, voucher cards, and/or the like. The merchant may send a payment request 711 to the merchant's acquirer 713, which may ask the entity to process the transaction. In some implementations, payment request 711 may take a form similar to the following:

POST /payment_request.php HTTP/1.1
Host: www.ECOADVANTAGEprocess.com
Content-Type: Application/XML
Content-Length: 788
<?XML version = “1.0” encoding = “UTF-8”?>
<paymentRequest>

<posId>4088</posId>
<merchantId>2033</merchantId>
<amountDueInDollars>77.0</amountDueInDollars>
<dateTime>03/07/2013 03:39 PM</dateTime>
<userCard>3214 3578 3568 3542</userCard>

</paymentRequest>

In some implementations payment request 711 may only include the transaction balance after ecos and/or bonus blocks have been applied. The acquirer may prepare 712 the transaction and procure payment via sending a transaction request 714 to a bank entity 715 (e.g. the user's issuing bank, another acquirer, and/or the like).

The bank may send a transaction response 716 to the acquirer, which may indicate whether or not the transaction was approved and/or processed, or whether the transaction was declined. The acquirer may forward this information to ECO ADVANTAGE via transaction confirmation 717, which may take a form similar to transaction confirmation 219, or may forward the information to the merchant via transaction confirmation 718 (which may take a form similar to transaction confirmation 219), who may forward the information via transaction confirmation 719 to ECO ADVANTAGE. In some implementations, the entity the acquirer forwards the confirmation to may depend on the security of the entities, entity resources, and/or the like. In some implementations ECO ADVANTAGE may not receive the confirmation (e.g., via the acquirer or the merchant). In some implementations, transaction confirmation 719 may take a form similar to transaction confirmation 219. Once ECO ADVANTAGE has received a transaction confirmation, it may debit 720 the used ecos and bonus blocks from the user's balances, may credit to the user with new ecos equal to a predetermined amount related to the transaction amount, and may update the user's balances. In some implementations, Grails code for updating the user's balances may take a form similar to the following:

Transaction transaction = Transaction.get(transactionId)
User user = transaction.getUser( )
Merchant merchant = transaction.getMerchant( )
long ecoUsage = transaction.getEcoUsage( )
long bonusBlockUsage = transaction.getBonusBlockUsage( )
Try {

beginTransaction( )
user.debitEco(ecoUsage)
user.debitBonusBlock(bonusBlockUsage)
commitTransaction( );

} catch (Exception) {

rollbackTransaction( );
return false;

}

ECO ADVANTAGE may also update the merchant account record 721, including updating BI information, transaction data, the merchant's usage schedule, atmospherics, and/or the like. In some implementations, Grails code for updating the user's balances may take a form similar to the following:

Transaction transaction = Transaction.get(transactionId)
User user = transaction.getUser( )
Merchant merchant = transaction.getMerchant( )
long amountDueInDollars = transaction.getAmountDueInDollars( )
Try {

beginTransaction( )
user.creditEco(amountDueInDollars, merchant)
commitTransaction( );

} catch (Exception) {

rollbackTransaction( );
return false;

}

ECO ADVANTAGE may send an eco credit confirmation 722 to the merchant in order to indicate that the transaction was successful and that the user's balances have been updated. In some implementations, eco credit confirmation 722 may take a form similar to the following:

POST /eco_credit_confirmation.php HTTP/1.1
Host: www.ECOADVANTAGEprocess.com
Content-Type: Application/XML
Content-Length: 788
<?XML version = “1.0” encoding = “UTF-8”?>
<ecoCreditConfirmation>

<UID>da6c5cdf4e90b2961873f7b2e863415</UID>
<newEcos>77</newEcos>
<bonusBlock>0</BonusBlock>
<usedEcos>23</usedEcos>
<EcoBalance>1091</EcoBalance>

<ecoCreditConfirmation>

In some implementations, the merchant may use the eco credit confirmation to generate and send a transaction receipt 723 to the user, which may contain information similar to the following:

DOCUMENT: NNN.NNN.NNN-NN ID EAS: IIIIII

| | |
|---|---|
| USED ECOS: | VVV.VVV,VV |
| USED BONUS BLOCKS: | VVV.VVV,VV |
| NEW ECOS: | EEE.EEE,EE |

NNNNNNNNNNNNNNNNNNNNNNNNNNNNNNNNNNNNNNNN

| | |
|---|---|
| ECO BALANCE: | BBB.BBB,BB |

FFFFFFFFFFFFFFFFFFFFFFFFFFFFFFFFFFFFFFFF

In some implementations, ECO ADVANTAGE may also monitor the status of various transactions, and may reverse, retry, and/or otherwise handle incomplete transactions if found in the ECO ADVANTAGE database's records, based on predetermined criteria.

FIG. 7b shows a logic flow diagram illustrating slow commit, credit-only transactions in example embodiments of the ECO ADVANTAGE. In some implementations, a user may initiate 724 a transaction with an enrolled merchant, via providing transaction input to a merchant. The merchant may receive the user input and transaction information 725, and may generate and send a request to ECO ADVANTAGE for the user's eco and/or bonus block balances. In some implementations, ECO ADVANTAGE may receive 726 the request for the user's eco and bonus block balance, and may retrieve from the ECO ADVANTAGE database 727 the user's available ecos, bonus blocks, and/or the like to determine which and how many ecos and bonus blocks may be applied to the current transaction, as well as to determine the user's confirmation setting. If the confirmation setting is on 728, ECO ADVANTAGE may generate 729 and send 730 a response to the merchant indicating the user's eco and/or bonus block balances and/or like transaction information. The merchant may receive the balance information 731 and forward the information to the user via displaying and/or printing the transaction information for the user and asking the user to confirm the transaction. The user may authenticate 732 the transaction and the use of his ecos and/or bonus blocks towards the purchase using his password, user PIN, and/or a like form of identification. In some implementations, the merchant may generate and send a payment request 733 with the user's payment information, the transaction balance after subtracting the applied ecos and/or bonus blocks to the original transaction amount, and/or like information to an acquirer for procurement. In some implementations the acquirer may receive 734 the user's payment information, transaction data, and/or the like, and may request the transaction balance 735 from the user's issuing bank.

If the acquirer can successfully procures the funds 736, the acquirer may obtain the funds 737 and may send a confirmation to the merchant (and in some implementations, to ECO ADVANTAGE) indicating that the transaction was successfully processed. In some implementations the merchant may, if the transaction was successful 739, forward the success notification to ECO ADVANTAGE, which may obtain the confirmation of a successful transaction 743 and may use the confirmation to debit the ecos and/or bonus blocks used in the transaction, credit to the user's account 744 a predetermined amount related to the transaction amount, and may update the user's balance, as well as updating merchant and transaction records 745 using the information described in 721 and/or like information.

If the acquirer cannot successfully procure the funds 736, the acquirer may send a notification of transaction failure 738 to the merchant (and, in some implementations, to ECO ADVANTAGE). The merchant may, after determining the transaction was not successful 739, send a notification to the user 740, along with a prompt to retry the transaction (e.g. with a different payment method and or the like). In some implementations the merchant may also forward the notification to ECO ADVANTAGE which, after obtaining the notification of transaction failure 741, may mark all related records (e.g. transaction records and/or the like) 742 as being incomplete until the transaction is successfully processed, until the user cancels the transaction, and/or the like. In some implementations, ECO ADVANTAGE may also monitor the status of various transactions, and may reverse, retry, and/or otherwise handle incomplete transactions if found in the ECO ADVANTAGE database's records, based on predetermined criteria.

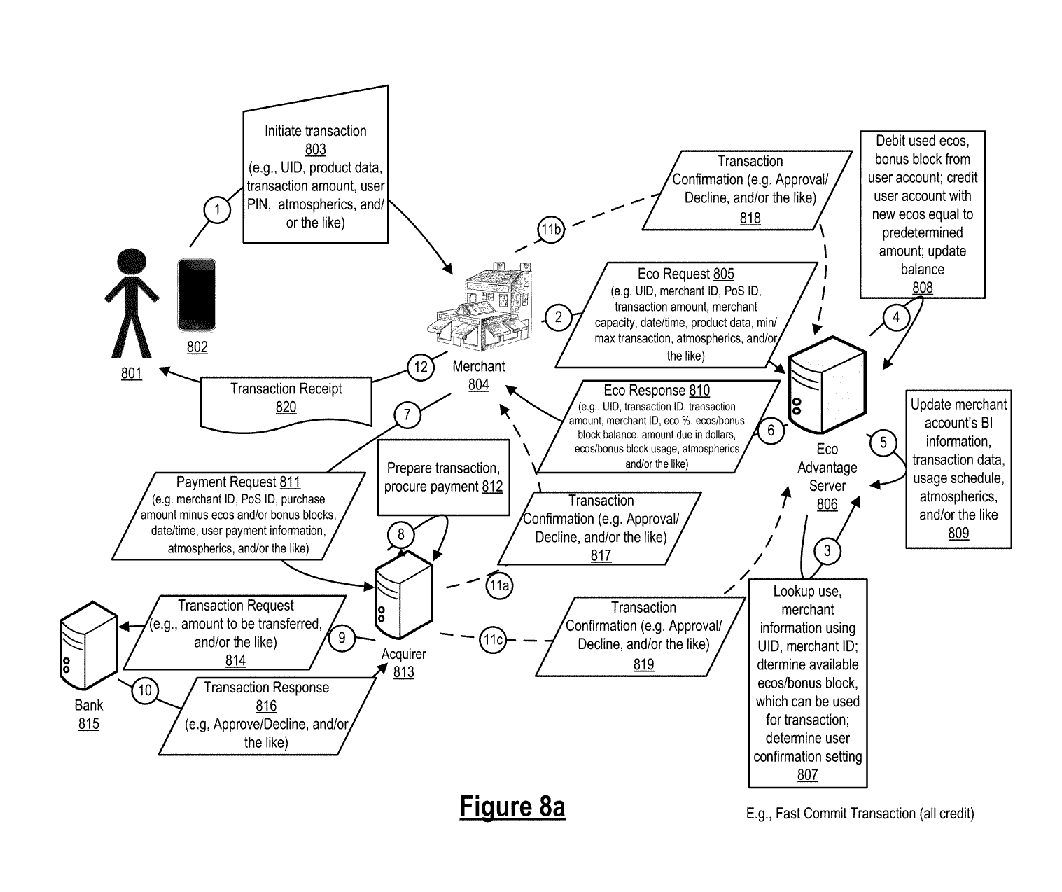

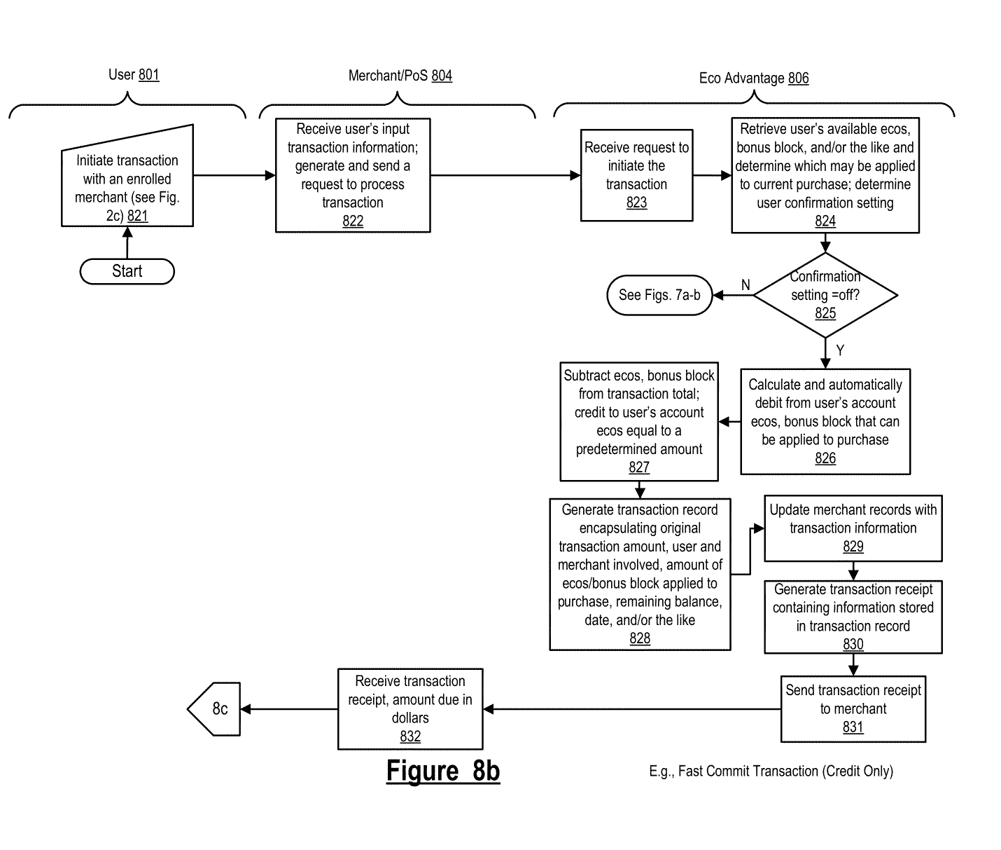

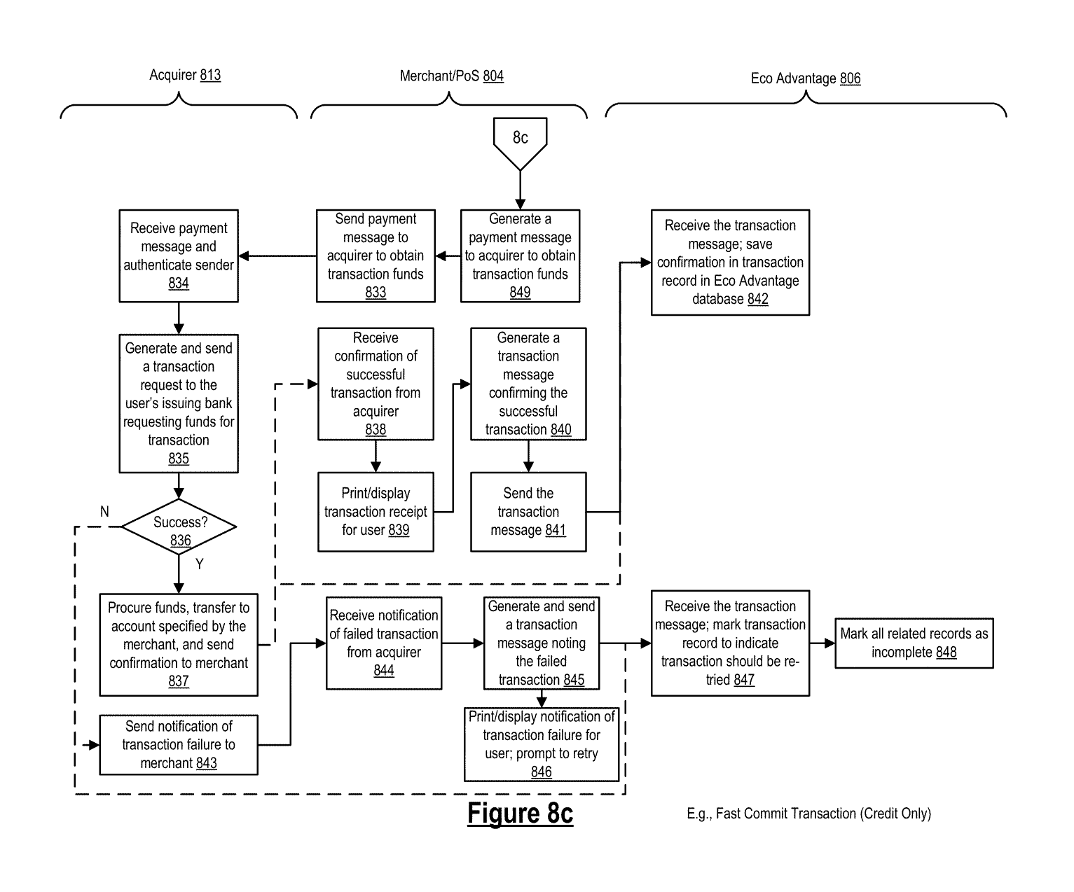

FIG. 8a shows a data flow diagram illustrating fast commit, credit-only transactions in example embodiments of the ECO ADVANTAGE. In some implementations, a user 801 may send a transaction initiation request 803 to the merchant 804 using the merchant's PoS device and/or a user electronic device 802. In some implementations, sensitive information (e.g. the user PIN and/or the like) may be encrypted. In some implementations, the transaction initiation request may take a form similar transaction initiation 205, or may take a form similar to the following:

POST / transaction_intitation_request.php HTTP/1.1
Host: www.ECOADVANTAGEprocess.com
Content-Type: Application/XML
Content-Length: 788
<?XML version = “1.0” encoding = “UTF-8”?>
<InitiateTransactionRequest>

<UID>32134321354321345312</UID>
<ProductData>haircut</ProductData>
<TransactionAmount>100</TransactionAmount>
<UserPIN>3214 3558 1587 9877</UserPIN>

</InitiateTransactionRequest>

In some implementations, sensitive information (e.g. the user PIN and/or the like) may be encrypted. In some implementations, the merchant may send an eco request 805 to the ECO ADVANTAGE 806. In some implementations, eco request 805 may take a form similar to eco request 206. ECO ADVANTAGE may look up the user's and merchant's records using the user ID (UID) and the merchant ID 807, respectively, and may determine which and how many ecos and bonus blocks the user may apply to his transaction (e.g. based on the merchant's eco schedule, the user's eco and bonus block balances, and/or the like), and may determine the state of a user confirmation setting. If the confirmation setting is set to “false,” ECO ADVANTAGE may not require the user to confirm his transaction before initiating any portion of it. In some implementations ECO ADVANTAGE may debit 808 the used ecos and bonus blocks from the user's balances, may credit to the user with new ecos equal to a predetermined amount related to the transaction amount, and may update the user's balances. ECO ADVANTAGE may also update the merchant account record 809, including updating BI information, transaction data, the merchant's usage schedule, atmospherics, and/or the like.

ECO ADVANTAGE may send an eco response 810 back to the merchant, which may take a form similar to eco response 212. The merchant may send a payment request 811 to the merchant's acquirer 813, which may ask the entity to process the transaction. In some implementations, payment request 811 may take a form similar to payment request 215. The acquirer may prepare 812 the transaction and procure payment via sending a transaction request 814 to a bank entity 815 (e.g. the user's issuing bank, another acquirer, and/or the like). In some implementations, the transaction request 814 may take a form similar to transaction request 714. The bank may send a transaction response 816 to the acquirer, which may indicate whether or not the transaction was approved and/or processed, or whether the transaction was declined. The acquirer may forward this information to ECO ADVANTAGE via transaction confirmation 819, which may take a form similar to transaction confirmation 219, or may forward the information to the merchant via transaction confirmation 817 (which may take a form similar to transaction confirmation 219), who may forward the information via transaction confirmation 818 to ECO ADVANTAGE. In some implementations, transaction confirmation 818 may take a form similar to transaction confirmation 719. In some implementations, the merchant may use the eco credit confirmation to generate and send a transaction receipt 820 to the user, which may contain information similar to transaction receipt 723. In some implementations, ECO ADVANTAGE may also monitor the status of various transactions, and may reverse, retry, and/or otherwise handle incomplete transactions if found in the ECO ADVANTAGE database's records, based on predetermined criteria.

FIG. 8b shows a logic flow diagram illustrating fast commit, credit-only transactions in example embodiments of the ECO ADVANTAGE. In some implementations, a user may initiate 821 a transaction with an enrolled merchant, via providing transaction input to a merchant. The merchant may receive the user input and transaction information 822, and may generate and send a request to ECO ADVANTAGE for the user's eco and/or bonus block balances. In some implementations, ECO ADVANTAGE may receive 823 the request for the user's eco and bonus block balance, and may retrieve from the ECO ADVANTAGE database 824 the user's available ecos, bonus blocks, and/or the like to determine which and how many ecos and bonus blocks may be applied to the current transaction, as well as to determine the user's confirmation setting. If the confirmation setting is off 825, ECO ADVANTAGE may calculate and automatically debit 826 from the user's account the ecos and/or bonus blocks that the user may apply to the purchase. ECO ADVANTAGE may also subtract the ecos and bonus blocks being used from the transaction total 827, and may credit to the user's account a number of ecos equal to a predetermined amount based on the transaction balance and/or total. ECO ADVANTAGE may generate a transaction record encapsulating the original transaction amount, the user and merchant involved, the amount of ecos and/or bonus blocks used in the transaction, the remaining transaction balance, the date of the transaction, and/or like information, and may update the merchant records 829 with the transaction data and/or like data as described in 809, and/or like information. In some implementations, ECO ADVANTAGE may generate a transaction receipt 831 to send to the merchant who, once it has received 832 the transaction receipt and the remaining balance, may generate 849 and send 833 a payment request with the user's payment information, the transaction balance after subtracting the applied ecos and/or bonus blocks to the original transaction amount, and/or like information to an acquirer for procurement. In some implementations the acquirer may receive 834 the user's payment information, transaction data, and/or the like, and may generate and send a request to the user's issuing bank 835 for the transaction balance.

If the acquirer can successfully procures the funds 836, the acquirer may obtain the funds 837 and may send a confirmation to the merchant (and in some implementations, to ECO ADVANTAGE) indicating that the transaction was successfully processed. In some implementations the merchant may, if it receives a notification 838 indicating a successful transaction, print and/or display a transaction receipt 839 for the user, and may generate 840 and send 841 a transaction confirmation message to ECO ADVANTAGE indicating that the transaction was successful. ECO ADVANTAGE may, after receiving 842 the transaction confirmation, save the confirmation within the transaction record in the ECO ADVANTAGE database in order to mark the transaction as completed.

If the acquirer cannot successfully procure the funds 836, the acquirer may send a notification of transaction failure 843 to the merchant (and, in some implementations, to ECO ADVANTAGE). The merchant may, after receiving 844 the notification of a failed transaction, generate and send 845 a transaction confirmation to ECO ADVANTAGE indicating the transaction failed, and may also display and/or print 846 a notification of transaction failure for the user and/or may prompt the user to retry the transaction (e.g. with a different payment method and/or the like). ECO ADVANTAGE may receive 847 the transaction confirmation message and mark the transaction as incomplete and necessary to retry, and mark related records (e.g. the user's record, the merchant's record and/or the like) as also being incomplete 848. In some implementations, ECO ADVANTAGE may also monitor the status of various transactions, and may reverse, retry, and/or otherwise handle incomplete transactions if found in the ECO ADVANTAGE database's records, based on predetermined criteria.

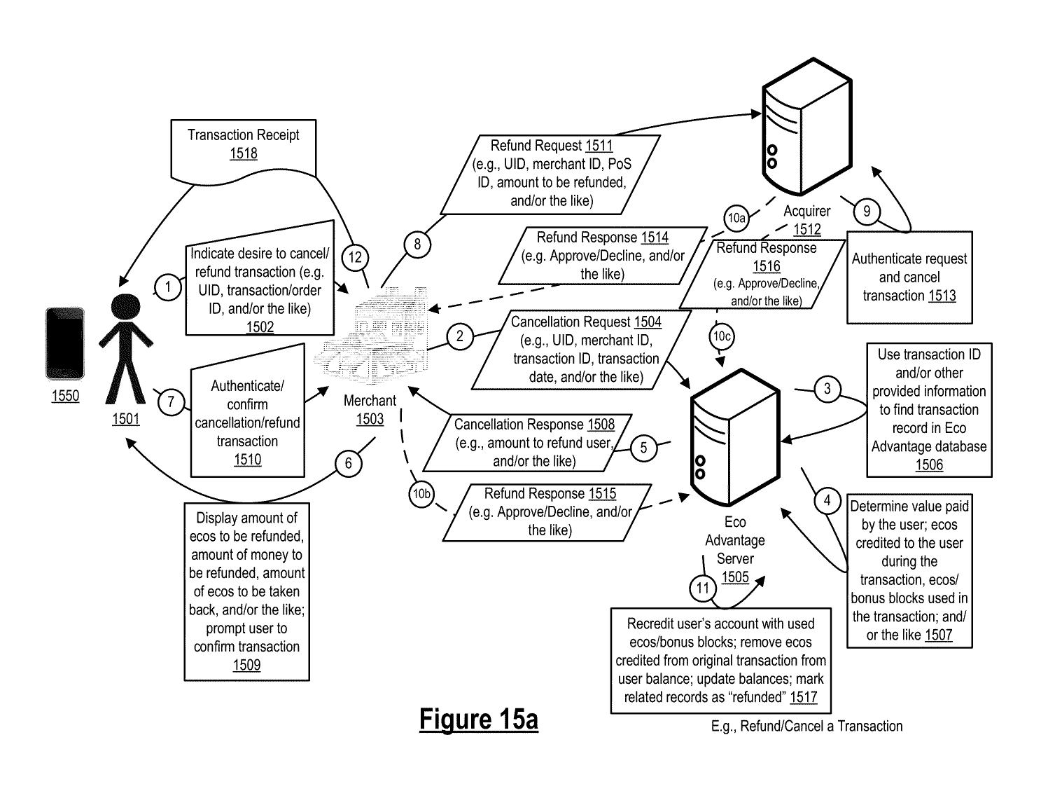

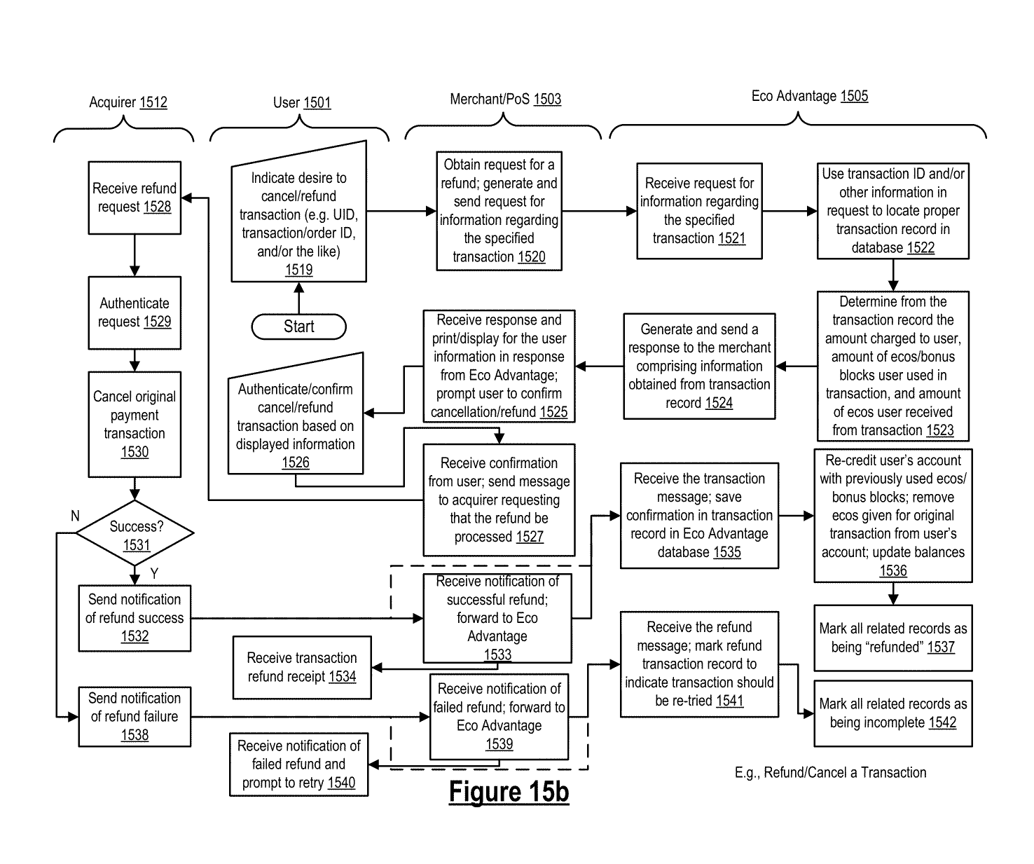

In some implementations, ECO ADVANTAGE and/or the merchant may prompt the user to confirm after the transaction has been committed and processed. In such implementations, if the user confirms the transaction, the user may receive transaction receipt 820. If the user declines the transaction, ECO ADVANTAGE may cancel the processed transaction (see FIGS. 15a-b).

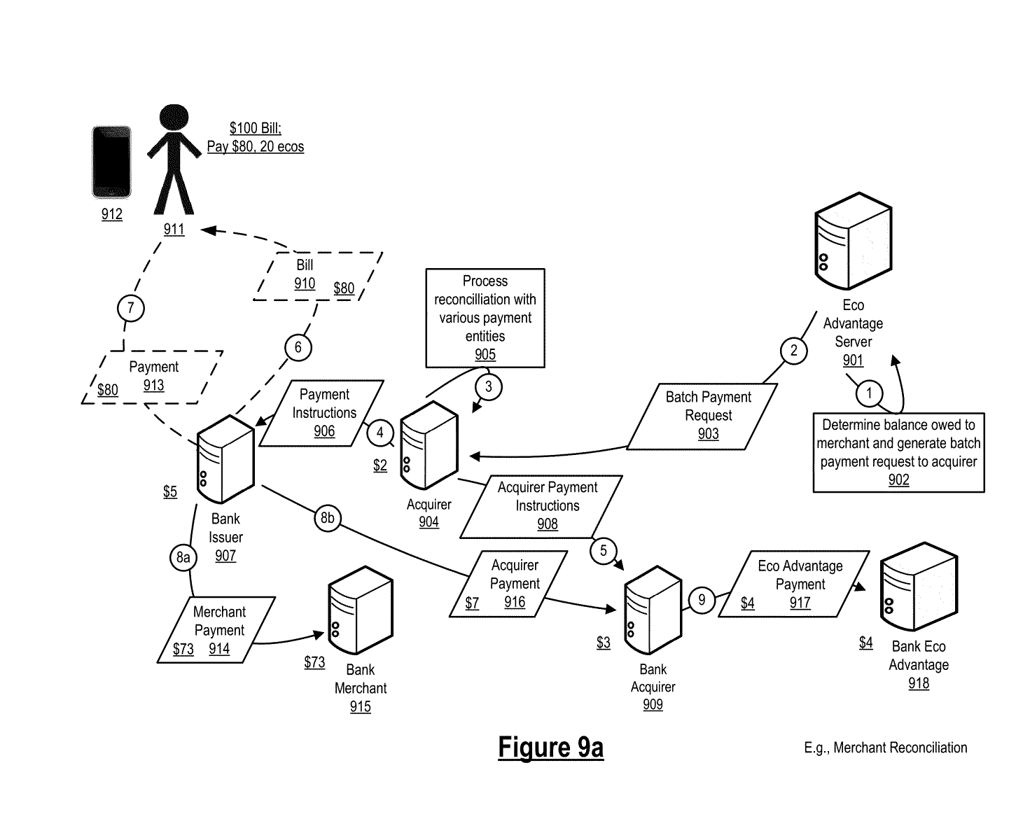

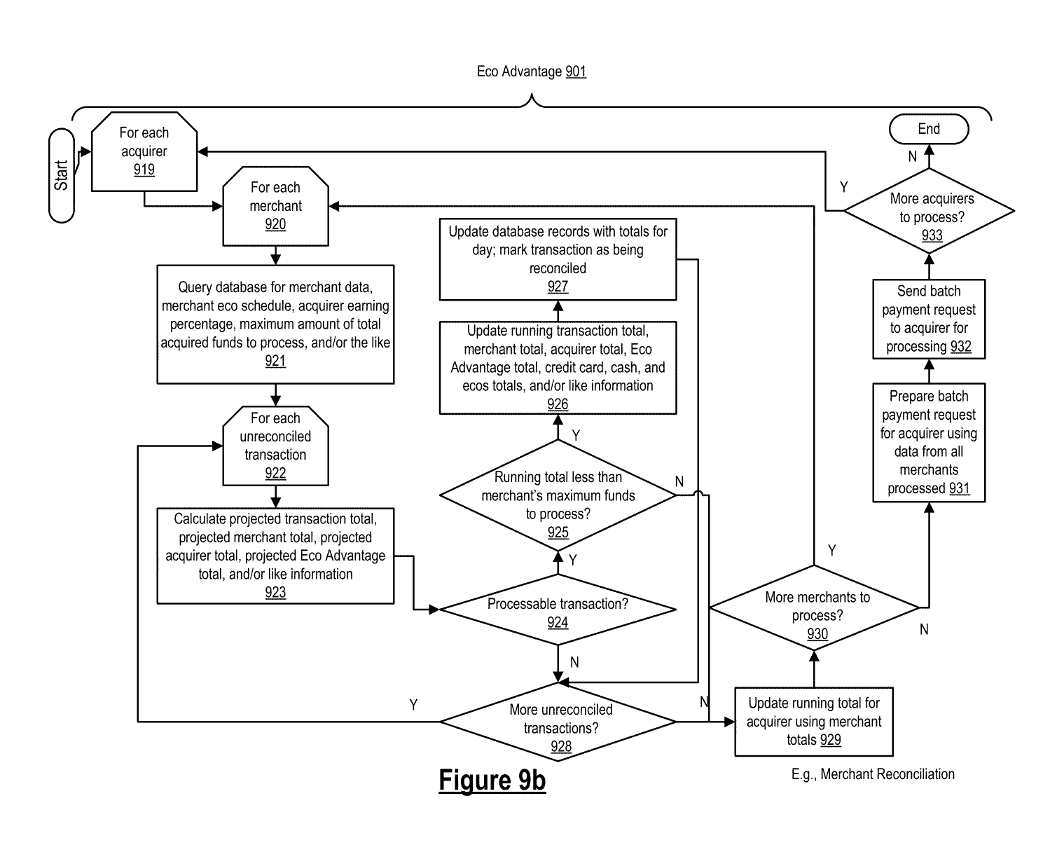

FIG. 9a shows a data flow diagram illustrating merchant reconciliation in example embodiments of the ECO ADVANTAGE. In some implementations, ECO ADVANTAGE 901 may determine the balance owed to a merchant in ECO ADVANTAGE 902 (e.g. based on incomplete transaction records and/or the like), and may generate a batch payment request to the acquirer. In some implementations, ECO ADVANTAGE may send a batch payment request 903 to an acquirer 904. In some implementations, an exemplary batch payment request 903 may take a form similar to the following:

POST / batch_payment_request.php HTTP/1.1
Host: www.ECOADVANTAGEprocess.com
Content-Type: Application/XML
Content-Length: 788
<?XML version = “1.0” encoding = “UTF-8”?>
<batchPaymentRequest>

<listOfPaymentRequest>

<paymentRequest>

<id>125414</id>
<ecoadvantage>true</merchantId>
<balanceOwed>8547.00</balanceOwed>
<requestDate>05/13/2013</requestDate>

</paymentRequest>
<paymentRequest>

<id>125415</id>
<acquirer>2033</merchantId>
<balanceOwed>54871.00</balanceOwed>
<requestDate>05/13/2013</requestDate>

</paymentRequest>
<paymentRequest>

<id>125416</id>
<merchantId>2034</merchantId>
<balanceOwed>125.00</balanceOwed>
<requestDate>05/13/2013</requestDate>

</paymentRequest>
<paymentRequest>

<id>125417</id>
<merchantId>2035</merchantId>
<balanceOwed>588.00</balanceOwed>
<requestDate>05/13/2013</requestDate>

</paymentRequest>

</listOfPaymentRequest>

</batchPaymentRequest>

The acquirer may perform 905 reconciliation with various payment entities via sending a payment instruction message 906 to the user's issuing bank 907 and an acquirer payment instruction message 908 to an acquiring bank 909. In some implementations, the issuer bank may send a bill 910 to the user 911, who may view the bill in the merchant location or via the user's electronic device 912. The user may send a payment indication 913 to the issuer in order to indicate that the issuer should provide the funds for the payment.

The issuer may send a merchant payment message 914 to the merchant's bank 915, which may include the funds requested for the payment being processed. The issuer may also send an acquirer payment 916 to the acquiring bank 909, which may include a payment to the acquirer for processing the transaction. The acquiring bank may, using the acquirer payment instructions 908 and the acquirer payment 916, calculate a payment value to be sent to ECO ADVANTAGE 918, and may send the ECO ADVANTAGE Payment 917 to ECO ADVANTAGE. In some implementations, ECO ADVANTAGE may also send a confirmation request to the acquirer containing a request date, in order to determine whether the batch payment was successful. In some implementations, ECO ADVANTAGE may receive a confirmation once the payment has been processed at the ECO ADVANTAGE bank, which may include a confirmation that the transaction was successfully processed, the transaction ID for each transaction from the acquirer, and/or the like, for each transaction in the batch.

FIG. 9b shows a logic flow diagram illustrating merchant reconciliation in example embodiments of the ECO ADVANTAGE. In some implementations, for each acquirer connected to ECO ADVANTAGE 919, ECO ADVANTAGE may check every merchant 920 that uses the acquirer to see if any reconciliation is necessary for the merchant. ECO ADVANTAGE may query 921 the database for transaction data, merchant data, the merchant's eco schedule, the acquirer's earning percentage, the maximum amount of total funds that the acquirer can process at the time, and/or the like. For each transaction in the transaction data that is unreconciled 922, ECO ADVANTAGE may calculate the transaction total for the transaction, and may also calculate what the acquirer's running transaction total at the time, the merchant's running transaction total at the time, and the ECO ADVANTAGE transaction total at the time would be if the transaction is reconciled 923 at the time. If the transaction is not processable 924 (e.g., if the projected totals do not exceed the maximum amount of total funds that may be processed by the acquirer at the time), ECO ADVANTAGE may determine whether there are other unreconciled transactions 928 (e.g. in case another unreconciled transaction may be processable), and may continue to check each unreconciled transaction in the database.

If the transaction is processable, ECO ADVANTAGE may also check to determine whether the projected totals would be less than the merchant's maximum amount of possible funds to process 925. If not, ECO ADVANTAGE may determine whether there are any other unreconciled transactions to process 928. If the projected totals are also less than the merchant's maximum processable funds amount, ECO ADVANTAGE may update the actual calculated running totals 926 to reflect the calculated running total of the merchant, acquirer, ECO ADVANTAGE, and/or the like once the transaction is processed. ECO ADVANTAGE may also keep a running total for different payment methods, such as the total amount of funds to be received from credit/debit cards, the total amount of funds received in cash, the total amount of funds received in ecos, and/or the like. ECO ADVANTAGE may update 927 the ECO ADVANTAGE database records with the totals calculated at the time, and may update the transaction record to reflect that the transaction has been reconciled. Once all transactions have been checked, ECO ADVANTAGE may update 929 the running total for the acquirer based on the merchant's totals and may check to see if there are any other merchants to process 930. If so, ECO ADVANTAGE may calculate the same totals for the remaining merchants; if not, ECO ADVANTAGE may prepare 931 a batch payment request to an acquirer using the data obtained from all the processed merchants, and may send 932 the batch payment request to the acquirer for payment processing. If there are other acquirers 922 to process, ECO ADVANTAGE may repeat the process for each other acquirer connected with ECO ADVANTAGE.

In some implementations, Grails code for processing the batch payment may take a form similar to the following:

def totalEcoAdvantage = 0
def batchPayment = [ ];
def listOfAquirer = Acquirer.findAll( )
foreach(aquirer in listOfAquirer) {

def totalAcquirer = 0
def listOfMerchant = Merchant.findbyAquirerer(acquirer)
foreach(merchant in listOfMerchant) {
def totalMerchandFund = 0

def totalMerchant = 0

def listOfTransaction =

Transaction.findByAcquirerAndMerchant(acquirer, merchant)

foreach(transaction in listOfTransaction) {

if (NOT transaction.reconciled) {

def totalTransaction =
transaction.calculateTotal( )
totalMerchant = totalMerchant +

transaction.calculateTotalMerchant( )

totalAcquirer = totalAcquirer +

transaction.calculateTotalAcquirer( )

totalEcoAdvantage = totalEcoAdvantage +

transaction.calculateTotalEcoAdv( )

if (totalMerchandFund + totalMerchant <

SystemSetting.getMaxFundToMerchant( )) {

```
  Reconcilation reconcilation = new Reconcilation( )
  reconcilation.merchant = merchant
  reconcilation.acquirer = acquirer
  reconcilation.date = today( )
  reconcilation.totalTransaction = totalTransaction
  reconcilation.totalMerchant = transaction.calculateTotalMerchant( )
  reconcilation.totalAcquirer = transaction.calculateTotalAcquirer( )
  reconcilation.totalEcoAdvantage =
  transaction.calculateTotalEcoAdv( )
  reconcilation.totalCash = transaction.calculateTotalCash( )
  reconcilation.totalCard = transaction.calculateTotalCard( )
  reconcilation.totalEco = transaction.calculateTotalEco( )
  reconcilation.save( )
  transaction.reconciled = true
  transaction.save( );
  totalMerchandFund =+ totalMerchant
```

}
}

}

PaymentRequest paymentRequest = new PaymentRequest( );
paymentRequest.merchant = merchant;
paymentRequest.balanceOwed = totalMerchant;
paymentRequest.requestDate = new Date( );
paymentRequest.confirmed = false;
paymentRequest.save( )
batchPayment.push(payment: paymentRequest)
}
PaymentRequest paymentRequest = new PaymentRequest( );
paymentRequest.acquirer = acquirer;
paymentRequest.balanceOwed = totalAcquirer;
paymentRequest.requestDate = new Date( );
paymentRequest.confirmed = false;
paymentRequest.save( )
batchPayment.push(payment: paymentRequest)
}
PaymentRequest paymentRequest = new PaymentRequest( );
paymentRequest.ecoAdvantage = true;
paymentRequest.balanceOwed = totalEcoAdvantage;
paymentRequest.requestDate = new Date( );
paymentRequest.confirmed = false;
paymentRequest.save( )
batchPayment.push(payment: paymentRequest)
render batchPayment as XML;

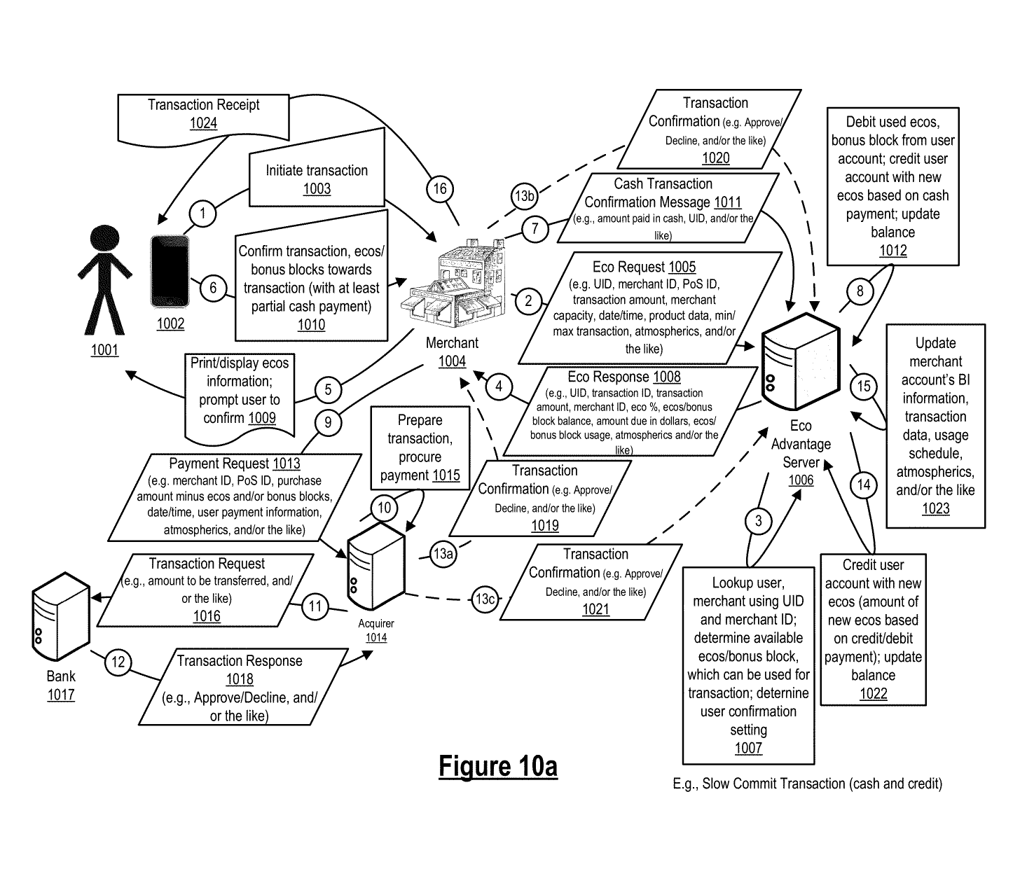

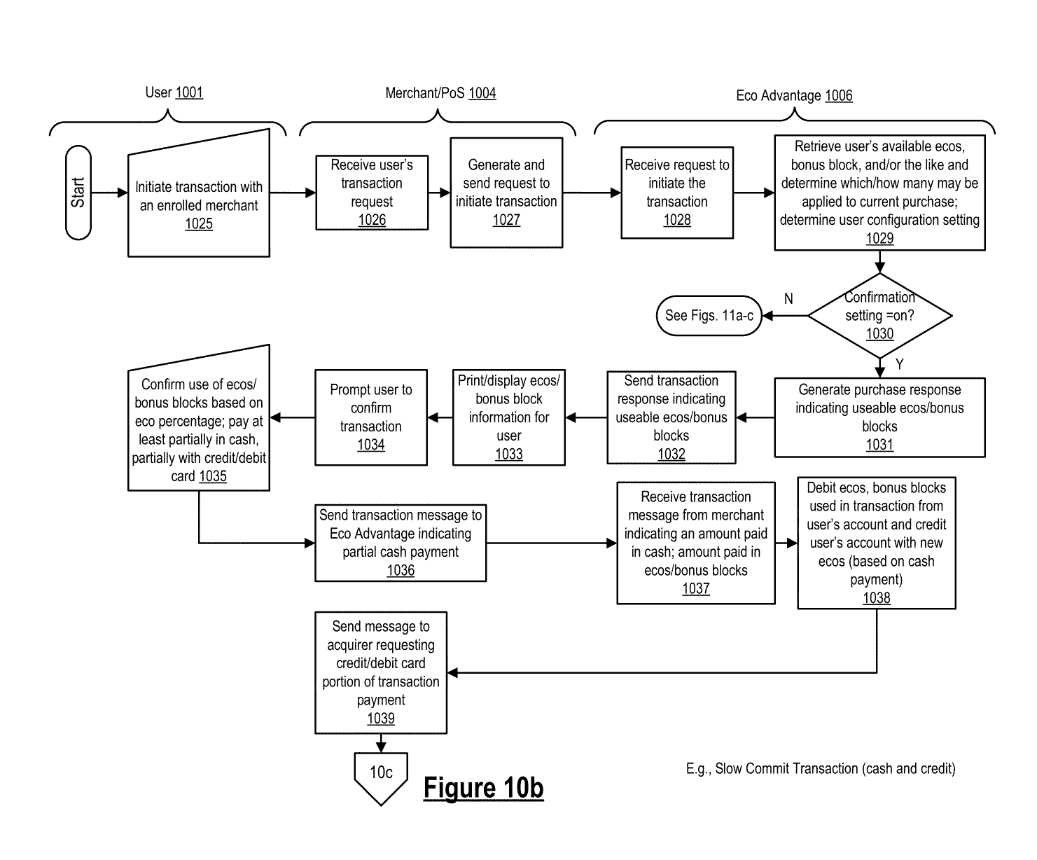

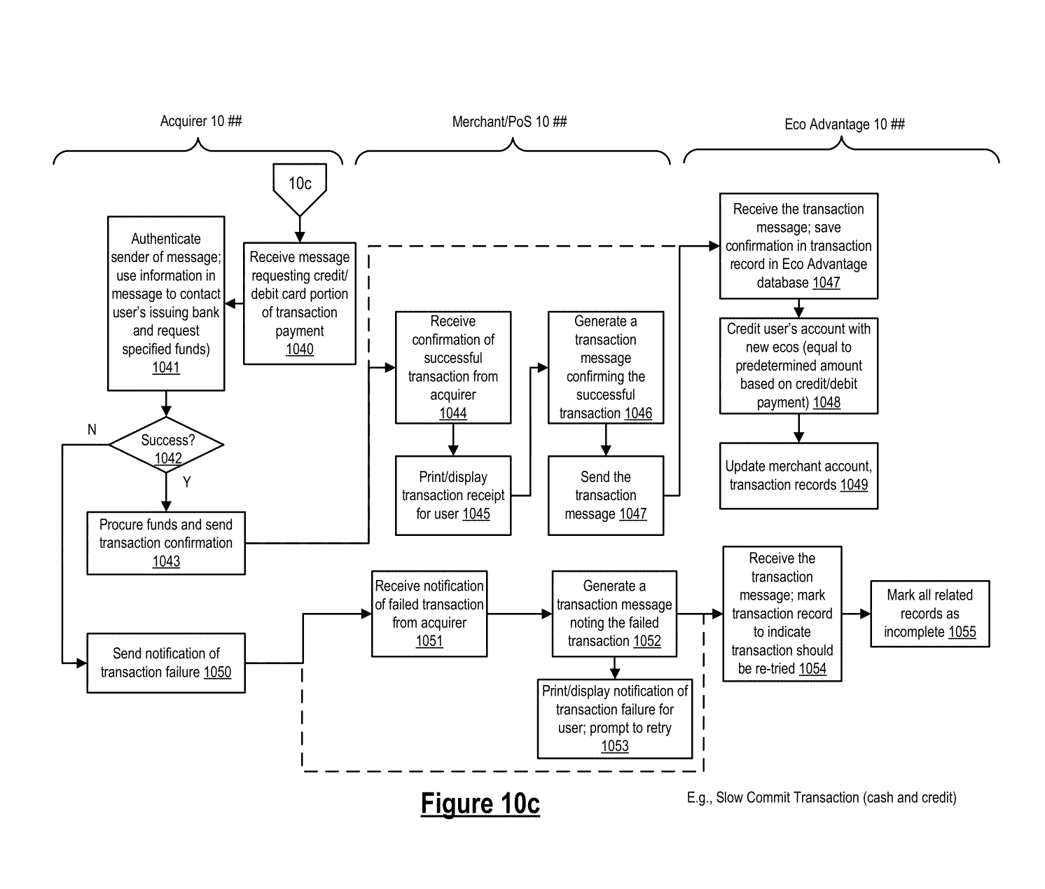

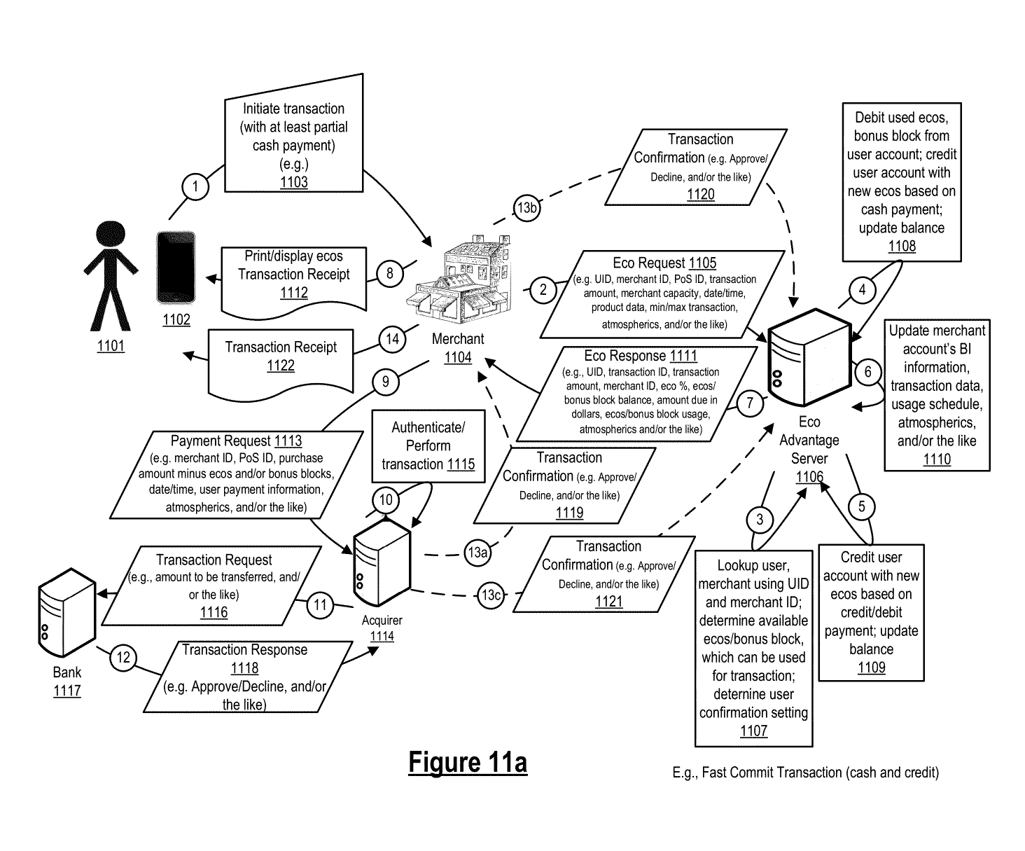

FIG. 10a shows a data flow diagram illustrating slow commit, cash and credit transactions in example embodiments of the ECO ADVANTAGE. In some implementations, a user 1001 may send a transaction initiation request 1003 to the merchant 1004 using the merchant's PoS device and/or a user electronic device 1002. In some implementations, sensitive information (e.g. the user PIN and/or the like) may be encrypted. In some implementations, the merchant may send an eco request 1005 to the ECO ADVANTAGE 1006. In some implementations, eco request 1005 may take a form similar to eco request 206. ECO ADVANTAGE may look up the user's and merchant's records using the user ID (UID) and the merchant ID 1007, respectively, and may determine which and how many ecos and bonus blocks the user may apply to his transaction (e.g. based on the merchant's eco schedule, the user's eco and bonus block balances, and/or the like), and may determine the state of a user confirmation setting. If the confirmation setting is set to “true,” ECO ADVANTAGE may require the user to confirm his transaction before initiating any portion of it. In some implementations ECO ADVANTAGE may send an eco response 1008 back to the merchant, which may take a form similar to eco response 212.

In some implementations, the merchant may display and/or print 100A the ecos information for the user, who may review the information 1010 and confirm the transaction, including the ecos and/or bonus blocks to be used in the transaction. The user may also choose to pay some part of the transaction with cash. In some implementations, the cash payment may also be a check, gift coupon, pre-paid gift voucher, community scrip, electronic fund transfer, a money card, money order, bank transfer, bank payment slip, and/or a like payment method. In such cases, the merchant may send a cash transaction confirmation message 1011 to ECO ADVANTAGE indicating that the user has already paid part of the transaction balance in cash, and is to pay the rest with a credit/debit card, and/or the like. ECO ADVANTAGE may debit 1012 the ecos and/or bonus blocks being used towards the transaction from the user account, may credit the user account with a predetermined amount of ecos based on the cash payment, and may update the user's balances.

The merchant may send a payment request 1013 to the merchant's acquirer 1014, which may ask the entity to process the transaction. In some implementations, payment request 1013 may take a form similar to payment request 215. The acquirer may prepare 1015 the transaction and procure payment via sending a transaction request 1016 to a bank entity 1017 (e.g. the user's issuing bank, another acquirer, and/or the like). The bank may send a transaction response 1018 to the acquirer, which may indicate whether or not the transaction was approved and/or processed, or whether the transaction was declined. The acquirer may forward this information to ECO ADVANTAGE via transaction confirmation 1021, which may take a form similar to the following:

POST /transaction_confirmation.php HTTP/1.1
Host: www.ECOADVANTAGEprocess.com
Content-Type: Application/XML
Content-Length: 788
<?XML version = “1.0” encoding = “UTF-8”?>
<paymentConfirmation>

<UID>da6c5cdf4e90b2961873f7b2e863415</UID>
<transactionId>635467</transactionId>
<merchantId>2033</merchantId>
<posId>4088</posId>
<amounDueInDollars>77.0</amountDueInDollars>
<bonusBlockAmount>20</bonusBlockAmount>
<debitCreditAmount>27.0</debitCreditAmount>
<cashAmount>50.0</cashAmount>
<totalAmount>100</totalAmount>
<dateTime>03/07/2013 03:40 PM</dateTime>
<approved>true</approved>

</paymentConfirmation>

In some implementations the acquirer may forward the information to the merchant via transaction confirmation 1019 (which may take a form similar to transaction confirmation 219), who may forward the information via transaction confirmation 1020 to ECO ADVANTAGE. Once ECO ADVANTAGE has received a transaction confirmation, it may credit 1022 to the user with new ecos equal to a predetermined amount related to the credit/debit and/or the like transaction amount, and may update the user's balance. ECO ADVANTAGE may also update the merchant account record 1023, including updating BI information, transaction data, the merchant's usage schedule, atmospherics, and/or the like. In some implementations, the merchant may generate and send a transaction receipt 1024 to the user, which may contain information similar to transaction receipt 723. In some implementations, ECO ADVANTAGE may also monitor the status of various transactions, and may reverse, retry, and/or otherwise handle incomplete transactions if found in the ECO ADVANTAGE database's records, based on predetermined criteria.

FIGS. 10b-c show logic flow diagrams illustrating slow commit, cash and credit transactions in example embodiments of the ECO ADVANTAGE. In some implementations, a user may initiate 1025 a transaction with an enrolled merchant, via providing transaction input to a merchant. The merchant may receive the user input and transaction information 1026, and may generate and send 1027 a request to ECO ADVANTAGE for the user's eco and/or bonus block balances. In some implementations, ECO ADVANTAGE may receive 1028 the request for the user's eco and bonus block balance, and may retrieve from the ECO ADVANTAGE database 1029 the user's available ecos, bonus blocks, and/or the like to determine which and how many ecos and bonus blocks may be applied to the current transaction, as well as to determine the user's confirmation setting. If the confirmation setting is on 1030, ECO ADVANTAGE may generate 1031 and send 1032 a response to the merchant indicating the user's eco and/or bonus block balances and/or like transaction information. The merchant may receive the balance information 1033 and forward the information to the user via displaying and/or printing the transaction information for the user and asking the user to confirm the transaction 1034. The user may authenticate 1035 the transaction and the use of his ecos and/or bonus blocks towards the purchase using his password, user PIN, and/or a like form of identification, and may pay some amount of the balance in cash. In some implementations, the merchant may generate and send a message 1036 to ECO ADVANTAGE indicating the user has both confirmed the use of his ecos and/or bonus blocks and wishes to pay for the transaction, and has paid at least a portion of the transaction balance in cash. Once ECO ADVANTAGE receives 1037 the message, it may debit 1038 from the user's account all of the used ecos and/or bonus blocks in the transaction, and may credit the user's account with new ecos equal to a predetermined amount based on the cash payment.

In some implementations, the merchant may also generate and send a payment request 1039 with the user's payment information, the transaction balance after subtracting the applied ecos and/or bonus blocks and the partial cash payment from the original transaction amount, and/or like information to an acquirer for procurement. In some implementations the acquirer may receive 1040 the user's payment information, transaction data, and/or the like, and may authenticate the sender of the message 1041 and use the information to request the transaction balance from the user's issuing bank.

If the acquirer can successfully procures the funds 1042, the acquirer may obtain the funds 1043 and may send a confirmation to the merchant (and in some implementations, to ECO ADVANTAGE) indicating that the transaction was successfully processed. In some implementations the merchant may, if it receives a notification 1044 indicating a successful transaction, print and/or display a transaction receipt 1045 for the user, and may generate 1046 and send 1047 a transaction confirmation message to ECO ADVANTAGE indicating that the transaction was successful. ECO ADVANTAGE may, after receiving 1047 the transaction confirmation, save the confirmation within the transaction record in the ECO ADVANTAGE database in order to mark the transaction as completed. ECO ADVANTAGE may also credit 1048 the user's account with a predetermined amount of new ecos based on the user's credit/debit payment, and may update the merchant and transaction records 1049 using the data in 1023 and/or like information in the ECO ADVANTAGE database to indicate that the full transaction amount has been processed and procured.

If the acquirer cannot successfully procure the funds 1042, the acquirer may send a notification of transaction failure 1050 to the merchant (and, in some implementations, to ECO ADVANTAGE). The merchant may, after receiving 1051 the notification of a failed transaction, generate and send 1052 a transaction confirmation to ECO ADVANTAGE indicating the transaction failed, and may also display and/or print 1053 a notification of transaction failure for the user and/or may prompt the user to retry the transaction (e.g. with a different payment method and/or the like). ECO ADVANTAGE may receive 1054 the transaction confirmation message and mark the transaction as incomplete and necessary to retry, and mark related records (e.g. the user's record, the merchant's record and/or the like) as also being incomplete loss. In some implementations, ECO ADVANTAGE may also monitor the status of various transactions, and may reverse, retry, and/or otherwise handle incomplete transactions if found in the ECO ADVANTAGE database's records, based on predetermined criteria.

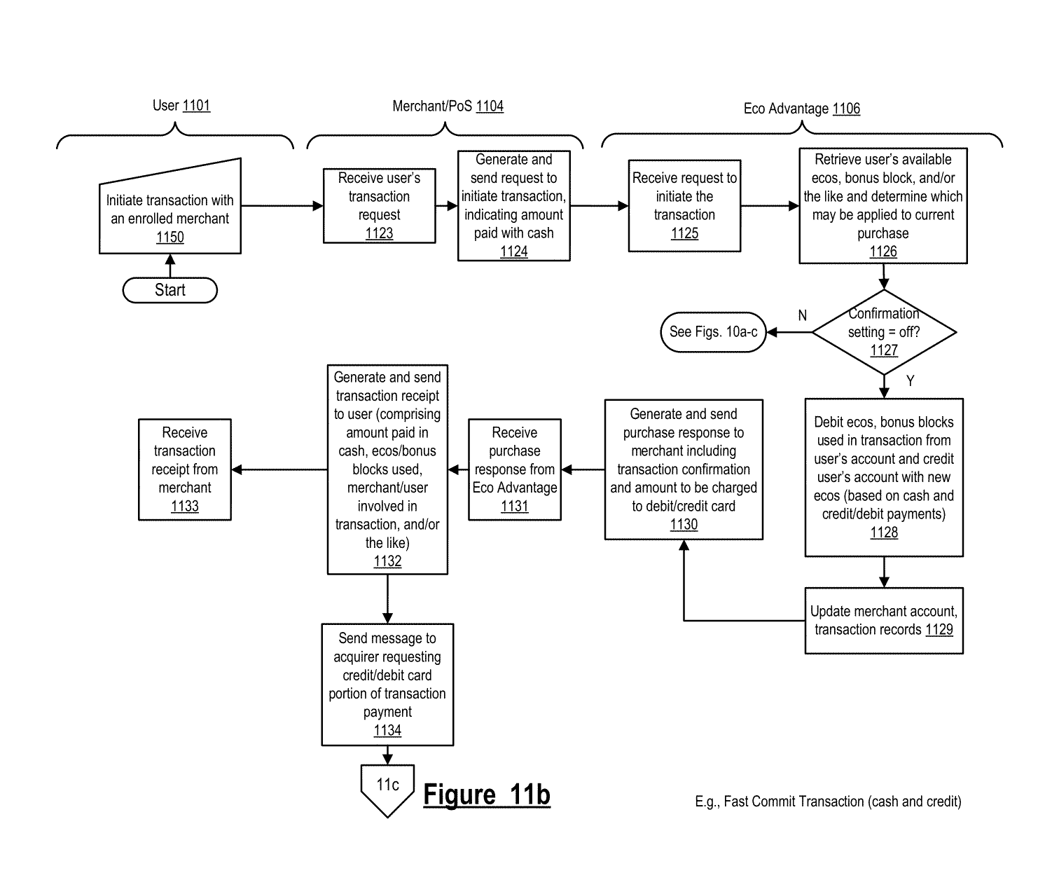

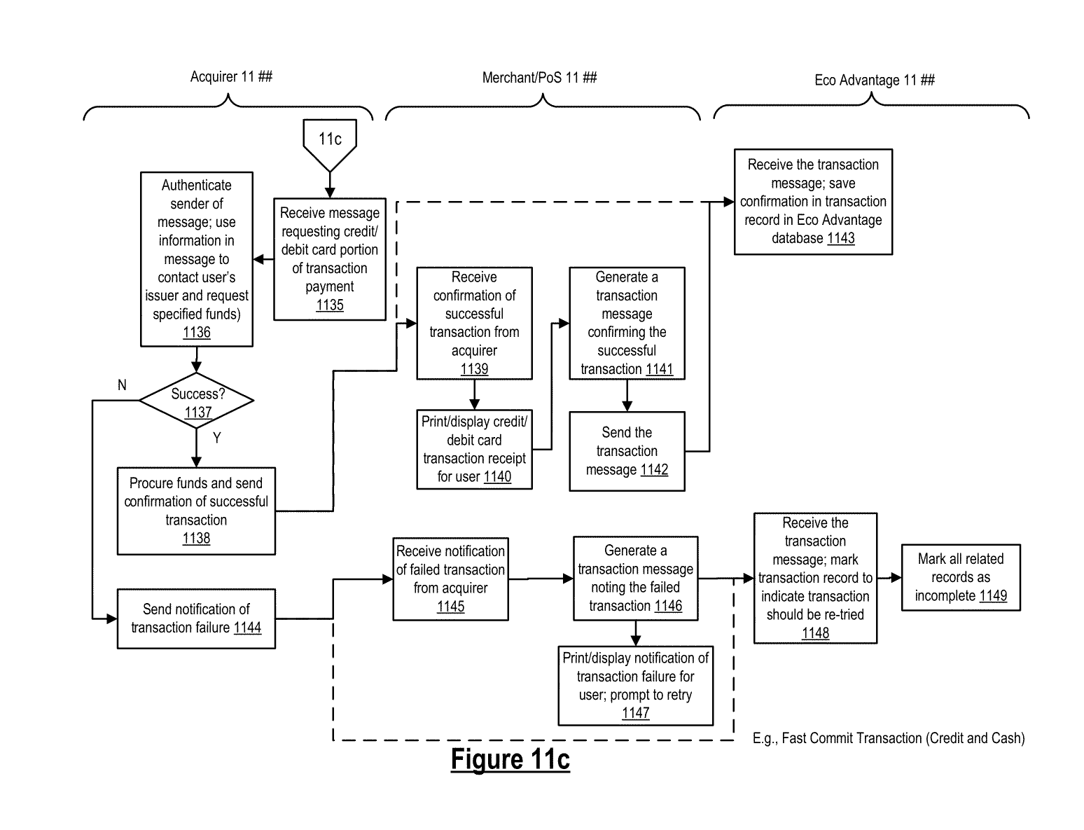

FIG. 11a shows a data flow diagram illustrating fast commit, cash and credit transaction in example embodiments of the ECO ADVANTAGE. In some implementations, a user 1101 may send a transaction initiation request 1103 to the merchant 1104 using the merchant's PoS device and/or a user electronic device 1102. In some implementations, sensitive information (e.g. the user PIN and/or the like) may be encrypted. In some implementations the user may also provide a cash payment to the merchant covering at least a part of the remaining transaction balance once the user's ecos and/or bonus blocks are applied. In some implementations, the cash payment may also be a check, gift coupon, pre-paid gift voucher, community scrip, electronic fund transfer, a money card, money order, bank transfer, bank payment slip, and/or a like payment method. In some implementations, the merchant may send an eco request 1105 to the ECO ADVANTAGE 1106. In some implementations, eco request 1105 may take a form similar to eco request 206. ECO ADVANTAGE may look up the user's and merchant's records using the user ID (UID) and the merchant ID 1107, respectively, and may determine which and how many ecos and bonus blocks the user may apply to his transaction (e.g. based on the merchant's eco schedule, the user's eco and bonus block balances, and/or the like), and may determine the state of a user confirmation setting. If the confirmation setting is set to “false,” ECO ADVANTAGE may not require the user to confirm his transaction before initiating any portion of it. ECO ADVANTAGE may debit 1108 the ecos and/or bonus blocks being used towards the transaction from the user account, may credit 1109 the user account with a predetermined amount of ecos based on the cash payment, and may update the user's balances. In some implementations Grails code for updating the user's balances may take a form similar to the following:

Transaction transaction = Transaction.get(transactionId)
User user = transaction.getUser( )
Merchant merchant = transaction.getMerchant( )
long ecoUsage = transaction.getEcoUsage( )
long bonusBlockUsage = transaction.getBonusBlockUsage( )
long amountPaidInCash = transaction.getAmountPaidInCash( )
Try {

beginTransaction( )
user.debitEco(ecoUsage)
user.debitBonusBlock(bonusBlockUsage)
user.creditEco(amountPaidInCash, merchant)
commitTransaction( );

} catch (Exception) {

rollbackTransaction( );
return false;

}

ECO ADVANTAGE may also update the merchant account record 1110, including updating BI information, transaction data, the merchant's usage schedule, atmospherics, and/or the like.

In some implementations ECO ADVANTAGE may send an eco response 1111 back to the merchant, which may take a form similar to eco response 212. In some implementations, the merchant may display and/or print 1112 the ecos information for the user via an ecos transaction receipt. The merchant may send a payment request 1113 to the merchant's acquirer 1114, which may ask the entity to process the transaction. In some implementations, payment request 1113 may take a form similar to payment request 1013. The acquirer may prepare 1115 the transaction and procure payment via sending a transaction request 1116 to a bank entity 1117 (e.g. the user's issuing bank, another acquirer, and/or the like). The bank may send a transaction response 1118 to the acquirer, which may indicate whether or not the transaction was approved and/or processed, or whether the transaction was declined. The acquirer may forward this information to ECO ADVANTAGE via transaction confirmation 1121, which may take a form similar to transaction confirmation 1021, or may forward the information to the merchant via transaction confirmation 1119 (which may take a form similar to transaction confirmation 219), who may forward the information via transaction confirmation 1120 to ECO ADVANTAGE. In some implementations, the merchant may generate and send a transaction receipt 1122 to the user, which may contain information similar to transaction receipt 1024. In some implementations, ECO ADVANTAGE may also monitor the status of various transactions, and may reverse, retry, and/or otherwise handle incomplete transactions if found in the ECO ADVANTAGE database's records, based on predetermined criteria.

FIGS. 11b-c show logic flow diagrams illustrating fast commit, cash and credit transactions in example embodiments of the ECO ADVANTAGE. In some implementations, a user may initiate 1150 a transaction with an enrolled merchant, via providing transaction input to a merchant. The merchant may receive the user input and transaction information 1123, and may generate and send 1124 a request to ECO ADVANTAGE for the user's eco and/or bonus block balances. In some implementations, ECO ADVANTAGE may receive 1126 the request for the user's eco and bonus block balance, and may retrieve from the ECO ADVANTAGE database 1126 the user's available ecos, bonus blocks, and/or the like to determine which and how many ecos and bonus blocks may be applied to the current transaction, as well as to determine the user's confirmation setting. If the confirmation setting is off 1127, ECO ADVANTAGE may debit 1128 the ecos and/or bonus blocks used in the transaction from the user's account, and may credit the user's account with a predetermined amount of new ecos, which may be based on the transaction amount (e.g. both the cash payment and the pending credit/debit card payment). ECO ADVANTAGE may also update the merchant account and transaction records 1129 using the information in 1110 and/or like information to add the transaction to the ECO ADVANTAGE database and to update the merchant's records based on the transaction data (e.g. update information described in 1110). ECO ADVANTAGE may generate and send 1130 a response to the merchant indicating the user's eco and/or bonus block balances and/or like transaction information. After receiving 1131 the response, the merchant may generate and send a transaction receipt 1132 to the user containing the data from the transaction (e.g. transaction total, amount paid with cash, amount paid with a credit/debit card, amount of ecos and/or bonus blocks used, and/or the like), which may be sent and received 1122 by the user.

In some implementations, the merchant may also generate and send a payment request 1134 with the user's payment information, the transaction balance after subtracting the applied ecos and/or bonus blocks and the partial cash payment from the original transaction amount, and/or like information to an acquirer for procurement. In some implementations the acquirer may receive 1135 the user's payment information, transaction data, and/or the like, and may authenticate the sender of the message 1136 and use the information to request the transaction balance from the user's issuing bank.

If the acquirer can successfully procures the funds 1127, the acquirer may obtain the funds 1138 and may send a confirmation to the merchant (and in some implementations, to ECO ADVANTAGE) indicating that the transaction was successfully processed. In some implementations the merchant may, if it receives a notification 1139 indicating a successful transaction, print and/or display a transaction receipt 1140 for the user, and may generate 1141 and send 1142 a transaction confirmation message to ECO ADVANTAGE indicating that the transaction was successful. ECO ADVANTAGE may, after receiving 1142 the transaction confirmation, save the confirmation within the transaction record in the ECO ADVANTAGE database in order to mark the transaction as completed.

If the acquirer cannot successfully procure the funds 1137, the acquirer may send a notification of transaction failure 1144 to the merchant (and, in some implementations, to ECO ADVANTAGE). The merchant may, after receiving 1145 the notification of a failed transaction, generate and send 1146 a transaction confirmation to ECO ADVANTAGE indicating the transaction failed, and may also display and/or print 1147 a notification of transaction failure for the user and/or may prompt the user to retry the transaction (e.g. with a different payment method and/or the like). ECO ADVANTAGE may receive 1148 the transaction confirmation message and mark the transaction as incomplete and necessary to retry, and mark related records (e.g. the user's record, the merchant's record and/or the like) as also being incomplete 1149. In some implementations, ECO ADVANTAGE may also monitor the status of various transactions, and may reverse, retry, and/or otherwise handle incomplete transactions if found in the ECO ADVANTAGE database's records, based on predetermined criteria.

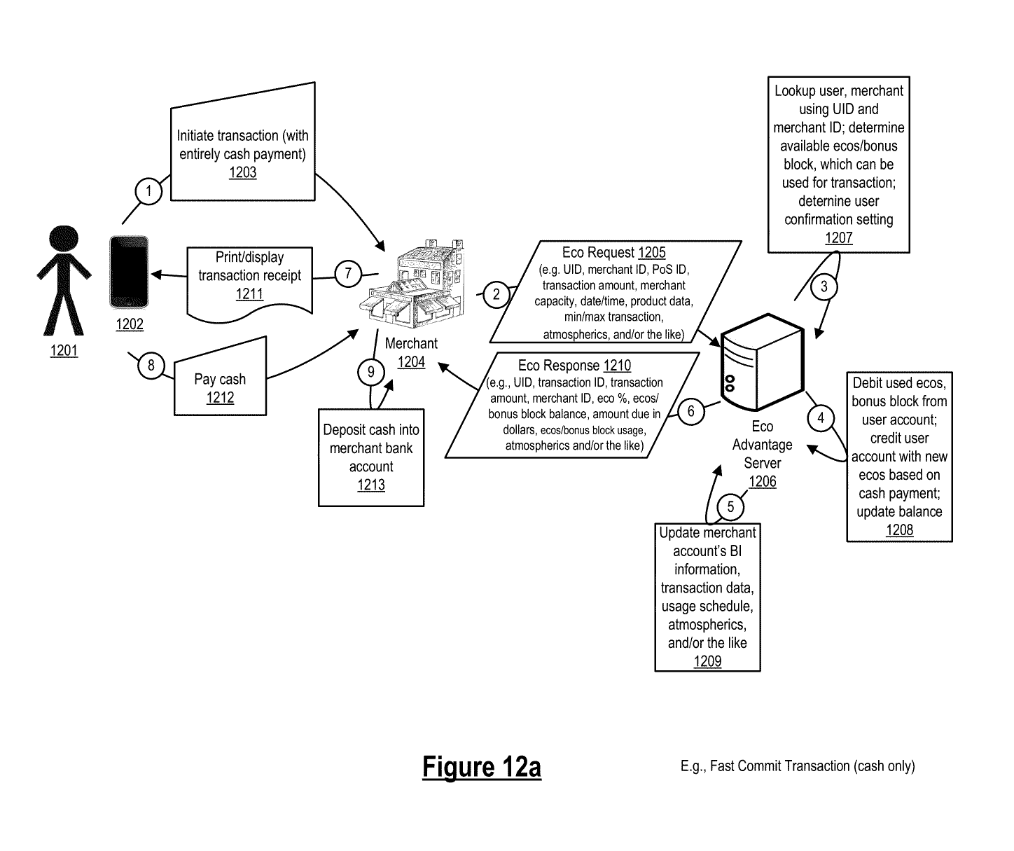

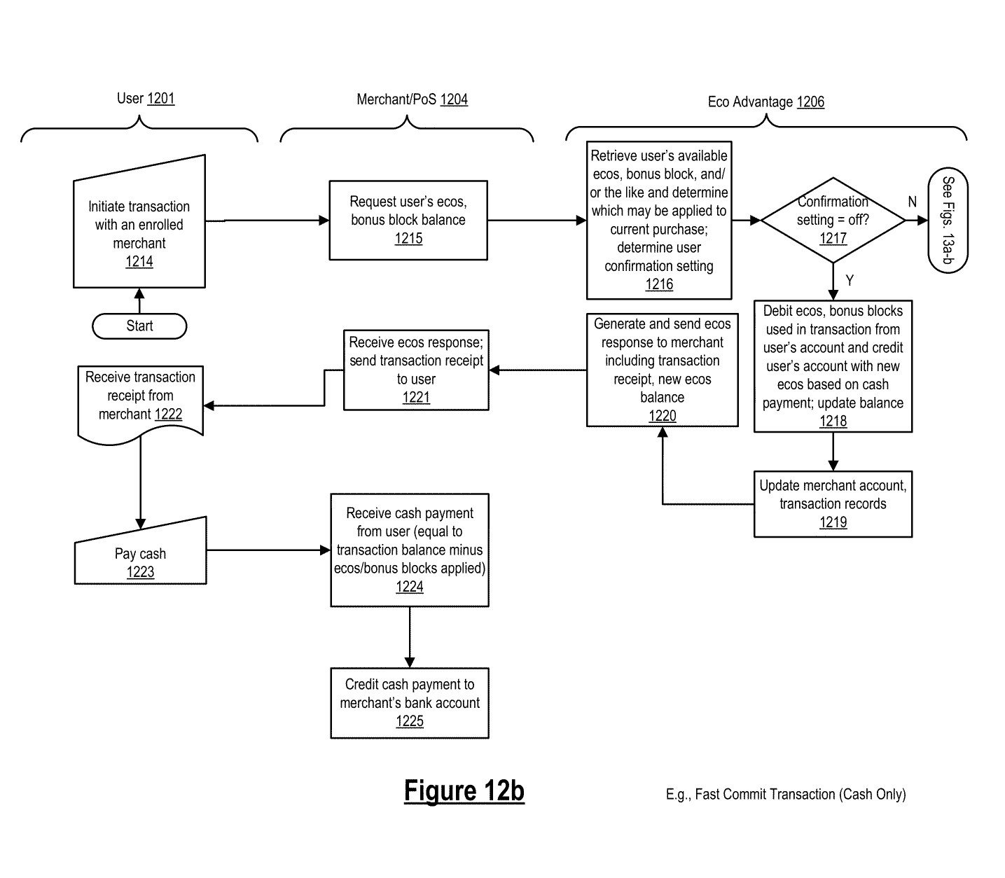

FIG. 12a shows a data flow diagram illustrating fast commit, cash only transactions in example embodiments of the ECO ADVANTAGE. In some implementations, a user 1201 may send a transaction initiation request 1203 to the merchant 1204 using the merchant's PoS device and/or a user electronic device 1202. In some implementations, sensitive information (e.g. the user PIN and/or the like) may be encrypted. In some implementations the user may also provide a cash payment to the merchant covering the entirety of the remaining transaction balance once the user's ecos and/or bonus blocks are applied. In some implementations, the cash payment may also be a check, gift coupon, pre-paid gift voucher, community scrip, electronic fund transfer, a money card, money order, bank transfer, bank payment slip, and/or a like payment method. In some implementations, the merchant may send an eco request 1205 to the ECO ADVANTAGE 1206. In some implementations, eco request 1205 may take a form similar to eco request 206. ECO ADVANTAGE may look up the user's and merchant's records using the user ID (UID) and the merchant ID 1207, respectively, and may determine which and how many ecos and bonus blocks the user may apply to his transaction (e.g. based on the merchant's eco schedule, the user's eco and bonus block balances, and/or the like), and may determine the state of a user confirmation setting. If the confirmation setting is set to “true,” ECO ADVANTAGE may require the user to confirm his transaction before initiating any portion of it. ECO ADVANTAGE may debit 1208 the ecos and/or bonus blocks being used towards the transaction from the user account, may credit the user account with a predetermined amount of ecos based on the cash payment, and may update the user's balances. ECO ADVANTAGE may also update the merchant account record 1209, including updating BI information, transaction data, the merchant's usage schedule, atmospherics, and/or the like.

In some implementations ECO ADVANTAGE may send an eco response 1210 back to the merchant, which may take a form similar to eco response 212. In some implementations, the merchant may display and/or print 1211 the ecos information for the user via a transaction receipt which may take a form similar to transaction receipt 1122. The user may pay cash 1212 to the merchant, and the merchant may deposit 1213 the cash in the merchant's bank account.

FIG. 12b shows a logic flow diagram illustrating fast commit, cash only transactions in example embodiments of the ECO ADVANTAGE. In some implementations, a user may initiate 1214 a transaction with an enrolled merchant, via providing transaction input to a merchant. The merchant may receive the user input and transaction information, and may generate and send 1215 a request to ECO ADVANTAGE for the user's eco and/or bonus block balances. In some implementations, ECO ADVANTAGE may receive the request for the user's eco and bonus block balance, and may retrieve from the ECO ADVANTAGE database 1216 the user's available ecos, bonus blocks, and/or the like to determine which and how many ecos and bonus blocks may be applied to the current transaction, as well as to determine the user's confirmation setting. If the confirmation setting is off 1217, ECO ADVANTAGE may debit 1218 the ecos and/or bonus blocks used in the transaction from the user's account, and may credit the user's account with a predetermined amount of new ecos, which may be based on the cash payment).

ECO ADVANTAGE may also update the merchant account and transaction records 1219 using the information from 1209 and/or like information to add the transaction to the ECO ADVANTAGE database and to update the merchant's records based on the transaction data (e.g. update information described in 1110). ECO ADVANTAGE may generate and send 1220 a response to the merchant indicating the user's eco and/or bonus block balances and/or like transaction information. After receiving 1221 the response, the merchant may generate and send a transaction receipt to the user containing the data from the transaction (e.g. transaction total, amount paid with cash, amount of ecos and/or bonus blocks used, and/or the like). When the user receives 1222 the transaction receipt, the user may pay cash 1223 to the merchant. The merchant may receive the cash payment 1224 from the user, which may cover the transaction balance after the user's qualifying ecos and bonus blocks have been applied. The merchant may credit 1225 the cash payment to the merchant's bank account via depositing the cash in the merchant's bank account.

In some implementations, ECO ADVANTAGE and/or the merchant may prompt the user to confirm after the transaction has been committed. In such implementations, if the user confirms the transaction, the user may receive transaction receipt 1211 and may pay for the transaction. If the user declines the transaction, ECO ADVANTAGE may reverse the committed transaction information in the ECO ADVANTAGE database.

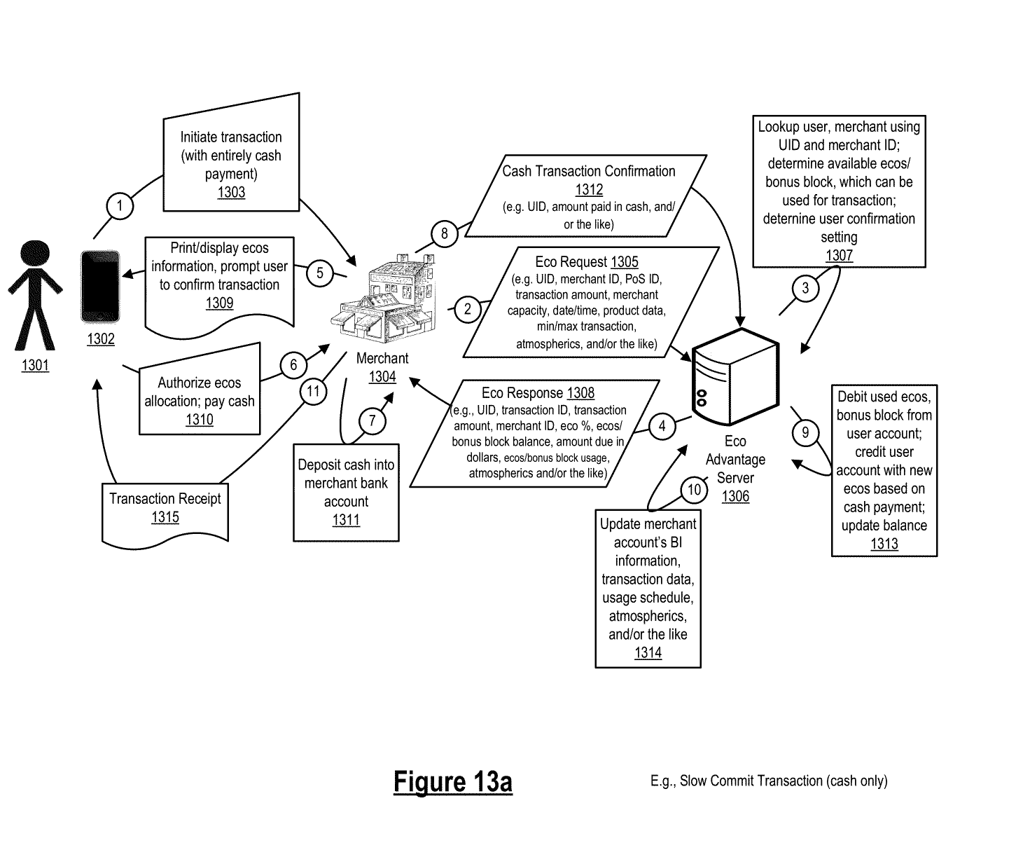

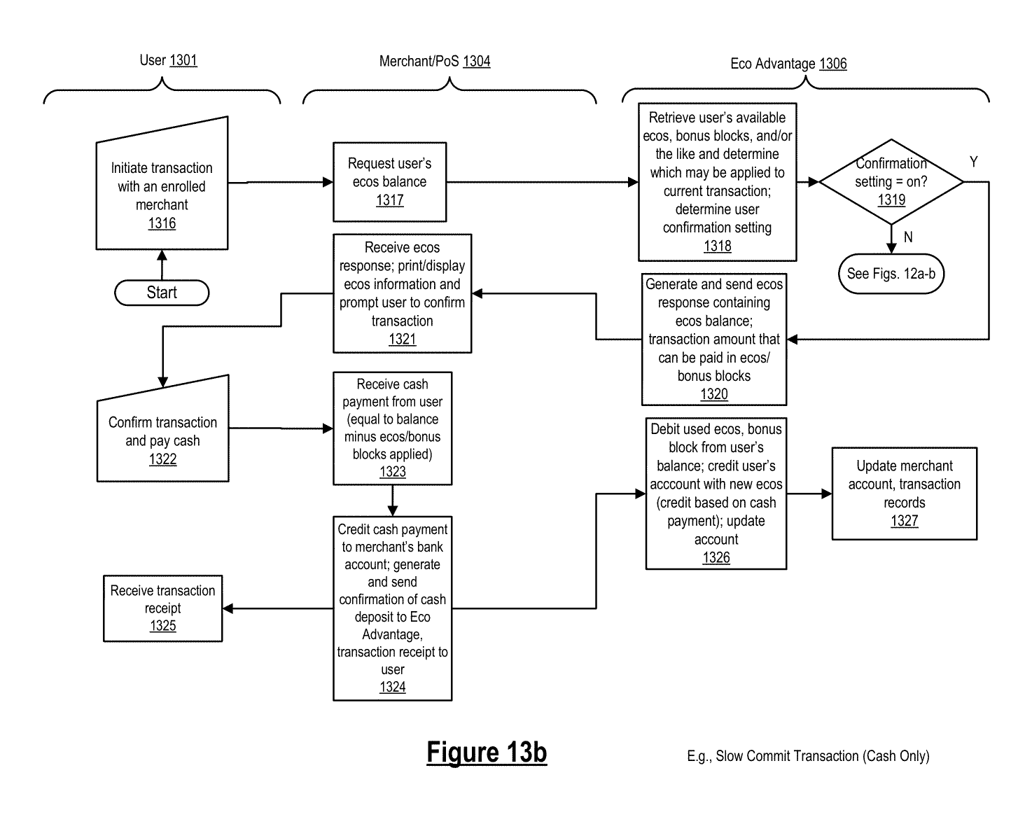

FIG. 13a shows a data flow diagram illustrating slow commit, cash only transactions in example embodiments of the ECO ADVANTAGE. In some implementations, a user 1301 may send a transaction initiation request 1303 to the merchant 1304 using the merchant's PoS device and/or a user electronic device 1302. In some implementations, sensitive information (e.g. the user PIN and/or the like) may be encrypted. In some implementations, the merchant may send an eco request 1305 to the ECO ADVANTAGE 1206. In some implementations, eco request 1305 may take a form similar to eco request 206.

ECO ADVANTAGE may look up the user's and merchant's records using the user ID (UID) and the merchant ID 1307, respectively, and may determine which and how many ecos and bonus blocks the user may apply to his transaction (e.g. based on the merchant's eco schedule, the user's eco and bonus block balances, and/or the like), and may determine the state of a user confirmation setting. If the confirmation setting is set to “true,” ECO ADVANTAGE may require the user to confirm his transaction before initiating any portion of it. In some implementations ECO ADVANTAGE may send an eco response 1308 back to the merchant, which may take a form similar to eco response 1210. In some implementations, the merchant may display and/or print 1309 the ecos information for the user, who may review the information 1310 and confirm the transaction (e.g. using a password, user PIN, and/or the like), including the ecos and/or bonus blocks to be used in the transaction. The user may also choose to pay the entirety of the transaction with cash. In some implementations, the cash payment may also be a check, gift coupon, pre-paid gift voucher, community scrip, electronic fund transfer, a money card, money order, bank transfer, bank payment slip, and/or a like payment method. In some implementations, confirmation can also be represented via a successful cash payment. In such cases, the merchant may deposit the cash 1311 into its bank account, and may send a cash transaction confirmation message 1312 to ECO ADVANTAGE indicating that the user has already paid the transaction balance in cash. ECO ADVANTAGE may debit 1313 the ecos and/or bonus blocks being used towards the transaction from the user account, may credit the user account with a predetermined amount of ecos based on the cash payment, and may update the user's balances.

ECO ADVANTAGE may also update the merchant account record 1314, including updating BI information, transaction data, the merchant's usage schedule, atmospherics, and/or the like. In some implementations, the merchant may generate and send a transaction receipt 1315 to the user, which may contain information similar to transaction receipt 1211.

FIG. 13b shows a logic flow diagram illustrating slow commit, cash only transactions in example embodiments of the ECO ADVANTAGE. In some implementations, a user may initiate 1316 a transaction with an enrolled merchant, via providing transaction input to a merchant. The merchant may receive the user input and transaction information 1317, and may generate and send a request to ECO ADVANTAGE for the user's eco and/or bonus block balances. In some implementations, ECO ADVANTAGE may receive the request for the user's eco and bonus block balance, and may retrieve from the ECO ADVANTAGE database 1318 the user's available ecos, bonus blocks, and/or the like to determine which and how many ecos and bonus blocks may be applied to the current transaction, as well as to determine the user's confirmation setting. If the confirmation setting is off 1319, ECO ADVANTAGE may generate and send 1320 a response to the merchant indicating the user's eco and/or bonus block balances and/or like transaction information. The merchant may receive the balance information 1321 and forward the information to the user via displaying and/or printing the ecos information for the user and asking the user to confirm the transaction. The user may confirm 1322 the transaction and the use of his ecos and/or bonus blocks towards the purchase using his password, user PIN, and/or a like form of identification, and may pay the transaction balance in cash.

In some implementations, the merchant may receive the cash payment from the user 1323, which may be equal to the transaction balance after the user's ecos and/or bonus blocks have been applied. The merchant may credit 1324 the cash payment to its account via depositing the cash payment in the merchant's bank account, and may generate and send a confirmation of the cash deposit to ECO ADVANTAGE and a transaction receipt to the user. In some implementations, the user may receive the transaction receipt, and ECO ADVANTAGE may debit the used ecos and/or bonus blocks from the user's balances 1326 and may credit the user's account with a predetermined amount of new ecos based on the cash payment and may update the account. ECO ADVANTAGE may also update the merchant account 1327 using the information from 1314 and/or like information and ECO ADVANTAGE's transaction records in order to update the merchant and transaction data stored in the ECO ADVANTAGE database.

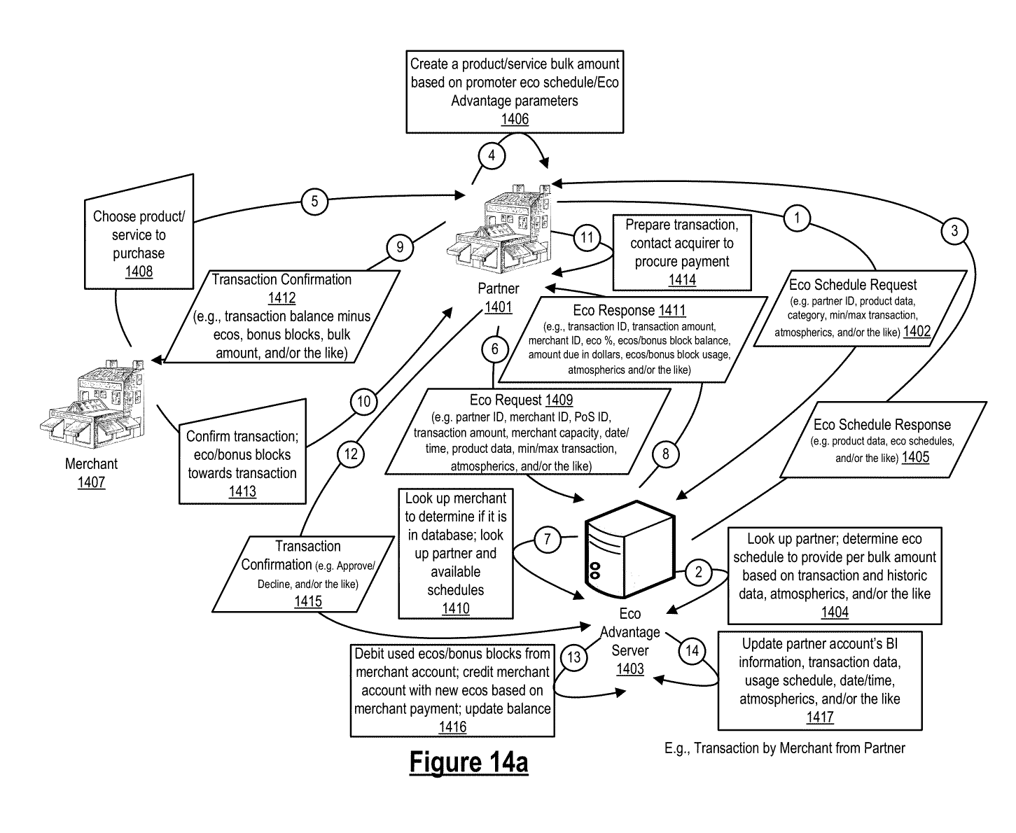

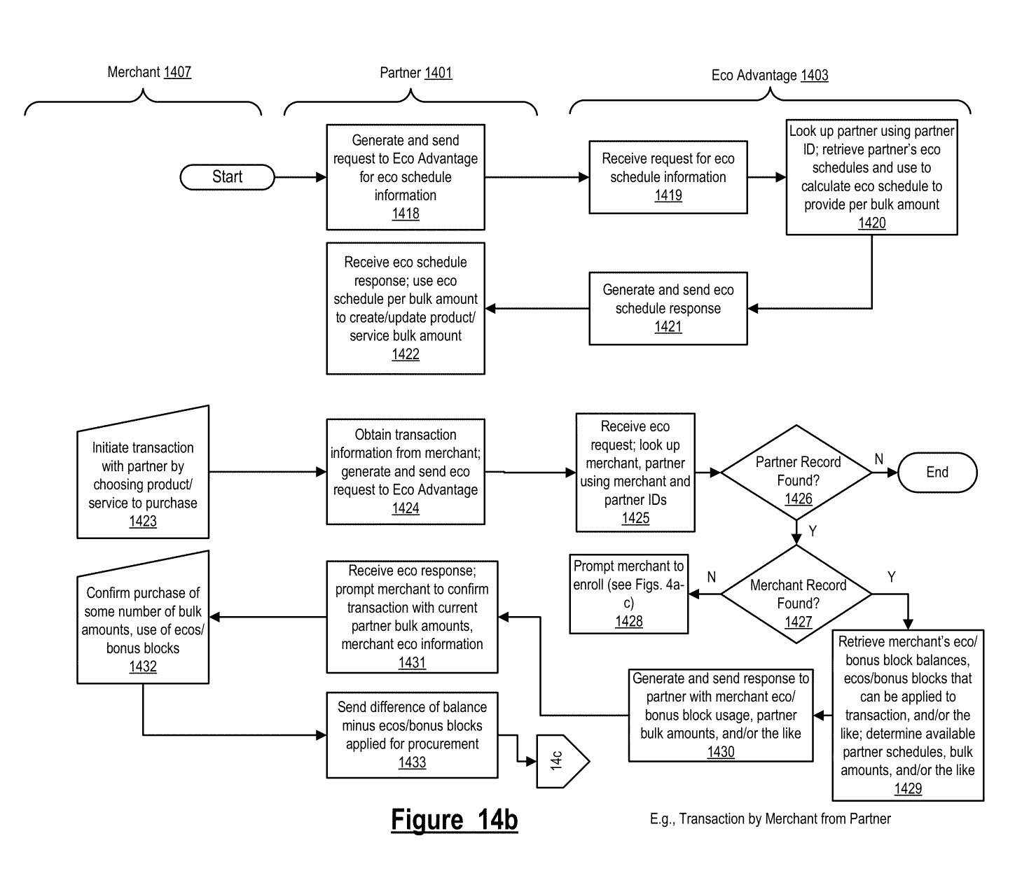

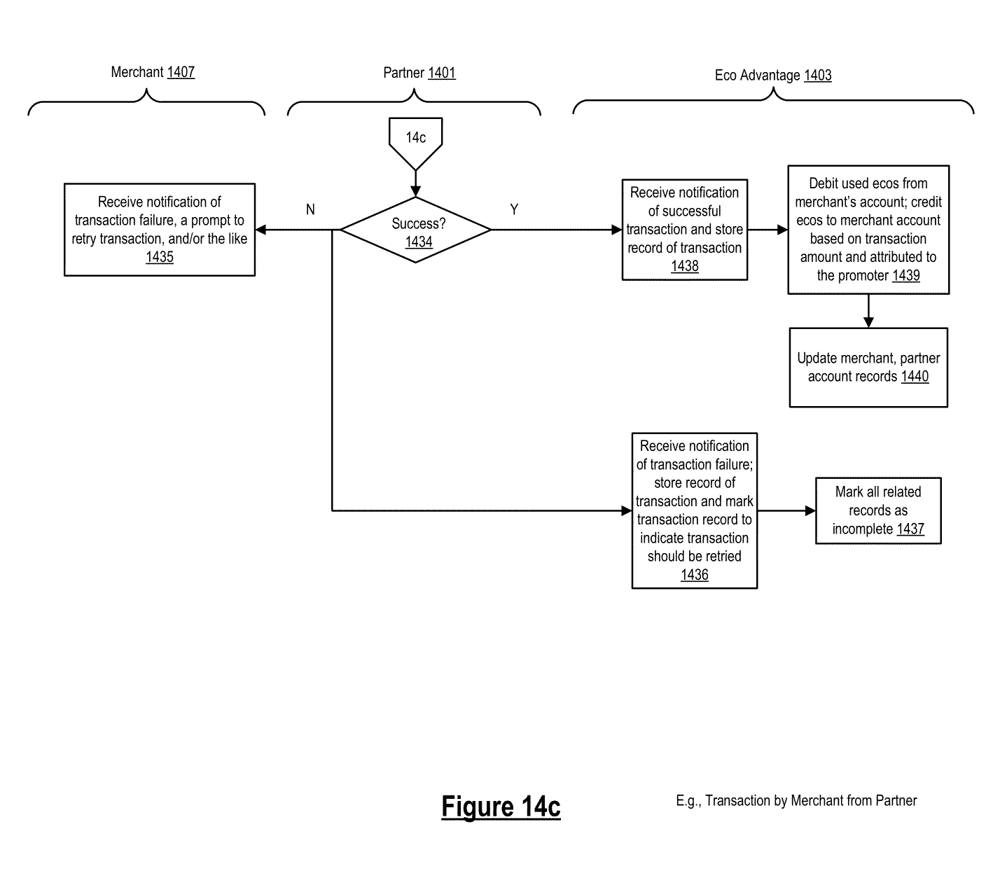

FIG. 14a shows a data flow diagram illustrating merchant and partner transactions in example embodiments of the ECO ADVANTAGE. In some implementations, a partner 1401 may enroll in ECO ADVANTAGE via a process similar to merchants (see FIGS. 4a-c). In some implementations partners may be retail merchants, manufacturers, wholesalers, large distributors, and/or the like In some implementations the partner may wish to determine a bulk amount of its products and/or services, and may send an eco schedule request 1402 to ECO ADVANTAGE 1403. In some implementations, the eco schedule request 1402 may take a form similar to the following:

POST / eco_schedule_request.php HTTP/1.1
Host: www.ECOADVANTAGEprocess.com
Content-Type: Application/XML
Content-Length: 788
<?XML version = “1.0” encoding = “UTF-8”?>
<ecoScheduleRequest>

<partnerId>154</partnerId>
<deviceId>579524552</deviceId>
<userId>102557952</userId>
<userAuth>da6c5cdf4e90b2961873f7b2e863415</userAuth>
<origDocNumber></origDocNumber>
<nsu>572052</nsu>
<mcc>6432</mcc>
<transactionAmount>100.0</transactionAmount>
<minTransactionSize>100</minTransactionSize>
<maxTransactionSize>5000</maxTransactionSize>
<transactionSize>1</transactionSize>
<productData>

<sku>56673858</sku>
<sku>56673953</sku><description>television</description>
<sku>56685901</sku>

</productData>
<dateTime>03/07/2013 03:39 PM</dateTime>

</ecoScheduleRequest>

In some implementations, ECO ADVANTAGE may look up the partner in the ECO ADVANTAGE database using the partner's ID 1404, and may retrieve the partner's eco schedule for bulk amounts. In some implementations the eco schedule may be based on transaction and historic data, atmospherics, and/or the like. ECO ADVANTAGE may send an eco schedule response 1405 to the partner containing eco schedules and/or the like. In some implementations the eco schedule response 1405 may take a form similar to the following:

POST /eco_schedule_response.php HTTP/1.1
Host: www.ECOADVANTAGEprocess.com
Content-Type: Application/XML
Content-Length: 788
<?XML version = “1.0” encoding = “UTF-8”?>
<ecoScheduleResponse>

<UID>da6c5cdf4e90b2961873f7b2e863415</UID>
<transactionId>635467</transactionId>
<partnerId>154</partnerId>
<ecoScheduleList>

<ecoUsage>

<sku>56673858</sku>
<quantity>100</quantity>
<percentage>15</percentage>

</ecoUsage>
<ecoUsage>

<sku>56673953</sku>
<description>television</description>
<quantity>500</quantity>
<percentage>20</percentage>

</ecoUsage>
<ecoUsage>

<sku>56685901</sku>
<quantity>1000</quantity>
<percentage>30</percentage>

</ecoUsage>

</ecoScheduleList>

<startDateTime>03/03/2013 00:00 AM</startDateTime>
<endDateTime>04/04/2013 23:59 PM</endDateTime>
<dateTime>02/02/2013 03:39 PM</dateTime>

</ecoScheduleResponse>

The partner may use the information in the response to create a product/service bulk amount 1406 based on the promoter's eco schedule and/or other ECO ADVANTAGE parameters.

In some implementations partners may also receive from ECO ADVANTAGE an allotment of ecos, bonus blocks, and/or the like that they may provide to employees and/or the like as part of an incentive program (e.g. as bonuses, rewards, and/or the like). In some implementations partners may open credit lines for employees, wherein the credit line may be equal to an amount of ecos given to employees/10. In some implementations another ECO ADVANTAGE partner may buy from them some percentage of that amount (e.g. four times the amount and/or the like) in products and/or services, with SRP. In some implementations consumers may also be able to pay parts of transactions with partners with ecos.

In other implementations, the partner may also have access to a B2B Marketplace interface (e.g. a website, application, and/or the like) which may allow the partner to launch new products, and/or provide like information.

In some implementations ECO ADVANTAGE may provide a merchant with an allotment of ecos, bonus blocks, and/or the like to be used with participating partners. In some implementations the merchant may receive such allotments once (e.g. after meeting a milestone, e.g. providing a predetermined amount of ecos to its consumers and/or the like, after enrolling, and/or the like), or more than once over a period of time (e.g. weekly, monthly, annually, and/or the like, at some interval if the merchant meets predefined ECO ADVANTAGE criteria, and/or the like). In some implementations, a merchant 1407 may use the allotment of ecos to purchase a product and/or service from the partner, via choosing 1408 a product and/or service available for purchase from the partner. The partner may send an eco request 1409 to ECO ADVANTAGE in order to get the merchant's eco balance, updated partner eco schedules, and/or the like. in some implementations eco request 1409 may take a form similar to the following:

POST /eco_request.php HTTP/1.1
Host: www.ECOADVANTAGEprocess.com
Content-Type: Application/XML
Content-Length: 788
<?XML version = “1.0” encoding = “UTF-8”?>
<ecoRequest>

<partnerId>154</partnerId>
<merchantId>2033</merchantId>
<transactionAmount>100.0</transactionAmount>
<productData>

<sku>56673953</sku>

</productData>
<dateTime>03/07/2013 03:39 PM</dateTime>

</ecoRequest>

ECO ADVANTAGE may look up 1410 the merchant to ensure it has an account in the ECO ADVANTAGE database, and to look up the partner for its available schedules and/or the like. In some implementations Grails code for looking up the merchant and partner may take a form similar to the following:

def partner = Partner.get(params.partnerId);

if (!partner) {

log.warn(“Partner not found with value ‘${params.partnerId}’”);
return sendError(‘exception.partner.not.found’);

}elseif (!partner.enabled || !partner.confirmed) {

log.warn(“Partner inactive with value ‘${params.partnerId}’”);
return sendError(‘exception.partner.inactive’);

} elseif (partner.accountLocked) {

log.warn(“Partner account locked with value

‘${params.partnerId}’”);

return sendError(‘exception.partner.locked’);

}
def schedule = partner.getSchedules( )
def merchant = Merchant.get(params.merchantId);
if (!merchant) {

log.warn(“Merchant not found with value
‘${params.merchant}’”);
return sendError(‘exception.merchant.not.found’);

} elseif (!merchant.enabled || !merchant.confirmed) {

log.warn(“Merchant inactive with value
‘${params.merchant}’”);
return sendError(‘exception.merchant.inactive’);

} elseif (merchant.accountLocked) {

log.warn(“Merchant account locked with value

‘${params.merchant}’”);

return sendError(‘exception.merchant.locked’);

}
def productData = merchant.getProductData( )
def balanceForPartner = getBalanceForPartner(transaction.merchant.

transaction.partner)

def amountOfEcos = calculateValueToPayWithEco(transaction,

schedule, productData, balanceForPartner)

ECO ADVANTAGE may send an eco response 1411 to the partner with the requested information. In some implementations, eco response 1411 may take a form similar to the following:

POST /eco_response.php HTTP/1.1
Host: www.ECOADVANTAGEprocess.com
Content-Type: Application/XML
Content-Length: 788
<?XML version = “1.0” encoding = “UTF-8”?>
<ecoResponse>

<partnerId>154</partnerId>
<merchantId>2033</merchantId>
<transactionId>635467</transactionId>
<transactionAmount>100.0</transactionAmount>
<ecoSaving>20%</ecoSaving>
<ecoBalance>1091</ecoBalance>
<amountDueInDollars>77.0</amountDueInDollars>
<ecoUsage>23</ecoUsage>
<dateTime>03/07/2013 03:39 PM</dateTime>

<ecoResponse>

The partner may send a transaction confirmation message 1412 to the merchant indicating the transaction balance and/or like transaction information, and prompting the merchant to confirm the transaction. In some implementations, the transaction confirmation message 1412 may take a form similar to the following:

POST /transaction_confirmation.php HTTP/1.1
Host: www.ECOADVANTAGEprocess.com
Content-Type: Application/XML
Content-Length: 788
<?XML version = “1.0” encoding = “UTF-8”?>
<transactionConfirmation>

<partnerId>154</partnerId>
<merchantId>2033</merchantId>
<transactionId>635467</transactionId>
<status>Approved</status>
<dateTime>03/07/2013 03:39 PM</dateTime>

</transactionConfirmation>

The merchant may confirm 1413 the transaction and the use of ecos towards the transaction, and the partner may prepare the transaction data 1414 to be sent to the partner's acquirer and/or a like payment entity for payment procurement. In some implementations, the partner may receive a transaction confirmation from the acquirer indicating whether or not the transaction was successful or not, and may forward this transaction confirmation via a message 1415 to ECO ADVANTAGE. In some implementations, ECO ADVANTAGE may, upon receiving a confirmation that the transaction was successful, debit the ecos used for the transaction from the merchant's account 1416, may credit the merchant's account with a new predetermined amount of ecos (the amount based at least partially on the amount the merchant pays for the transaction), and may update the merchant's balance. IN some implementations, updating the merchant's balance may take a form similar to the following:

Transaction transaction = Transaction.get(transactionId)
Merchant merchant = transaction.getMerchant( )
Partner partner = transaction.getPartner( )
long ecoUsage = transaction.getEcoUsage( )
long bonusBlockUsage = transaction.getBonusBlockUsage( )
long amountDueInDollars = transaction.getAmountDueInDollars( )
Try {

beginTransaction( )
merchant.debitEco(ecoUsage)
user.debitBonusBlock(bonusBlockUsage)
merchant.creditEco(amountDueInDollars, partner)
commitTransaction( );

} catch (Exception) {

rollbackTransaction( );
return false;

}

ECO ADVANTAGE may also update the partner's account record and transaction records, including creating a transaction record, updating the partner's BI information, transaction data, usage schedules using the transaction's date, time and atmospherics, and/or the like. In some implementations, Grails code for updating partner data may take a form similar to the following:

Transaction transaction = Transaction.get(transactionId)
Partner partner = transaction.getPartner( )
Merchant merchant = transaction.getMerchant( )
long ecoUsage = transaction.getEcoUsage( )
long bonusBlockUsage = transaction.getBonusBlockUsage( )
def historyTransaction = new HistoryTransaction(transaction, partner,
merchant, ecoUsage, bonusBlockUsage)
historyTransaction.save( )

FIGS. 14b-c show logic flow diagrams illustrating merchant and partner transactions in example embodiments of the ECO ADVANTAGE. In some implementations, before a transaction, a partner may generate and send 1418 a request to ECO ADVANTAGE for its eco schedule information. ECO ADVANTAGE may receive the request for the partner's eco schedules, and may look up the partner's record using the partner ID included in the request. ECO ADVANTAGE may retrieve the partner's eco schedules and/or like partner information and use them to calculate the eco schedule to provide per bulk amount of the partner's products and/or services. ECO ADVANTAGE may generate and send 1421 a schedule response to the partner, who may receive the eco schedule response 1422 and may use the eco schedule per bulk amount received to create and/or update product and service bulk amounts.

In some implementations, a merchant may, at some point, initiate a transaction 1423 with a partner via choosing products and/or services to purchase. The partner may obtain 1424 the transaction information from the merchant, and may generate and send an eco request to ECO ADVANTAGE. ECO ADVANTAGE may receive the eco request 1425 from the partner and may look up the partner and the merchant using the partner and merchant IDs, respectively. If a partner record is not found, ECO ADVANTAGE may prompt the partner to enroll in ECO ADVANTAGE. If a partner record is found 1426, ECO ADVANTAGE may determine if a record for the merchant can be found. If the merchant record 1427 is not found, ECO ADVANTAGE may prompt the merchant to enroll in ECO ADVANTAGE (see FIGS. 4a-c for further detail). If the merchant's record can be found, ECO ADVANTAGE may retrieve 1429 the merchant's eco balance, and may use it to determine the number of ecos that can be applied to the transaction amount. ECO ADVANTAGE may also retrieve the partner's eco schedules, bulk amounts, and/or the like, and may send the partner and merchant data to the partner via an eco response 1430 to the merchant. The merchant may receive the eco response from ECO ADVANTAGE and may prompt the merchant to confirm the transaction given the merchant's eco information and the partner's current bulk amounts. Once the merchant has confirmed 1432 the transaction and the use of ecos, the partner may send 1433 the transaction balance (e.g. the transaction amount minus the ecos applied) to an acquirer for procurement.

In some implementations, if the acquirer notifies the partner 1434 that the procurement was a success, ECO ADVANTAGE may receive a notification indicating a successful transaction 1438, and may create and store a record of the transaction in the ECO ADVANTAGE database. ECO ADVANTAGE may debit 1439 the ecos used in the transaction from the merchant's account, and may credit the merchant's account with a predetermined amount of ecos based on the transaction amount and marked as being from the promoter. ECO ADVANTAGE may also update the merchant and partner's account records 1440 using the transaction information and/or like information in 1417, and/or like information.

In some implementations, if the procurement was not successful 1434, the merchant may receive a notification of transaction failure 1435, may be prompted to retry the transaction and/or the like. The partner may also forward the notification to ECO ADVANTAGE, which may receive the notice and store a transaction record for the transaction 1436. In some implementations the record may be marked as incomplete so that ECO ADVANTAGE may retry the transaction at a later time. In some implementations ECO ADVANTAGE may also mark 1437 related records (e.g. merchant and partner records, and/or the like) as being incomplete as a result of the failed transaction.

FIG. 15a show a data flow diagram illustrating refunding or cancelling transactions in example embodiments of the ECO ADVANTAGE. In some implementations, a user 1501 may indicate to a merchant 1503 that he may wish to cancel and/or obtain a refund for a transaction 1502, and may provide transaction information (e.g. transaction and/or order ID, the user's ID, and/or the like) to the merchant. In some implementations, sensitive information (e.g. the user PIN and/or the like) may be encrypted. The merchant may send a cancellation request 1504 to ECO ADVANTAGE 1505, including the provided transaction information. In some implementations, the cancellation request 1504 may take a forms similar to the following:

POST /cancellation_request.php HTTP/1.1
Host: www.ECOADVANTAGEprocess.com
Content-Type: Application/XML
Content-Length: 788
<?XML version = “1.0” encoding = “UTF-8”?>
<cancellationRequest>

<UID>da6c5cdf4e90b2961873f7b2e863415</UID>
<merchantId>2033</merchantId>
<posId>4088</posId>
<mcc>6432</mcc>
<transactionId>635467</transactionId>
<transactionDate>03/06/2013</transactionDate>
<transactionProcessingCode></transactionProcessingCode>
<transactionDocNumber></transactionDocNumber>
<transactionNsu></transactionNsu>
<dateTime>03/07/2013 01:39 PM</dateTime>

</cancellationRequest>

In some implementations, ECO ADVANTAGE may use the transaction ID and/or other provided data 1506 in order to locate the transaction record in the ECO ADVANTAGE database. In some implementations Grails code for locating the transaction may take a form similar to the following:

def transaction = Transaction.get(params.transactionId)

if(!transaction) {

log.warn(“Transaction not found with value

‘${params.transactionId}’.”)

return sendError(‘exception.transaction.not.found’);

} elseif (!transaction.isCancellable( )) {

log.warn(“Transaction ‘${params.transactionId}’ cannot be

cancelled.”)

return sendError(‘exception.transaction.not.cancellable’);

}

ECO ADVANTAGE may determine the amount that the user paid in the transaction, the number of ecos credited to the user during the transaction, the number of ecos and/or bonus blocks the user spent towards the transaction, and/or the like 1507. In some implementations, Grails code for determining the transaction data may take a form similar to the following:

def amountDueInDollars=transaction.amountDueInDollars
def newEcos=transaction.newEcos
def usedEcos=transacton.usedEcos
def usedBonusBlocks=transacton.usedBonusBlocks

ECO ADVANTAGE may use the information to determine the amount to refund the user, how the user's ecos and or bonus block balances should be updated, and/or the like, and may send this information to the merchant via a cancellation response 1508. In some implementations the cancellation response 1508 may take a form similar to the following:

POST /cancellation_response.php HTTP/1.1
Host: www.ECOADVANTAGEprocess.com
Content-Type: Application/XML
Content-Length: 788
<?XML version = “1.0” encoding = “UTF-8”?>
<cancellationResponse>

<UID>da6c5cdf4e90b2961873f7b2e863415</UID>
<transactionId>635467</transactionId>
<AmountToRefundUser>${amountDueInDollars}</AmountToRefundUser>
<EcosToRefundUser>${usedEcos}</EcosToRefundUser>
<BonusBlocksToRefundUser>${usedBonusBlocks}</BonusBlocksToRefundUser>

</cancellationResponse>

The merchant may print and/or display 1509 the amount of ecos to be refunded, the amount of real currency to be refunded, the amount of ecos to be rescinded from the user's account, and/or like information, and may prompt the user to confirm the transaction. The user may authenticate and/or confirm the refund and/or cancellation transaction 1510, and the merchant may send a refund request 1511 to its acquirer 1512 and/or a like entity in order to process the transaction. In some implementations, refund request 1511 may take a form similar to the following:

POST /refund_request.php HTTP/1.1
Host: www.ECOADVANTAGEprocess.com
Content-Type: Application/XML
Content-Length: 788
<?XML version = “1.0” encoding = “UTF-8”?>
<refundRequest>

<UID>da6c5cdf4e90b2961873f7b2e863415</UID>
<transactionId>635467</transactionId>
<merchantId>2033</merchantId>
<posId>4065</posId>
<amountToBeRefunded>77.0</amountToBeRefunded>
<dateTime>03/07/2013 01:39 PM</dateTime>

</refundRequest>

The acquirer and/or like entity may authenticate the request 1513 and may cancel the previous transaction and/or perform like tasks in order to process the cancellation of the previous transaction. In some implementations the acquirer may send a refund response 1514 indicating whether or not the refund transaction was successful or not, and/or the like to the merchant, who may forward the refund response to ECO ADVANTAGE 1515. In some implementations refund response 1514, 1515, and 1516 may take a form similar to the following:

POST /refund_request.php HTTP/1.1
Host: www.ECOADVANTAGEprocess.com
Content-Type: Application/XML
Content-Length: 788
<?XML version = “1.0” encoding = “UTF-8”?>
<refundResponse>

<UID>da6c5cdf4e90b2961873f7b2e863415</UID>
<transactionId>635467</transactionId>
<merchantId>2033</merchantId>
<posId>4065</posId>
<AmountToBeRefunded>77.0</AmountToBeRefunded>
<dateTime>03/07/2013 01:39 PM</dateTime>
<approved>true</approved>

</refundResponse>

In some implementations the acquirer may also send a refund response 1516 to ECO ADVANTAGE. In some implementations ECO ADVANTAGE may recredit the user's account with the ecos and/or bonus blocks used in the cancelled transaction, may rescind the ecos credited to the user in the cancelled transaction and/or the like 1517, and may update the user's balances and mark the related transaction record and/or other related records as being cancelled or refunded. In some implementations Grails code for updating the user's balances may take a form similar to the following:

Transaction transaction = Transaction.get(transactionId)
User user = transaction.getUser( )
Try {

beginTransaction( )
user.creditEco(transaction.usedEcos)
user.creditBonusBlocks(transaction.usedBonusBlocks)
user.debitEco(transaction.newEcos)
transaction.refunded = true;
transaction.save( )
commitTransaction( );

} catch (Exception) {

rollbackTransaction( );
return false;

}

The merchant may also send a transaction receipt 1518 to the user, which may take a form similar to transaction receipt 1315.

FIG. 15b shows a logic flow diagram illustrating refunding or cancelling transactions in example embodiments of the ECO ADVANTAGE. In some implementations, a user may indicate to a merchant a desire to cancel and/or refund a transaction 1519. The merchant may obtain the request for a refund 1520 and may generate and send a request for the transaction's information to ECO ADVANTAGE, using the transaction ID and/or other data provided by the user. ECO ADVANTAGE may receive 1521 the request for information about the transaction and may use the transaction ID and/or like information 1522 in order to locate the proper transaction record in the ECO ADVANTAGE. ECO ADVANTAGE may determine from the transaction record 1522 the amount charged to the user, the amount of ecos and/or bonus blocks the user spent in the transaction, the amount of ecos the user gained from the transaction, and/or the like. ECO ADVANTAGE may then generate and send a response 1524 to the merchant with the information determined from the transaction record.

The merchant, upon receiving the response 1525, may print and/or display the information received for the user to review, and may prompt the user to confirm the refund and/or transaction cancellation. If the user authenticates and/or otherwise confirms 1526 the transaction based on the displayed information, the merchant may send a message 1527 to an acquirer and/or like payment entity in order to have the refund transaction processed. In some implementations, the acquirer may receive 1528 the refund request, may authenticate 1529 the request, and may cancel 1530 the original payment transaction.

If the cancellation is successful 1531, the acquirer may send a notification 1532 to the merchant indicating success in processing the refund. The merchant may receive the notification 1533, may forward the confirmation to ECO ADVANTAGE, and the user may receive from the merchant a transaction receipt 1534 indicating the refund confirmation and/or further transaction details. In some implementations, ECO ADVANTAGE may receive the transaction message, and may save the confirmation as a transaction record in the ECO ADVANTAGE database 1535 for future reference. In some implementations, ECO ADVANTAGE may also re-credit the user's account with the ecos and/or bonus blocks used in the cancelled transaction 1526, may rescind any ecos given to the user in the original transaction, and may update the user's balances. ECO ADVANTAGE may also mark all related records 1537 (e.g. transaction records and/or the like) as being refunded.

If the cancellation is not successful 1531, the acquirer may send a notification of transaction failure 1538 to the merchant, who may receive 1539 the notification, and forward it to ECO ADVANTAGE. The user may also receive from the merchant 1540 a notification that the refund transaction failed and that the user may retry the refund transaction at a later date. ECO ADVANTAGE may receive the refund failure notification 1541 and may mark the refund transaction record in the ECO ADVANTAGE database in order to indicate that the transaction should be re-tried at a later time. ECO ADVANTAGE may also mark all related records (e.g. transaction records and/or the like) as being incomplete 1542.

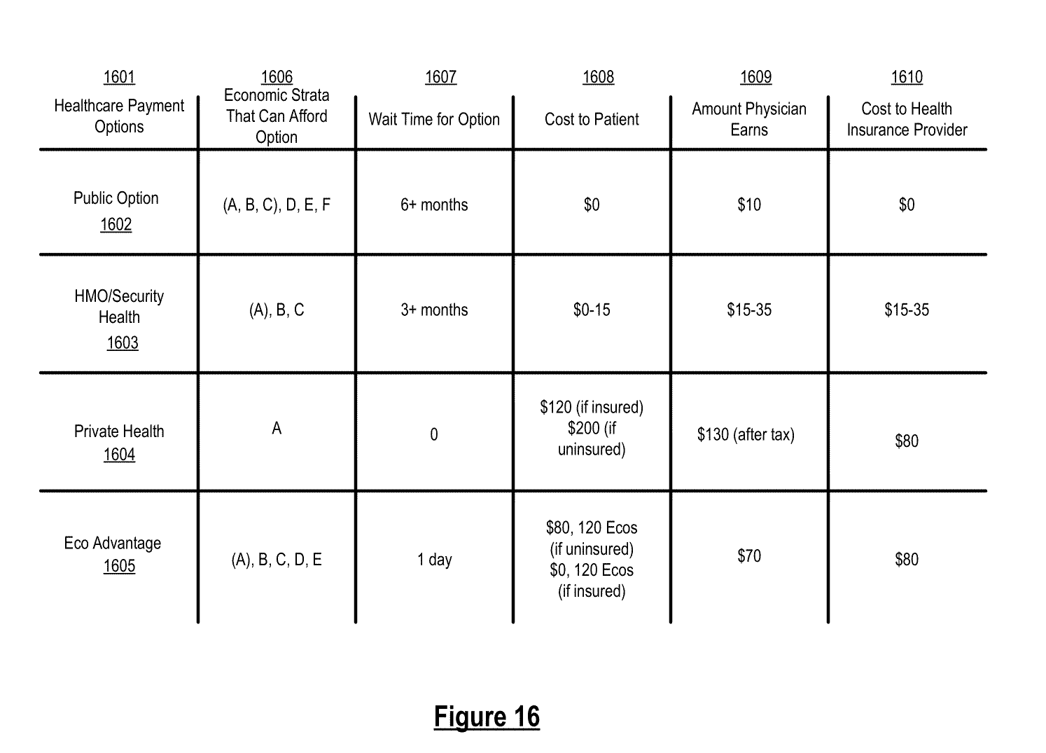

FIG. 16 shows a table diagram illustrating using ECO ADVANTAGE for health insurance in example embodiments of the ECO ADVANTAGE. In some implementations ECO ADVANTAGE may used to reduce a user's cost and/or wait time for various healthcare payment options 1601. In some implementations, for example, a user may be able to use a Public Option 1602, which may be affordable by all economic strata 1606, as the cost to the patient 1608 may be $0, but may require a wait time for appointments 1607 of six or more months, may only allow a physician to earn 1609 $10 per visit, and may cost $0 to a health insurance provider 1610.

In some implementations, if a user utilizes an HMO-like health insurance plan 1603, the user may only be able to afford the plan if the user fits into the top few (e.g. A, B, or C) economic strata, but the user may wait three or more months, may pay $0-15 per visit, which may result in $15-35 earnings per visit for a physician and a $15-35 cost to the health insurance provider.

In some implementations, a private 1604 health plan coupled with other health insurance may reduce the wait time considerably, but may cost the user $120 (or $200 if the user is uninsured, if, in some implementations, the user's insurance will refund up to $80 in doctor visit expenses), resulting in only the top (e.g. A) economic strata being able to afford the plan. Private health care plans, on the other hand, cost $80 to a health insurance provider if the user is insured, and provide $130 in earnings (post-tax) to a physician per visit.

In some implementations, a user enrolled in ECO ADVANTAGE 1605 may be able to reduce the cost of his health insurance considerably, while still allowing a physician to earn more per visit than would be possible if the user were only using a Public Option or HMO-like plan. In some implementations, the user may only need to wait a day (as opposed to the six or more months for the Public Option, or the three or more months for an HMO-like plan) for an appointment, and may pay only $80 per visit if uninsured (along with 120 ecos), and may pay only $0 and 120 ecos per visit if insured, and if the user's insurance will refund up to $80 in medical expenses. ECO ADVANTAGE may allow those in lower economic strata (e.g. B, C, D, E) to experience the benefits of private health plans, as they would not need to pay as much for the benefits. The physician may also earn $70 per visit with a patient using ECO ADVANTAGE, as opposed to $10 or $15-35 if the patients were to use the Public Option or the HMO and/or like plans (e.g. the only other options those economic strata would be able to afford). The cost to the health insurance provider also remains at $80, which would be the same cost if the patient were able to afford private health insurance.

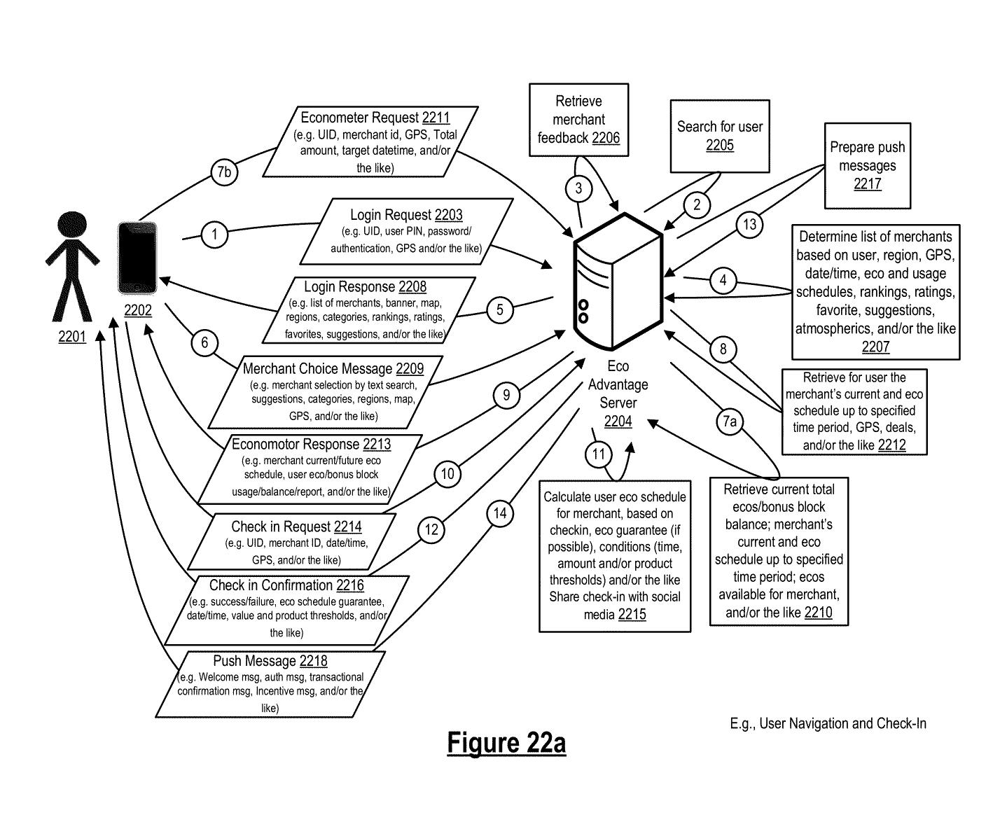

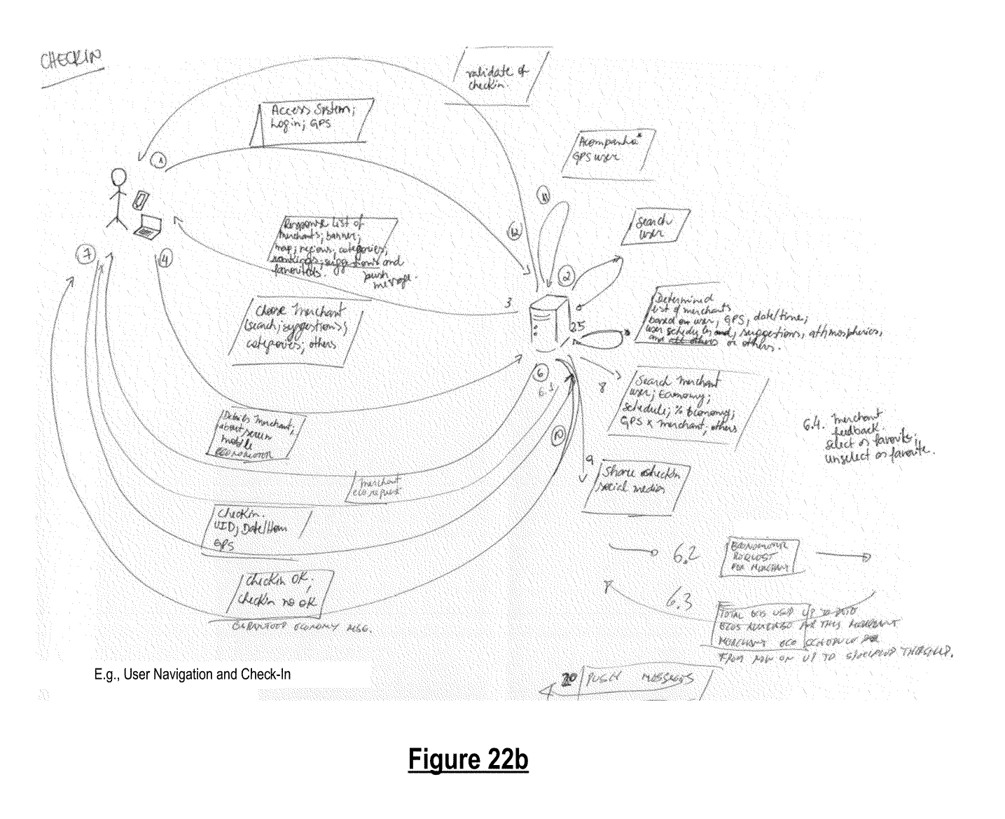

FIGS. 22a-b show block diagrams illustrating checking into ECO ADVANTAGE in some embodiments of an ECO ADVANTAGE. In some implementations a user 2201 may, on his electronic device 2201, wish to log in 2203 to ECO ADVANTAGE 2204, using his user credentials, GPS data, and/or the like. ECO ADVANTAGE may determine whether the user has an account in ECO ADVANTAGE 2205, and may determine 2207 a list of selected merchants to provide to the user to preliminary viewing based on the user's profile information, GPS data, the date and time of the login, user schedules, suggestions for the user based on merchant feedback 2206, atmospheric data, and/or the like. ECO ADVANTAGE may then send a login response 2208 to the user containing a list of merchants to view, a map of the user's preferred region(s), categories for the user to browse through, merchant rankings and suggestions, and/or the like. The user may look through the list of merchants (e.g. via a list view or via interacting with the map contained in the login response) and select at least one to obtain further information on via a merchant choice message 2209 to ECO ADVANTAGE. In some implementations ECO ADVANTAGE may retrieve eco statistics for the merchant 2210, such as the total number of ecos used from and/or at the merchant, the merchant's current eco schedule (and/or the schedule within a specified date range), and/or like information, and may also retrieve current deals 2211, the current eco %, the GPS data, and/or the like for the merchant. ECO ADVANTAGE may send the information to the user via an econometer response 2212. The user may then send a check-in request 2213 to ECO ADVANTAGE, which may include user identification information, the date and time of the check-in, the GPS coordinates of the user at the time of check-in, and/or like information. In some implementations ECO ADVANTAGE may share the user's check-in 2214 on social media websites (e.g. Facebook, Twitter, and/or the like), and/or may provide the user the opportunity to choose social networking websites to share the check-in data with. ECO ADVANTAGE may also send a check-in confirmation 2215 to the user to indicate whether or not the check-in was successful or not.

In some implementations, ECO ADVANTAGE may use a Telemetry component to pull information from current real-time transactions and historic data about users, merchants, transactions, ecos, bonus blocks, donation, eco calculations, and/or the like.

Using the BI and the analytics components in conjunction with the Telemetry component, ECO ADVANTAGE may process these types of data, and may produce individual and aggregated trend and skew per transaction data, user, merchant, eco schedule, usage schedule, region, category, grand-total entities data, and/or the like. ECO ADVANTAGE may also use these components to compare this trend and skew data with upper and lower thresholds, predicted plans, overall trends, and/or the like.

ECO ADVANTAGE may then use the Telemetry and/or other components to trigger immediate action mechanisms on various components and entities, including the Eco Schedule Calculation Component, Merchant Managers, Economic Promoters, Merchants, Eco and Usage Schedules, and/or the like, in order to keep delivering the defined commercial intelligence. It may also trigger short and long term actions and/or action mechanisms on those components, as well as the Region/Category Management Component. The Merchant Information Aggregation Component, and the Merchant and User Enrollment Components. ECO ADVANTAGE may also use the Telemetry and/or other components for calibration of thresholds.

In some implementations, an Econometer Component may allow ECO ADVANTAGE to integrate different dimensions of the ECO ADVANTAGE data into benefits, may keep them organized, and may distribute this data to all components and entities as needed.

In some implementations ECO ADVANTAGE may use the Econometer Component and/or other components to pull information from current real-time transactions and historic data about users, merchants, transactions, ecos, bonus blocks, donations, eco calculations, and/or the like. The ECO ADVANTAGE may also use the Econometer Component to distribute this data to all available devices and entities.

For example, in some implementations, ECO ADVANTAGE may use this component to facilitate communications between merchant and user entities via the user's mobile device, a website, SMS, Push msg, email, PoS, and/or like forms of communication. ECO ADVANTAGE may also use the component and/or other components as an Eco Calculator (e.g., for specific merchants, for specific entities as a whole, and/or the like). In some implementations ECO ADVANTAGE may also use the component to calculate current and/or near future merchant eco schedules, in numeric and figurative representations.

In some implementations ECO ADVANTAGE may use this component to facilitate communications from ECO ADVANTAGE to a user via his mobile device, a website, SMS, Push msg, email, PoS, and/or like forms of communication. ECO ADVANTAGE may also use the component to keep track of each user's total transaction usage, total ecos usage, total bonus block usage, total ecos donation, all by period or to date, show graphs, %, ecos and bonus blocks balances, and/or like values, and may allow ECO ADVANTAGE to generate and/or provide reports of all these types of data.

In some implementations ECO ADVANTAGE may use this component to facilitate communications from ECO ADVANTAGE to a merchant via a merchant's mobile device, a website, SMS, Push msg, email, PoS, and/or like forms of communication. ECO ADVANTAGE may also use the component and/or other components to calculate transaction usage, ecos usage, bonus block usage, aggregated and by period, show graphs, %, balances, and/or like values, and may use the component to generate and/or provide reports of all these types of data.

In some implementations ECO ADVANTAGE may also use the component to, via a mobile application, a website, and/or the like, provide the aggregated overall grand-total ecos usage (e.g., the total amount everybody already saved using the ECO ADVANTAGE SYSTEM to date), and/or like statistics to entities on ECO ADVANTAGE.

FIG. 22b demonstrates another exemplary implementations of checking into ECO ADVANTAGE and searching for merchants.

### ECO ADVANTAGE Controller

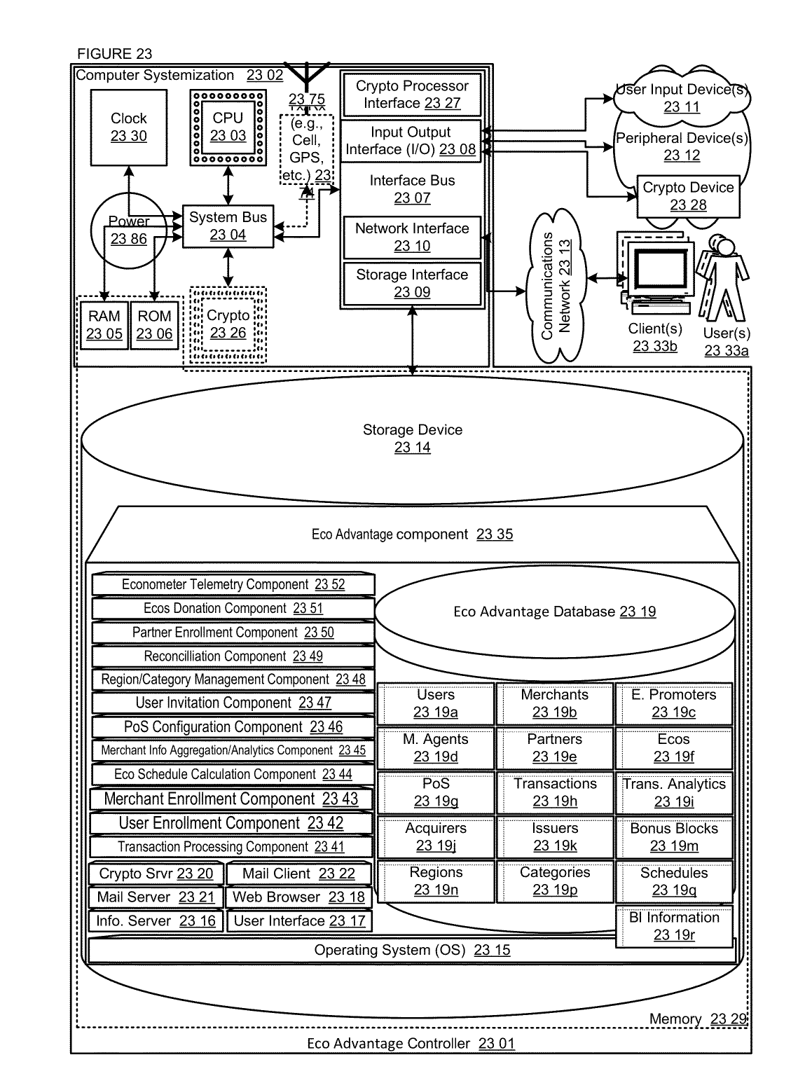

FIG. 23 shows a block diagram illustrating embodiments of a ECO ADVANTAGE controller. In this embodiment, the ECO ADVANTAGE controller 2301 may serve to aggregate, process, store, search, serve, identify, instruct, generate, match, and/or facilitate interactions with a computer through commerce and mutual benefit technologies, and/or other related data.

Typically, users, which may be people and/or other systems, may engage information technology systems (e.g., computers) to facilitate information processing. In turn, computers employ processors to process information; such processors 2303 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 2329 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the ECO ADVANTAGE controller 2301 may be connected to and/or communicate with entities such as, but not limited to: one or more users from user input devices 2311; peripheral devices 2312; an optional cryptographic processor device 2328; and/or a communications network 2313.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The ECO ADVANTAGE controller 2301 may be based on computer systems that may comprise, but are not limited to, components such as: a computer systemization 2302 connected to memory 2329.

### Computer Systemization

A computer systemization 2302 may comprise a clock 2330, central processing unit (“CPU(s)” and/or “processor(s)” (these terms are used interchangeable throughout the disclosure unless noted to the contrary)) 2303, a memory 2329 (e.g., a read only memory (ROM) 2306, a random access memory (RAM) 2305, etc.), and/or an interface bus 2307, and most frequently, although not necessarily, are all interconnected and/or communicating through a system bus 2304 on one or more (mother)board(s) 2302 having conductive and/or otherwise transportive circuit pathways through which instructions (e.g., binary encoded signals) may travel to effectuate communications, operations, storage, etc. The computer systemization may be connected to a power source 2386; e.g., optionally the power source may be internal. Optionally, a cryptographic processor 2326 and/or transceivers (e.g., ICs) 2374 may be connected to the system bus. In another embodiment, the cryptographic processor and/or transceivers may be connected as either internal and/or external peripheral devices via the interface bus I/O. In turn, the transceivers may be connected to antenna(s) 2375, thereby effectuating wireless transmission and reception of various communication and/or sensor protocols; for example the antenna(s) may connect to: a Texas Instruments WiLink WL1283 transceiver chip (e.g., providing 802.1in, Bluetooth 3.0, FM, global positioning system (GPS) (thereby allowing ECO ADVANTAGE controller to determine its location)); Broadcom BCM4329 FKUBG transceiver chip (e.g., providing 802.11n, Bluetooth 2.1+EDR, FM, etc.); a Broadcom BCM4750 IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 2329 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the ECO ADVANTAGE controller and beyond through various interfaces. Should processing requirements dictate a greater amount speed and/or capacity, distributed processors (e.g., Distributed ECO ADVANTAGE), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the ECO ADVANTAGE may be achieved by implementing a microcontroller such as CAST's R8051XC2 microcontroller; Intel's MCS 51 (i.e., 8051 microcontroller); and/or the like. Also, to implement certain features of the ECO ADVANTAGE, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the ECO ADVANTAGE component collection (distributed or otherwise) and/or features may be implemented via the microprocessor and/or via embedded components; e.g., via ASIC, coprocessor, DSP, FPGA, and/or the like. Alternately, some implementations of the ECO ADVANTAGE may be implemented with embedded components that are configured and used to achieve a variety of features or signal processing.

Depending on the particular implementation, the embedded components may include software solutions, hardware solutions, and/or some combination of both hardware/software solutions. For example, ECO ADVANTAGE features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the ECO ADVANTAGE features. A hierarchy of programmable interconnects allow logic blocks to be interconnected as needed by the ECO ADVANTAGE system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the ECO ADVANTAGE may be developed on regular FPGAs and then migrated into a fixed version that more resembles ASIC implementations. Alternate or coordinating implementations may migrate ECO ADVANTAGE controller features to a final ASIC instead of or in addition to FPGAs. Depending on the implementation all of the aforementioned embedded components and microprocessors may be considered the “CPU” and/or “processor” for the ECO ADVANTAGE.

### Power Source

The power source 2386 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 2386 is connected to at least one of the interconnected subsequent components of the ECO ADVANTAGE thereby providing an electric current to all subsequent components. In one example, the power source 2386 is connected to the system bus component 2304. In an alternative embodiment, an outside power source 2386 is provided through a connection across the I/O 2308 interface. For example, a USB and/or IEEE 1394 connection carries both data and power across the connection and is therefore a suitable source of power.

### Interface Adapters

Interface bus(ses) 2307 may accept, connect, and/or communicate to a number of interface adapters, conventionally although not necessarily in the form of adapter cards, such as but not limited to: input output interfaces (I/O) 2308, storage interfaces 2309, network interfaces 2310, and/or the like. Optionally, cryptographic processor interfaces 2327 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 2309 may accept, communicate, and/or connect to a number of storage devices such as, but not limited to: storage devices 2314, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 2310 may accept, communicate, and/or connect to a communications network 2313. Through a communications network 2313, the ECO ADVANTAGE controller is accessible through remote clients 2333b (e.g., computers with web browsers) by users 2333a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed ECO ADVANTAGE), architectures may similarly be employed to pool, load balance, and/or otherwise increase the communicative bandwidth required by the ECO ADVANTAGE controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 2310 may be used to engage with various communications network types 2313. For example, multiple network interfaces may be employed to allow for the communication over broadcast, multicast, and/or unicast networks.

Input Output interfaces (I/O) 2308 may accept, communicate, and/or connect to user input devices 2311, peripheral devices 2312, cryptographic processor devices 2328, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x, Bluetooth, cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 2311 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 2312 may be connected and/or communicate to I/O and/or other facilities of the like such as network interfaces, storage interfaces, directly to the interface bus, system bus, the CPU, and/or the like. Peripheral devices may be external, internal and/or part of the ECO ADVANTAGE controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers 12 (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the ECO ADVANTAGE controller may be embodied as an embedded, dedicated, and/or monitor-less (i.e., headless) device, wherein access would be provided over a network interface connection.

Cryptographic units such as, but not limited to, microcontrollers, processors 2326, interfaces 2327, and/or devices 2328 may be attached, and/or communicate with the ECO ADVANTAGE controller. A MC68HC16 microcontroller, manufactured by Motorola Inc., may be used for and/or within cryptographic units. The MC68HC16 microcontroller utilizes a 16-bit multiply-and-accumulate instruction in the MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 2329. However, memory is a fungible technology and resource, thus, any number of memory embodiments may be employed in lieu of or in concert with one another. It is to be understood that the ECO ADVANTAGE controller and/or a computer systemization may employ various forms of memory 2329. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 2329 will include ROM 2306, RAM 2305, and a storage device 2314. A storage device 2314 may be any conventional computer system storage. Storage devices may include a drum; a (fixed and/or removable) magnetic disk drive; a magneto-optical drive; an optical drive (i.e., Bluray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 2329 may contain a collection of program and/or database components and/or data such as, but not limited to: operating system component(s) 2315 (operating system); information server component(s) 2316 (information server); user interface component(s) 2317 (user interface); Web browser component(s) 2318 (Web browser); database(s) 2319; mail server component(s) 2321; mail client component(s) 2322; cryptographic server component(s) 2320 (cryptographic server); the ECO ADVANTAGE component(s) 2335, including components 2348-2349; and/or the like (i.e., collectively a component collection). These components may be stored and accessed from the storage devices and/or from storage devices accessible through an interface bus. Although non-conventional program components such as those in the component collection, typically, are stored in a local storage device 2314, they may also be loaded and/or stored in memory such as: peripheral devices, RAM, remote storage facilities through a communications network, ROM, various forms of memory, and/or the like.

### Operating System

The operating system component 2315 is an executable program component facilitating the operation of the ECO ADVANTAGE controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the ECO ADVANTAGE controller to communicate with other entities through a communications network 2313. Various communication protocols may be used by the ECO ADVANTAGE controller as a subcarrier transport mechanism for interaction, such as, but not limited to: multicast, TCP/IP, UDP, unicast, and/or the like.

### Information Server

An information server component 2316 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the ECO ADVANTAGE controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the 4 “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the ECO ADVANTAGE database 2319, operating systems, other program components, user interfaces, Web browsers, and/or the like.

Access to the ECO ADVANTAGE database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the ECO ADVANTAGE. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the ECO ADVANTAGE as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 2317 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 2318 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the ECO ADVANTAGE enabled nodes. The combined application may be nugatory on systems employing standard Web browsers.

### Mail Server

A mail server component 2321 is a stored program component that is executed by a CPU 2303. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the ECO ADVANTAGE.

Access to the ECO ADVANTAGE mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 2322 is a stored program component that is executed by a CPU 2303. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 2320 is a stored program component that is executed by a CPU 2303, cryptographic processor 2326, cryptographic processor interface 2327, cryptographic processor device 2328, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the ECO ADVANTAGE may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audfile. A cryptographic component may communicate to and/or with other components in a component collection, including itself, and/or facilities of the like. The cryptographic component supports encryption schemes allowing for the secure transmission of information across a communications network to enable the ECO ADVANTAGE component to engage in secure transactions if so desired. The cryptographic component facilitates the secure accessing of resources on the ECO ADVANTAGE and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The ECO ADVANTAGE Database

The ECO ADVANTAGE database component 2319 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the ECO ADVANTAGE database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the ECO ADVANTAGE database is implemented as a data-structure, the use of the ECO ADVANTAGE database 2319 may be integrated into another component such as the ECO ADVANTAGE component 2335. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 2319 includes several tables 2319a-k, m-n, p-r.

A users table 2319a includes fields such as, but not limited to: a user_ID, user_fname, user_lname, user_ID type, user_auth_code, user_email, user_address, user_date_created, user_pay_method, user_password, user_phone, user_interests, user_devices, user_confirmed, user_account_locked, user_enabled, user_username, and/or the like. The user table may support and/or track multiple user accounts on a ECO ADVANTAGE. A merchants table 2319b includes fields such as, but not limited to: merchant_ID, merchant_name, merchant_email, merchant_date_created, merchant_username, merchant_password, merchant_enabled, merchant_account_locked, merchant_confirmed, merchant_phone, merchant_contact, merchant_open_time, merchant_website, merchant_region, merchant_min_consumpt, merchant_max_consumpt, merchant_bank, merchant_bank_agency, merchant_bank_acct, and/or the like. The merchant table may support and/or track multiple merchant accounts on a ECO ADVANTAGE. An Economic Promoter table 2319c includes fields such as, but not limited to: ep_ID, ep_date_created, ep_ecos, ep_users, ep_region, ep_username, ep_password, and/or the like. The Economic Promoter table may support and/or track multiple Economic Promoter accounts on a ECO ADVANTAGE. A Merchant Agents table 2319d includes fields such as, but not limited to: ma_ID, ma_name, ma_merchants, ma_region, ma_categories, ma_parameters, ma_agg_info, and/or the like. The Merchant Agent table may support and/or track multiple Merchant Agent accounts on a ECO ADVANTAGE. A partners table 2319e includes fields such as, but not limited to: partner_ID, partner_name, partner_email, partner_date_created, partner_username, partner_password, partner_enabled, partner_account_locked, partner_confirmed, partner_phone, partner_contact, partner_open_time, partner_website, partner_region, partner_min_consumpt, partner_max_consumpt, partner_bank, partner_bank_agency, partner_bank_acct, and/or the like. The partner table may support and/or track multiple partner accounts on a ECO ADVANTAGE. An ecos table 2319f includes fields such as, but not limited to: eco_ID, eco_user_ID, eco_merchant_ID, eco_expiration, eco_donated, and/or the like. The ecos table may support and/or track multiple ecos on an ECO ADVANTAGE. A PoS table 2319g includes fields such as, but not limited to: pos_ID, pos_infrastructure, pos_configuration, pos_settings, and/or the like. The PoS table may support and/or track multiple PoS devices on a ECO ADVANTAGE. A transactions table 2319h includes fields such as, but not limited to: transaction ID, transaction date, transaction amount, transaction_user, transaction_merchant, transaction_ecos_paid, transaction_ecos_received, transaction_payment_method, transaction_atmospherics, and/or the like. The transaction table may support and/or track multiple transactions on a ECO ADVANTAGE. A transaction analytics table 2319i includes fields such as, but not limited to: ta_ID, ta_date, ta_results_merchants, ta_results_transactions, ta_results_ecos, ta_results_credit, ta_results_acquirer, ta_results_users, ta_results_ea, and/or the like. The transaction analytics table may support and/or track transaction analytics results on a ECO ADVANTAGE. An acquirers table 2319j includes fields such as, but not limited to: account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, and/or the like. The acquirer table may support and/or track multiple acquirer accounts on a ECO ADVANTAGE. An issuers table 2319k includes fields such as, but not limited to: issuer_id, issuer_name, issuer_address, ip_address, mac_address, auth_key, port_num, security_settings_list, and/or the like. The issuer table may support and/or track multiple issuer accounts on a ECO ADVANTAGE. A bonus blocks table 2319m includes fields such as, but not limited to: bb_ID, bb_user_ID, bb_merchant_ID, bb_expiration, bb_type, and/or the like. The bonus blocks table may support and/or track multiple bonus blocks on a ECO ADVANTAGE. A regions table 2319n includes fields such as, but not limited to: region_ID, region_name, region_geography, region_demographics, region_demarcations, region_merchants, region_users, region_partners, region_epromoters, region_mmanagers, region_categories, and/or the like. The regions table may support and/or track multiple regions on a ECO ADVANTAGE. A categories table 2319p includes fields such as, but not limited to: category_ID, category_interests, category_merchants, category_users, category_region, and/or the like. The categories table may support and/or track multiple categories on a ECO ADVANTAGE. A schedules table 2319q includes fields such as, but not limited to: schedule_ID, schedule_annual, schedule_monthly, schedule_weekly, schedule_daily, schedule_special_schedules, schedule_entity_ID and/or the like. The schedules table may support and/or track multiple eco schedules on a ECO ADVANTAGE. A BI information table 2319r includes fields such as, but not limited to: bi_id, bi_transactions, bi_analytics, and/or the like. The BI information table may support and/or track BI information on a ECO ADVANTAGE.

In one embodiment, the ECO ADVANTAGE database may interact with other database systems. For example, employing a distributed database system, queries and data access by search ECO ADVANTAGE component may treat the combination of the ECO ADVANTAGE database, an integrated data security layer database as a single database entity.

In one embodiment, user programs may contain various user interface primitives, which may serve to update the ECO ADVANTAGE. Also, various accounts may require custom database tables depending upon the environments and the types of clients the ECO ADVANTAGE may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 2319a-k, m-n, p-r. The ECO ADVANTAGE may be configured to keep track of various settings, inputs, and parameters via database controllers.

The ECO ADVANTAGE database may communicate to and/or with other components in a component collection, including itself, and/or facilities of the like. Most frequently, the ECO ADVANTAGE database communicates with the ECO ADVANTAGE component, other program components, and/or the like. The database may contain, retain, and provide information regarding other nodes and data.

### The ECO ADVANTAGEs

The ECO ADVANTAGE component 2335 is a stored program component that is executed by a CPU. In one embodiment, the ECO ADVANTAGE component incorporates any and/or all combinations of the aspects of the ECO ADVANTAGE that was discussed in the previous figures. As such, the ECO ADVANTAGE affects accessing, obtaining and the provision of information, services, transactions, and/or the like across various communications networks. The features and embodiments of the ECO ADVANTAGE discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the ECO ADVANTAGE's features and facilities, and in many cases reduce the costs, energy consumption/requirements, and extend the life of ECO ADVANTAGE's underlying infrastructure; this has the added benefit of making the ECO ADVANTAGE more reliable. Similarly, many of the features and mechanisms are designed to be easier for users to use and access, thereby broadening the audience that may enjoy/employ and exploit the feature sets of the ECO ADVANTAGE; such ease of use also helps to increase the reliability of the ECO ADVANTAGE. In addition, the feature sets include heightened security as noted via the Cryptographic components 2320, 2326, 2328 and throughout, making access to the features and data more reliable and secure.

The ECO ADVANTAGE transforms transaction and user, merchant, and payment data inputs via ECO ADVANTAGE Transaction Processing Component 2341, User Enrollment Component 2342, Merchant Enrollment Component 2343, Eco Schedule Calculation Component 2344, Merchant Information Aggregation and Analytics Component 2345, PoS Configuration Component 2346, User Invitation Component 2347, Region/Category Management Component 2348, Reconciliation Component 2349, Partner Enrollment Component 2350, Ecos Donation Component 2351, and Econometer Telemetry Component 2352, into eco, transaction, and region analytics outputs.

The ECO ADVANTAGE component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the ECO ADVANTAGE server employs a cryptographic server to encrypt and decrypt communications. The ECO ADVANTAGE component may communicate to and/or with other components in a component collection, including itself, and/or facilities of the like. Most frequently, the ECO ADVANTAGE component communicates with the ECO ADVANTAGE database, operating systems, other program components, and/or the like. The ECO ADVANTAGE may contain, communicate, generate, obtain, and/or provide program component, system, user, and/or data communications, requests, and/or responses.

### Distributed ECO ADVANTAGEs

The structure and/or operation of any of the ECO ADVANTAGE node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the ECO ADVANTAGE controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model 6 ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:

w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the ECO ADVANTAGE controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message do {

$input = “”;
$input = socket_read($client, 1024);
$data .= $input;

} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http: //www.xav.com/perl/site/lib/SOAP/Parser.html
http: //publib.boulder.ibm.com/infocenter/tivihelp/v2r1/index.jsp?topic=/com.ibm
.IBMDI.doc/referenceguide295.htm

and other parser implementations:

http: //publib.boulder.ibm.com/infocenter/tivihelp/v2r1/index.jsp?topic=/com.ibm
.IBMDI.doc/referenceguide259.htm

all of which are hereby expressly incorporated by reference.

In order to address various issues and advance the art, the entirety of this application for ECO ADVANTAGE MEDIATION APPARATUSES, METHODS AND SYSTEMS (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a ECO ADVANTAGE individual and/or enterprise user, database configuration and/or relational model, data type, data transmission and/or network framework, syntax structure, and/or the like, various embodiments of the ECO ADVANTAGE, may be implemented that enable a great deal of flexibility and customization. For example, aspects of the ECO ADVANTAGE may be adapted for health care, travel services, Accessories, Advertising and Marketing, Animal Clinic and Hospital, Arts and Crafts, Auto Body Shop, Auto Dealer, Auto Electric Shop, Auto Parts Store, Bakery, Beauty Clinic, Book Wholesale, Bookstore, Building Supplies, Camera and Photo, Car-Wash, Ceilings/Partition, Cell Phone Provider, Children's Store, Chocolate Shop, Clothing Repair, Coffee Shop, Computer and Accessories, Convenience Store, Cosmetics, Costume Shop, Courier Service, Dairy Products, Delicatessen, Diner, Do-It-Yourself Store, Durable Medical Equipment, DVD and Movies, Electrical Parts, Electronic and Video Game, Eletro/electronic Repair and Maintenance, Eyeglasses and Sunglasses, Fabric and Upholstery Store, Fast Graphic Service, Furniture Store, Gas Station, Gift Store, Gourmet and Specially Food Store, Grocery Store, Gym, Hardware Store, Heating and Air Conditioning, Home and Gardening, Home and Kitchen Goods, Home Appliance, Home Improvement, Home Phone Provider, Hotels, Ice Cream Parlour, Janitorial/Cleaning Supplies, Jewelry, Kids Party Place, Kids Tutoring, Language School or Learning Center, Laundry and Dry Cleaning, Leisure and Tourism, Light Fixture, Lingerie and Intimate Apparel, Locksmith, Luggage and Suitcase Store, Men's Fashion, Motels, Motorcycle Dealer, Movie Theater, Moving Service, Musical Instrument Shop, Natural Food Store, Nautical Store, Nightclub/Disco, Office Supplies, Paint Store, Party Supply Store, Perfumery, Personal Development Course, Pet Shop, Pharmacy, Plastic Surgery, Refrigeration Shop, Restaurant (all kinds), Rotisserie, Rug and Curtain Shop, School, Shoe Repair, Shoe Store, SPA, Specialty Pharmacy, Sporting Goods, Sport Tickets, Supermarket, Surgical Equipment, Swimwear Fashion, Technical Course, Theaters, Tickets (ShowsConcerts), Toy Store, Visual Communication, Winery, Women's Fashion, and/or the like. While various embodiments and discussions of the ECO ADVANTAGE have included commerce transactions between merchants and users, however, it is to be understood that the embodiments described herein may be readily configured and/or customized for a wide variety of other applications and/or implementations.

What is claimed is:

1. A processor-implemented method for mutual benefits, comprising:
receiving a request for a user's transaction value modifier (TVM) balance and a merchant's current TVM schedule from a merchant;
receiving a TVM transaction confirmation indicating a transaction has been successfully processed, and TVM transaction data;
debiting from a user's account an amount of TVMs received from another merchant in a previous transaction for use in the transaction;
crediting to the user's account an amount of TVMs based on the TVM transaction data; and
generating via a processor a TVM transaction record and storing the TVM transaction data in the TVM transaction record.

2. The method of claim 1, further comprising:
updating via the processor the merchant's current TVM schedule in the database using the TVM record.

3. The method of claim 1, wherein a TVM is an eco, a value identifier, or a subsequent value transaction modifier.

4. The method of claim 1, wherein the user's TVM balance is updated after receiving the TVM transaction confirmation.

5. The method of claim 1, wherein the user's TVM balance is updated before receiving the TVM transaction confirmation.

6. The method of claim 1, wherein the TVM transaction comprises paying at least a portion of the transaction amount in TVMs and at least a portion of the transaction amount with a payment device.

7. The method of claim 6, wherein the payment device is one of a credit card, debit card, or prepaid card.

8. The method of claim 1, wherein the TVM transaction comprises paying at least a portion of the transaction amount in TVMs and at least a portion of the transaction amount with cash.

9. The method of claim 1, wherein the TVM transaction comprises paying at least a portion of the transaction amount in TVMs, at least a portion of the transaction amount with cash, and at least a portion of the transaction amount with a payment device.

10. The method of claim 9, wherein the payment device is one of a credit card, debit card, or prepaid card.

11. The method of claim 1, wherein the credited transaction value modifiers can only be used in subsequent transactions.

12. The method of claim 11, wherein the credited transaction value modifiers is marked as originating from the merchant; and
wherein the transaction value modifiers cannot be used in subsequent transactions at the merchant from which they originated.

13. The method of claim 1, further comprising:
sending the user's TVM balance and the merchant's current TVM schedule to the merchant.

14. A processor-implemented method for mutual benefits, comprising:
sending to the user the user's TVM balance and an indication that at least some TVMs in the user's TVMs balance will expire;
receiving a request to donate expiring TVMs to a designated friend;
allocating via a processor the user's expiring TVMs to be donated to the designated friend;
sending a TVM donation message to the designated friend;
receiving from the designated friend an enrollment request;
generating via a processor a new user account for the designated friend;
transferring the allocated expiring TVMs to the designated friend's new user account; and
sending a confirmation of the transfer to the user and to the designated friend.

15. The method of claim 14, further comprising:
monitoring the spending of the user's donated TVMs by the designated friend; and
allocating via a processor an invite bonus block to the user's account when a predetermined number of the user's donated TVMs have been spent.

16. The method of claim 14, further comprising:
receiving a request from a user for user transaction value modifier (TVM) balance information;

17. The method of claim 15, wherein the mutual benefit enrollment request further comprises an amount of TVM gifted by an economic promoter.

18. The method of claim 17, wherein the economic promoter obtains a percentage of the amount of TVMs donated to the friend.

19. The method of claim 18, wherein a merchant manager gifts TVMs to the economic promoter and obtains a percentage of the amount of TVMs gifted to the friend.

20. A processor-implemented method for mutual benefits, comprising:
receiving an indication of preliminary interest in a mutual benefit program;
providing to the merchant a mutual benefit enrollment request form;
receiving a mutual benefit enrollment request from a merchant for the mutual benefit program;
sending a mutual benefit enrollment form to the merchant;
receiving from the merchant a completed mutual benefit enrollment form;
sending a request to a merchant agent requesting background material on the merchant;
receiving background material on the merchant from the merchant agent;
analyzing the background material from the merchant agent;
enrolling the merchant in the mutual benefit program if the background material meets predetermined criteria;
generating a merchant account for the merchant; and
sending the merchant a confirmation of enrollment in the mutual benefits program.

21. The method of claim 20, further comprising:
receiving from a merchant a survey of current point-of-sales (PoS) infrastructure and settings configurations;
determining a new PoS configuration for the user based on mutual benefit program specifications; and
sending the new PoS configuration and the training materials to the merchant for implementation.

22. The method of claim 21, further comprising:
generating training materials for the new PoS configuration.

23. A processor-implemented method for mutual benefits, comprising:
receiving a request for a user's value point balance and a merchant's current value point schedule from a merchant;
receiving a value point transaction confirmation indicating a transaction has been successfully processed and value point transaction data;
debiting from a user's account an amount of value points received from another merchant in a previous transaction for use in the transaction;
crediting to the user's account an amount of value points based on the value point transaction data; and
generating via a processor a value point transaction record and storing the value point transaction data in the value point transaction record.

24. The method of claim 23, further comprising:
updating via the processor the merchant's current value point schedule in the database using the value point record.

25. A processor-implemented method for mutual benefits, comprising:
receiving a product bulk amount from a partner;
receiving a request for a merchant's transaction value modifier (TVM) balance and a partner's current TVM schedule from a partner;
sending the merchant's TVM balance and the partner's current TVM schedule to the partner;
receiving a TVM transaction confirmation indicating a transaction involving purchasing at least one product bulk amount has been successfully processed and TVM transaction data;
debiting from the merchant's account an amount of TVMs used in the transaction;
crediting to the merchant's account an amount of TVM based on the TVM transaction data;
generating via a processor a TVM transaction record and storing the TVM transaction data in the TVM transaction record; and
updating via the processor the merchant's current TVM schedule in the database using the TVM transaction record.

26. A processor-implemented method for mutual benefits, comprising:
receiving aggregated entity data in a mutual benefits program within a defined geo-demographical region;
performing performance analytics on the entity data;
determining demarcation indicia to divide a region if the region is overpopulated;
splitting the region based on the geo-demographical demarcation indicia into sub-regions;
receiving updated demographic and industry data on each sub-region; and
generating new merchant categories for each sub-region based on the updated demographic and industry data.

27. The method of claim 26, wherein the entity is at least one of a merchant or demographic data.

28. A processor-implemented method for mutual benefits, comprising:
receiving aggregated entity data in a mutual benefits program within a defined geo-demographical region;
performing performance analytics on the entity data;
determining enrollment criteria for enrolling at least one merchant in the mutual benefits program if at least one merchant in the region is over-capacity;
sending a mutual benefit enrollment form to a merchant not enrolled in the mutual benefits program;
receiving from the merchant not enrolled in the mutual benefits program a completed mutual benefit enrollment form;
enrolling the merchant in the mutual benefits program; and
updating the region record in a database to include the enrolled merchant.

29. The method of claim 28, wherein the entity is at least one of a merchant or demographic data.

30. The method of claim 28, wherein the enrollment criteria may include the category that the at least one merchant in the region which is over-capacity.

31. A system for mutual benefits, comprising:
means for receiving a request for a user's transaction value modifier (TVM) balance and a merchant's current TVM schedule from a merchant;
means for receiving a TVM transaction confirmation indicating a transaction has been successfully processed, and TVM transaction data;
means for debiting from a user's account an amount of TVMs received from another merchant in a previous transaction for use in the transaction;
means for crediting to the user's account an amount of TVMs based on the TVM transaction data; and
means for generating via a processor a TVM transaction record and storing the TVM transaction data in the TVM transaction record.

32. The system of claim 31, further comprising:
means for updating via the processor the merchant's current TVM schedule in the database using the TVM record.

33. The system of claim 31, wherein a TVM is an eco, a value identifier, or a subsequent value transaction modifier.

34. The system of claim 31, wherein the user's TVM balance is updated after receiving the TVM transaction confirmation.

35. The system of claim 31, wherein the user's TVM balance is updated before receiving the TVM transaction confirmation.

36. The system of claim 31, wherein the TVM transaction comprises paying at least a portion of the transaction amount in TVMs and at least a portion of the transaction amount with a payment device.

37. The system of claim 36, wherein the payment device is one of a credit card, debit card, or prepaid card.

38. The system of claim 31, wherein the TVM transaction comprises paying at least a portion of the transaction amount in TVMs and at least a portion of the transaction amount with cash.

39. The system of claim 31, wherein the TVM transaction comprises paying at least a portion of the transaction amount in TVMs, at least a portion of the transaction amount with cash, and at least a portion of the transaction amount with a payment device.

40. The system of claim 39, wherein the payment device is one of a credit card, debit card, or prepaid card.

41. The system of claim 31, wherein the credited transaction value modifiers can only be used in subsequent transactions.

42. The system of claim 41, wherein the credited transaction value modifiers is marked as originating from the merchant; and
wherein the transaction value modifiers cannot be used in subsequent transactions at the merchant from which they originated.

43. The system of claim 31, further comprising:
means for sending the user's TVM balance and the merchant's current TVM schedule to the merchant.

44. A system for mutual benefits, comprising:
means for sending to the user the user's TVM balance and an indication that at least some TVMs in the user's TVMs balance will expire;
means for receiving a request to donate expiring TVMs to a designated friend;
means for allocating via a processor the user's expiring TVMs to be donated to the designated friend;
means for sending a TVM donation message to the designated friend;
means for receiving from the designated friend an enrollment request;
means for generating via a processor a new user account for the designated friend;
means for transferring the allocated expiring TVMs to the designated friend's new user account; and
means for sending a confirmation of the transfer to the user and to the designated friend.

45. The system of claim 44, further comprising:
means for monitoring the spending of the user's donated TVMs by the designated friend; and
means for allocating via a processor an invite bonus block to the user's account when a predetermined number of the user's donated TVMs have been spent.

46. The system of claim 44, further comprising:
means for receiving a request from a user for user transaction value modifier (TVM) balance information;

47. The system of claim 45, wherein the mutual benefit enrollment request further comprises an amount of TVM gifted by an economic promoter.

48. The system of claim 47, wherein the economic promoter obtains a percentage of the amount of TVMs donated to the friend.

49. The system of claim 48, wherein a merchant manager gifts TVMs to the economic promoter and obtains a percentage of the amount of TVMs gifted to the friend.

50. A system for mutual benefits, comprising:
means for receiving an indication of preliminary interest in a mutual benefit program;
means for providing to the merchant a mutual benefit enrollment request form;
means for receiving a mutual benefit enrollment request from a merchant for the mutual benefit program;
means for sending a mutual benefit enrollment form to the merchant;
means for receiving from the merchant a completed mutual benefit enrollment form;
means for sending a request to a merchant agent requesting background material on the merchant;
means for receiving background material on the merchant from the merchant agent;
means for analyzing the background material from the merchant agent;
means for enrolling the merchant in the mutual benefit program if the background material meets predetermined criteria;
means for generating a merchant account for the merchant; and
means for sending the merchant a confirmation of enrollment in the mutual benefits program.

51. The system of claim 50, further comprising:
means for receiving from a merchant a survey of current point-of-sales (PoS) infrastructure and settings configurations;
means for determining a new PoS configuration for the user based on mutual benefit program specifications; and
means for sending the new PoS configuration and the training materials to the merchant for implementation.

52. The system of claim 51, further comprising:
means for generating training materials for the new PoS configuration.

53. A system for mutual benefits, comprising:
means for receiving a request for a user's value point balance and a merchant's current value point schedule from a merchant;
means for receiving a value point transaction confirmation indicating a transaction has been successfully processed and value point transaction data;
means for debiting from a user's account an amount of value points received from another merchant in a previous transaction for use in the transaction;
means for crediting to the user's account an amount of value points based on the value point transaction data; and
means for generating via a processor a value point transaction record and storing the value point transaction data in the value point transaction record.

54. The system of claim 53, further comprising:
means for updating via the processor the merchant's current value point schedule in the database using the value point record.

55. A system for mutual benefits, comprising:
means for receiving a product bulk amount from a partner;
means for receiving a request for a merchant's transaction value modifier (TVM) balance and a partner's current TVM schedule from a partner;
means for sending the merchant's TVM balance and the partner's current TVM schedule to the partner;
means for receiving a TVM transaction confirmation indicating a transaction involving purchasing at least one product bulk amount has been successfully processed and TVM transaction data;
means for debiting from the merchant's account an amount of TVMs used in the transaction;
means for crediting to the merchant's account an amount of TVM based on the TVM transaction data;
means for generating via a processor a TVM transaction record and storing the TVM transaction data in the TVM transaction record; and
means for updating via the processor the merchant's current TVM schedule in the database using the TVM transaction record.

56. A system for mutual benefits, comprising:
means for receiving aggregated entity data in a mutual benefits program within a defined geo-demographical region;
means for performing performance analytics on the entity data;
means for determining demarcation indicia to divide a region if the region is overpopulated;
means for splitting the region based on the geo-demographical demarcation indicia into sub-regions;
means for receiving updated demographic and industry data on each sub-region; and
means for generating new merchant categories for each sub-region based on the updated demographic and industry data.

57. The system of claim 56, wherein the entity is at least one of a merchant or demographic data.

58. A system for mutual benefits, comprising:
means for receiving aggregated entity data in a mutual benefits program within a defined geo-demographical region;
means for performing performance analytics on the entity data;
means for determining enrollment criteria for enrolling at least one merchant in the mutual benefits program if at least one merchant in the region is over-capacity;
means for sending a mutual benefit enrollment form to a merchant not enrolled in the mutual benefits program;
means for receiving from the merchant not enrolled in the mutual benefits program a completed mutual benefit enrollment form;
means for enrolling the merchant in the mutual benefits program; and
means for updating the region record in a database to include the enrolled merchant.

59. The system of claim 58, wherein the entity is at least one of a merchant or demographic data.

60. The system of claim 58, wherein the enrollment criteria may include the category that the at least one merchant in the region which is over-capacity.

61. A mutual benefits non-transitory computer-readable medium storing processor-executable instructions, said instructions executable by a processor to:
receive a request for a user's transaction value modifier (TVM) balance and a merchant's current TVM schedule from a merchant;
receive a TVM transaction confirmation indicating a transaction has been successfully processed, and TVM transaction data;
debit from a user's account an amount of TVMs received from another merchant in a previous transaction for use in the transaction;
credit to the user's account an amount of TVMs based on the TVM transaction data; and
generate via a processor a TVM transaction record and storing the TVM transaction data in the TVM transaction record.

62. The medium of claim 61, further comprising instructions to:
update via the processor the merchant's current TVM schedule in the database using the TVM record.

63. The medium of claim 61, wherein a TVM is an eco, a value identifier, or a subsequent value transaction modifier.

64. The medium of claim 61, wherein the user's TVM balance is updated after receiving the TVM transaction confirmation.

65. The medium of claim 61, wherein the user's TVM balance is updated before receiving the TVM transaction confirmation.

66. The medium of claim 61, wherein the TVM transaction comprises paying at least a portion of the transaction amount in TVMs and at least a portion of the transaction amount with a payment device.

67. The medium of claim 66, wherein the payment device is one of a credit card, debit card, or prepaid card.

68. The medium of claim 61, wherein the TVM transaction comprises paying at least a portion of the transaction amount in TVMs and at least a portion of the transaction amount with cash.

69. The medium of claim 61, wherein the TVM transaction comprises paying at least a portion of the transaction amount in TVMs, at least a portion of the transaction amount with cash, and at least a portion of the transaction amount with a payment device.

70. The medium of claim 69, wherein the payment device is one of a credit card, debit card, or prepaid card.

71. The medium of claim 61, wherein the credited transaction value modifiers can only be used in subsequent transactions.

72. The medium of claim 71, wherein the credited transaction value modifiers is marked as originating from the merchant; and
wherein the transaction value modifiers cannot be used in subsequent transactions at the merchant from which they originated.

73. The medium of claim 61, further comprising instructions to:
send the user's TVM balance and the merchant's current TVM schedule to the merchant.

74. A mutual benefits non-transitory computer-readable medium storing processor-executable instructions, said instructions executable by a processor to:
send to the user the user's TVM balance and an indication that at least some TVMs in the user's TVMs balance will expire;
receive a request to donate expiring TVMs to a designated friend;
allocate via a processor the user's expiring TVMs to be donated to the designated friend;
send a TVM donation message to the designated friend;
receive from the designated friend an enrollment request;
generate via a processor a new user account for the designated friend;
transfer the allocated expiring TVMs to the designated friend's new user account; and
send a confirmation of the transfer to the user and to the designated friend.

75. The medium of claim 74, further comprising instructions to:
monitor the spending of the user's donated TVMs by the designated friend; and
allocate via a processor an invite bonus block to the user's account when a predetermined number of the user's donated TVMs have been spent.

76. The medium of claim 74, further comprising instructions to:
receive a request from a user for user transaction value modifier (TVM) balance information.

77. The medium of claim 75, wherein the mutual benefit enrollment request further comprises an amount of TVM gifted by an economic promoter.

78. The medium of claim 77, wherein the economic promoter obtains a percentage of the amount of TVMs donated to the friend.

79. The medium of claim 78, wherein a merchant manager gifts TVMs to the economic promoter and obtains a percentage of the amount of TVMs gifted to the friend.

80. A mutual benefits non-transitory computer-readable medium storing processor-executable instructions, said instructions executable by a processor to:
receive an indication of preliminary interest in a mutual benefit program;
provide to the merchant a mutual benefit enrollment request form;
receive a mutual benefit enrollment request from a merchant for the mutual benefit program;
send a mutual benefit enrollment form to the merchant;
receive from the merchant a completed mutual benefit enrollment form;
send a request to a merchant agent requesting background material on the merchant;
receive background material on the merchant from the merchant agent;
analyze the background material from the merchant agent;
enroll the merchant in the mutual benefit program if the background material meets predetermined criteria;
generate a merchant account for the merchant; and
send the merchant a confirmation of enrollment in the mutual benefits program.

81. The medium of claim 80, further comprising instructions to:
receive from a merchant a survey of current point-of-sales (PoS) infrastructure and settings configurations;
determine a new PoS configuration for the user based on mutual benefit program specifications; and
send the new PoS configuration and the training materials to the merchant for implementation.

82. The medium of claim 81, further comprising instructions to:
generate training materials for the new PoS configuration.

83. A processor-implemented medium for mutual benefits, comprising:
receive a request for a user's value point balance and a merchant's current value point schedule from a merchant;
receive a value point transaction confirmation indicating a transaction has been successfully processed and value point transaction data;
debit from a user's account an amount of value points received from another merchant in a previous transaction for use in the transaction;
credit to the user's account an amount of value points based on the value point transaction data; and
generate via a processor a value point transaction record and storing the value point transaction data in the value point transaction record.

84. The medium of claim 83, further comprising instructions to:
update via the processor the merchant's current value point schedule in the database using the value point record.

85. A mutual benefits non-transitory computer-readable medium storing processor-executable instructions, said instructions executable by a processor to:
receive a product bulk amount from a partner;
receive a request for a merchant's transaction value modifier (TVM) balance and a partner's current TVM schedule from a partner;
send the merchant's TVM balance and the partner's current TVM schedule to the partner;
receive a TVM transaction confirmation indicating a transaction involving purchasing at least one product bulk amount has been successfully processed and TVM transaction data;
debit from the merchant's account an amount of TVMs used in the transaction;
credit to the merchant's account an amount of TVM based on the TVM transaction data;
generate via a processor a TVM transaction record and storing the TVM transaction data in the TVM transaction record; and
update via the processor the merchant's current TVM schedule in the database using the TVM transaction record.

86. A mutual benefits non-transitory computer-readable medium storing processor-executable instructions, said instructions executable by a processor to:
receive aggregated entity data in a mutual benefits program within a defined geo-demographical region;
perform performance analytics on the entity data;
determine demarcation indicia to divide a region if the region is overpopulated;
split the region based on the geo-demographical demarcation indicia into sub-regions;
receive updated demographic and industry data on each sub-region; and
generate new merchant categories for each sub-region based on the updated demographic and industry data.

87. The medium of claim 86, wherein the entity is at least one of a merchant or demographic data.

88. A mutual benefits non-transitory computer-readable medium storing processor-executable instructions, said instructions executable by a processor to:
receive aggregated entity data in a mutual benefits program within a defined geo-demographical region;
perform performance analytics on the entity data;
determine enrollment criteria for enrolling at least one merchant in the mutual benefits program if at least one merchant in the region is over-capacity;
send a mutual benefit enrollment form to a merchant not enrolled in the mutual benefits program;
receive from the merchant not enrolled in the mutual benefits program a completed mutual benefit enrollment form;
enroll the merchant in the mutual benefits program; and
update the region record in a database to include the enrolled merchant.

89. The medium of claim 88, wherein the entity is at least one of a merchant or demographic data.

90. The medium of claim 88, wherein the enrollment criteria may include the category that the at least one merchant in the region which is over-capacity.

91. An apparatus for mutual benefits, comprising:
a processor; and
a memory disposed in communication with the processor and storing processor-executable instructions to:
receive a request for a user's transaction value modifier (TVM) balance and a merchant's current TVM schedule from a merchant;
receive a TVM transaction confirmation indicating a transaction has been successfully processed, and TVM transaction data;
debit from a user's account an amount of TVMs received from another merchant in a previous transaction for use in the transaction;
credit to the user's account an amount of TVMs based on the TVM transaction data; and
generate via a processor a TVM transaction record and storing the TVM transaction data in the TVM transaction record.

92. The apparatus of claim 91, further comprising instructions to:
update via the processor the merchant's current TVM schedule in the database using the TVM record.

93. The apparatus of claim 91, wherein a TVM is an eco, a value identifier, or a subsequent value transaction modifier.

94. The apparatus of claim 91, wherein the user's TVM balance is updated after receiving the TVM transaction confirmation.

95. The apparatus of claim 91, wherein the user's TVM balance is updated before receiving the TVM transaction confirmation.

96. The apparatus of claim 91, wherein the TVM transaction comprises paying at least a portion of the transaction amount in TVMs and at least a portion of the transaction amount with a payment device.

97. The apparatus of claim 96, wherein the payment device is one of a credit card, debit card, or prepaid card.

98. The apparatus of claim 91, wherein the TVM transaction comprises paying at least a portion of the transaction amount in TVMs and at least a portion of the transaction amount with cash.

99. The apparatus of claim 91, wherein the TVM transaction comprises paying at least a portion of the transaction amount in TVMs, at least a portion of the transaction amount with cash, and at least a portion of the transaction amount with a payment device.

100. The apparatus of claim 99, wherein the payment device is one of a credit card, debit card, or prepaid card.

101. The apparatus of claim 91, wherein the credited transaction value modifiers can only be used in subsequent transactions.

102. The apparatus of claim 101, wherein the credited transaction value modifiers is marked as originating from the merchant; and
wherein the transaction value modifiers cannot be used in subsequent transactions at the merchant from which they originated.

103. The apparatus of claim 91, further comprising instructions to:
send the user's TVM balance and the merchant's current TVM schedule to the merchant.

104. An apparatus for mutual benefits, comprising:
a processor; and
a memory disposed in communication with the processor and storing processor-executable instructions to:
send to the user the user's TVM balance and an indication that at least some TVMs in the user's TVMs balance will expire;
receive a request to donate expiring TVMs to a designated friend;
allocating via a processor the user's expiring TVMs to be donated to the designated friend;
send a TVM donation message to the designated friend;
receive from the designated friend an enrollment request;
generate via a processor a new user account for the designated friend;
transfer the allocated expiring TVMs to the designated friend's new user account; and
send a confirmation of the transfer to the user and to the designated friend.

105. The apparatus of claim 104, further comprising instructions to:
monitor the spending of the user's donated TVMs by the designated friend; and
allocate via a processor an invite bonus block to the user's account when a predetermined number of the user's donated TVMs have been spent.

106. The apparatus of claim 104, further comprising instructions to:
receive a request from a user for user transaction value modifier (TVM) balance information;

107. The apparatus of claim 105, wherein the mutual benefit enrollment request further comprises an amount of TVM gifted by an economic promoter.

108. The apparatus of claim 107, wherein the economic promoter obtains a percentage of the amount of TVMs donated to the friend.

109. The apparatus of claim 108, wherein a merchant manager gifts TVMs to the economic promoter and obtains a percentage of the amount of TVMs gifted to the friend.

110. An apparatus for mutual benefits, comprising:
a processor; and
a memory disposed in communication with the processor and storing processor-executable instructions to:
receive an indication of preliminary interest in a mutual benefit program;
provide to the merchant a mutual benefit enrollment request form;
receive a mutual benefit enrollment request from a merchant for the mutual benefit program;
send a mutual benefit enrollment form to the merchant;
receive from the merchant a completed mutual benefit enrollment form;
send a request to a merchant agent requesting background material on the merchant;
receive background material on the merchant from the merchant agent;
analyze the background material from the merchant agent;
enroll the merchant in the mutual benefit program if the background material meets predetermined criteria;
generate a merchant account for the merchant; and
send the merchant a confirmation of enrollment in the mutual benefits program.

111. The apparatus of claim no, further comprising instructions to:
receive from a merchant a survey of current point-of-sales (PoS) infrastructure and settings configurations;
determine a new PoS configuration for the user based on mutual benefit program specifications; and
send the new PoS configuration and the training materials to the merchant for implementation.

112. The apparatus of claim 111, further comprising instructions to:
generate training materials for the new PoS configuration.

113. An apparatus for mutual benefits, comprising:
a processor; and
a memory disposed in communication with the processor and storing processor-executable instructions to:
receive a request for a user's value point balance and a merchant's current value point schedule from a merchant;
receive a value point transaction confirmation indicating a transaction has been successfully processed and value point transaction data;
debit from a user's account an amount of value points received from another merchant in a previous transaction for use in the transaction;
credit to the user's account an amount of value points based on the value point transaction data; and
generate via a processor a value point transaction record and storing the value point transaction data in the value point transaction record.

114. The apparatus of claim 113, further comprising instructions to:
update via the processor the merchant's current value point schedule in the database using the value point record.

115. An apparatus for mutual benefits, comprising:
a processor; and
a memory disposed in communication with the processor and storing processor-executable instructions to:
receive a product bulk amount from a partner;
receive a request for a merchant's transaction value modifier (TVM) balance and a partner's current TVM schedule from a partner;
send the merchant's TVM balance and the partner's current TVM schedule to the partner;
receive a TVM transaction confirmation indicating a transaction involving purchasing at least one product bulk amount has been successfully processed and TVM transaction data;
debit from the merchant's account an amount of TVMs used in the transaction;
credit to the merchant's account an amount of TVM based on the TVM transaction data;
generate via a processor a TVM transaction record and storing the TVM transaction data in the TVM transaction record; and
update via the processor the merchant's current TVM schedule in the database using the TVM transaction record.

116. An apparatus for mutual benefits, comprising:
a processor; and
a memory disposed in communication with the processor and storing processor-executable instructions to:
receive aggregated entity data in a mutual benefits program within a defined geo-demographical region;
perform performance analytics on the entity data;
determine demarcation indicia to divide a region if the region is overpopulated;
split the region based on the geo-demographical demarcation indicia into sub-regions;
receive updated demographic and industry data on each sub-region; and
generate new merchant categories for each sub-region based on the updated demographic and industry data.

117. The apparatus of claim 116, wherein the entity is at least one of a merchant or demographic data.

118. An apparatus for mutual benefits, comprising:
a processor; and
a memory disposed in communication with the processor and storing processor-executable instructions to:
receive aggregated entity data in a mutual benefits program within a defined geo-demographical region;
perform performance analytics on the entity data;
determine enrollment criteria for enrolling at least one merchant in the mutual benefits program if at least one merchant in the region is over-capacity;
send a mutual benefit enrollment form to a merchant not enrolled in the mutual benefits program;
receive from the merchant not enrolled in the mutual benefits program a completed mutual benefit enrollment form;
enroll the merchant in the mutual benefits program; and
update the region record in a database to include the enrolled merchant.

119. The apparatus of claim 118, wherein the entity is at least one of a merchant or demographic data.

120. The apparatus of claim 118, wherein the enrollment criteria may include the category that the at least one merchant in the region which is over-capacity.
